(19) United States
(12) Patent Application Publication
(10) Pub. No.: US 2025/0258685 A1
(43) Pub. Date: Aug. 14, 2025

(54) SYSTEM AND METHOD FOR AI BASED DYNAMIC USER EXPERIENCE CURATION

(71) Applicant: QOMPLX LLC, Reston, VA (US)

(72) Inventors: Jason Crabtree, Vienna, VA (US); Richard Kelley, Woodbridge, VA (US); Jason Hopper, Halifax (CA); David Park, Fairfax, VA (US)

(21) Appl. No.: 18/731,326

(22) Filed: Jun. 2, 2024

Related U.S. Application Data
(63) Continuation-in-part of application No. 18/668,137, filed on May 18, 2024.
Application No. 18/668,137 is a continuation-in-part of application No. 18/656,612, filed on May 7, 2024.
(60) Provisional application No. 63/551,328, filed on Feb. 8, 2024.

(51) Int. Cl. G06F 9/451; A63F 13/40

(52) U.S. Cl. CPC G06F 9/451; A63F 13/40; A63F 2300/308

(57) ABSTRACT

A system and method for AI based user experience curation across multiple scenarios and finite time horizons of interest. The present invention integrates connectionist and symbolic AI techniques to generate coherent, relevant, and personalized content across various domains. The invention bridges the gap between connectionist AI and symbolic AI, enabling more adaptive, immersive, and engaging user experiences while prioritizing security and traceability and contextualization considerations behind recommendations or content generation. The platform furthers dynamic and tailored user interactions with digital systems across individual interactions, preferences, sequences and ongoing engagements across sessions by leveraging the power of analytics, deep learning, and AI to create truly intelligent, dynamic, and responsive user experiences enhanced with optimization and planning faculties.

### CROSS-REFERENCE TO RELATED APPLICATIONS

Priority is claimed in the application data sheet to the following patents or patent applications, each of which is expressly incorporated herein by reference in its entirety:
Ser. No. 18/668,137
Ser. No. 18/656,612
63/551,328

### BACKGROUND OF THE INVENTION

### Field of the Art

The present invention relates to the field of dynamic user interface and experience development. More specifically, the invention pertains to systems and methods that utilize generative artificial intelligence to create dynamic user experiences and interfaces with both connectionist and symbolic reasoning capabilities.

### Discussion of the State of the Art

In recent years, the field of user experience (UX) design has witnessed significant advancements, with a growing emphasis on creating engaging, intuitive, and personalized interactions between users and digital systems across a multitude of devices. However, despite these developments, current UX approaches often face challenges in delivering truly immersive, adaptive, and context-aware experiences across various domains such as sound, visuals, tactile feedback, environments, smells, and other user interface elements, while also conveying information to a user in a way specific to their preferences and needs.

One of the primary limitations of existing UX design methodologies is their reliance on predefined rules, templates, static content, and libraries. While these approaches can provide functional and aesthetically pleasing user experiences, they often lack the flexibility and adaptability required to cater to the diverse needs and preferences of individual users or adapt to specific context or goals from a given session in an experience. As a result, users may find themselves interacting with systems that feel overly generic, impersonal, or disconnected from their specific context or functional requirements. Moreover, traditional UX design and follow-on implementation processes often involve time-consuming and resource-intensive manual creation and curation of content or User Interface (UI) elements, which can limit the appropriateness, scalability and responsiveness of the resulting user experiences, and creates a bottleneck between the user and the underlying content or data. This is particularly evident in domains such as gaming, virtual reality, and interactive media, where the demand for rich, dynamic, and personalized content far outpaces the capacity of manual content creation. It can also limit the effectiveness and narrow tailoring of media, advertising, conversion funnels, or e-commerce experiences which have canonically focused on traditional statistical analysis, machine learning and various forms of A/B testing, user engagement and conversion modeling.

The emergence of generative artificial intelligence (AI) techniques, such as large language models (LLMs), reinforcement learning, and deep learning-based text, image, and audio synthesis, has opened up new possibilities for addressing these limitations. Gen AI has the potential to automatically create, augment, or adapt diverse and compelling content, adapt to user preferences and contexts, and enable more immersive and engaging user experiences across various subject domains and devices.

What is needed is a new approach to UX design that leverages the power of statistics, machine learning, artificial intelligence, stochastic search, Gen AI, user feedback, and modeling simulation to address the limitations of current UX design, generation, and efficacy modeling systems and methods. Such an approach may enable the creation of agile and adaptive, context-aware, and engaging user experiences that can further the way users interact with digital systems across various domains, content, information, devices, and ongoing sequences of interactions or sessions.

### SUMMARY OF THE INVENTION

Accordingly, the inventor has conceived and reduced to practice, a system and method for AI based user experience curation. The present invention aims to address the limitations of current UX design with a mix of statistical, machine learning, artificial intelligence, modeling simulation, and Gen AI approaches by introducing an integrated data capture novel composite neuro-symbolic and non-symbolic AI platform for creating advanced, context-aware user experiences. This platform leverages the power of connectionist AI techniques, such as large language models, reinforcement learning, generalized adversarial networks, or deep learning-based synthesis, while integrating symbolic reasoning and domain knowledge to enable the creation of coherent, relevant, and personalized content. The system incorporates a human-machine collaborative development framework that allows for the continuous improvement and refinement of the AI models based on user and group feedback and domain expert (or group) and AI agent or model input or result packages. By bridging the gap between connectionist AI and symbolic reasoning, the proposed platform enables the creation of more adaptive, immersive, and engaging user experiences and sequences across various domains, devices, and sessions to include elements such as sound, visuals, smells, tactile experiences environments, and user interfaces, while prioritizing reliability, security, provenance, traceability, and responsible deployment and utilization considerations. The system may also engage in multidimensional optimization and planning actions to construct suggestions, plans, experience moments, sequences or progressions to improve an inferred or declared objective function for at least one target user or stakeholder. The system may also engage in multidimensional optimization and planning actions to construct suggestions, plans, experience moments, sequences or progressions to improve an inferred or declared objective function for at least one target user or stakeholder.

According to a preferred embodiment, a system for user experience curation, comprising: a computing device comprising at least a memory and a processor; a plurality of programming instructions that, when operating on the processor, cause the computing device to: collect a plurality of data types from a plurality of sources or systems wherein data may include but is not limited to audio, visual, telematics, haptic, smells, environmental conditions, user security settings, user privacy settings, user disabilities and sensory ranges, user health and faculties, other user devices, and user preference settings; train a modular artificial intelligence which includes a plurality of artificial general intelligence subsystems using the plurality of data where each intelligence subsystem is trained on a different data type; generate a user interface or user experience which incorporates elements associated with audio, visual, smell or fragrance, pressure, temperature, humidity, direct brain stimulus via neural interface, other environmental elements to include molecular composition of air or water or solutions in vicinity of user, telematics and motion elements, taste, haptic, and user inputs using the modular artificial intelligence system wherein the plurality user security, privacy, and preference settings allow the interface or experience to be tailored to a particular user; and collect a plurality of user feedback data which may input into an artificial intelligence training live or training system to better tailor an interface, experience moment or sequence of moments or progression of sequences, or environment to a particular user.

According to another preferred embodiment, a method for user experience curation, comprising the steps of: collecting a plurality of data types from a plurality of sources or systems wherein data may include but is not limited to audio, visual, telematics, haptic, smells, environmental conditions, user security settings, user privacy settings, user disabilities and sensory ranges, user health and faculties, other user devices, and user preference settings; training a modular artificial intelligence which includes a plurality of artificial general intelligence subsystems using the plurality of data where each intelligence subsystem is trained on a different data type; generating a user interface or user experience which incorporates elements associated with audio, visual, smell or fragrance, pressure, temperature, humidity, direct brain stimulus via neural interface, other environmental elements to include molecular composition of air or water or solutions in vicinity of user, telematics and motion elements, taste, haptic, and user inputs using the modular artificial intelligence system wherein the plurality user security, privacy, and preference settings allow the interface or experience to be tailored to a particular user; and collecting a plurality of user feedback data which may input into an artificial intelligence training live or training system to better tailor an interface, experience moment or sequence of moments or progression of sequences, or environment to a particular user.

According to an aspect of an embodiment, the modular artificial intelligence system is integrated into a dynamic application experience generation platform which generates a chatbot that may be incorporated into a generated user interface or experience.

According to an aspect of an embodiment, the modular artificial intelligence system uses the telematics, haptics, audio, and visual data to generate virtual environments and interfaces for video games and simulations.

According to an aspect of an embodiment, the generated virtual environments and interfaces for video games and simulations may be updated based on how the user interacts with the environment and allows a user to receive sensory feedback based on their interactions.

According to an aspect of an embodiment, the artificial intelligence experience is integrated into a dynamic experience curation platform which allows the artificial intelligence system to generate a plurality of virtual experiences.

### BRIEF DESCRIPTION OF THE DRAWING FIGURES

FIG. 1 is a block diagram illustrating an exemplary system architecture for a distributed, composite symbolic and non-symbolic AI platform with user experience curation capabilities.

FIG. 2 is a block diagram illustrating a component of a system for a distributed, composite symbolic and non-symbolic AI platform with user experience curation capabilities, a user experience curation system.

FIG. 3 is a block diagram illustrating a component of a system for a distributed, composite symbolic and non-symbolic AI platform with user experience curation capabilities, an AI training system.

FIG. 4 is a block diagram illustrating an exemplary system architecture for a distributed generative artificial intelligence reasoning and action platform, according to an embodiment.

FIG. 5 is a block diagram illustrating an exemplary aspect of a distributed Gen AI reasoning and action platform incorporating various additional contextual data.

FIG. 6 is a diagram illustrating incorporating symbolic reasoning in support of LLM-based Gen AI, according to an aspect of a neuro-symbolic Gen AI reasoning and action platform.

FIG. 7 is a block diagram illustrating an exemplary architecture for a neuro-symbolic Gen AI reasoning and action platform configured for federated learning at a plurality of edge devices, according to an embodiment.

FIG. 8 is a block diagram illustrating an exemplary architecture for a neuro-symbolic Gen AI reasoning and action platform configured to utilize a midserver to act as a computing intermediary between a plurality of edge devices and the platform.

FIG. 9 is a block diagram illustrating an exemplary mobile device configured for experience curation using embedded capabilities and functionality provided by a neuro-symbolic Gen AI reasoning and action platform, according to an embodiment.

FIG. 10 is a block diagram illustrating an exemplary aspect of a distributed generative artificial intelligence reasoning and action platform, a curation computing system.

FIG. 11 is a block diagram illustrating an exemplary aspect of a distributed generative artificial intelligence reasoning and action platform, a marketplace computing system.

FIG. 12 is a block diagram illustrating a simple example of a distributed computational graph representation for providing neuro-symbolic Gen AI capabilities, according to an aspect.

FIG. 13 is a block diagram illustrating an exemplary aspect of an embodiment of a distributed computational graph computing system utilizing an advanced cyber decision platform (ACDP) for external network reconnaissance and contextual data collection.

FIG. 14 is a block diagram illustrating another exemplary aspect of an embodiment of a distributed computational graph computing systems utilizing an advanced cyber decision platform.

FIG. 15 is a diagram of an exemplary architecture for a system for rapid predictive analysis of very large data sets using an actor-driven distributed computational graph, according to one aspect.

FIG. 16 is a diagram of an exemplary architecture for a system for rapid predictive analysis of very large data sets using an actor-driven distributed computational graph, according to one aspect.

FIG. 17 is a diagram of an exemplary architecture for a system for rapid predictive analysis of very large data sets using an actor-driven distributed computational graph, according to one aspect.

FIG. 18 is a block diagram of an architecture for a transformation pipeline within a system for predictive analysis of very large data sets using distributed computational graph computing system.

FIG. 19 is a block diagram illustrating an exemplary system architecture for a distributed, composite symbolic and non-symbolic AI platform for advanced reasoning, according to an embodiment.

FIG. 20 is a block diagram illustrating an exemplary model architecture of the Transformer, consisting of an Encoder and a Decoder.

FIG. 21 is a block diagram illustrating an exemplary basic embedding layer generation process, according to an embodiment.

FIG. 22 is a block diagram illustrating an exemplary system architecture for dynamic generation of application experiences, according to an embodiment.

FIG. 23 is a block diagram illustrating an exemplary aspect of dynamic application experience generation platform, a design management system.

FIG. 24 is a block diagram illustrating an exemplary aspect of dynamic application experience generation platform, an agent orchestration system.

FIG. 25 is a block diagram illustrating an exemplary design workboard which may be implemented by dynamic application experience generation platform, according to an aspect.

FIG. 26 is a block diagram illustrating exemplary clarity factors which may be used for determining a clarity score associated with a user specification for UX/UI content, according to an aspect.

FIG. 27 is a block diagram illustrating an exemplary system architecture of a dynamic experience curation platform, according to an embodiment.

FIG. 28 is a block diagram illustrating an exemplary aspect of a dynamic experience curation platform, a preference database.

FIG. 29 is a block diagram illustrating an exemplary high-level architecture of a dynamic experience curation platform and the exchange of information among various components during dynamic experience curation, according to an aspect of an embodiment.

FIG. 30 is a block diagram illustrating an exemplary aspect of a dynamic experience curation platform, a context extracting/tracking system.

FIG. 31 is a block diagram illustrating an exemplary aspect of a dynamic experience curation platform, a process filtering system.

FIG. 32 is a block diagram illustrating an exemplary federated architecture of a dynamic experience curation platform, according to an aspect of an embodiment.

FIG. 33 is a block diagram illustrating an exemplary system architecture for AI-enabled telematics for electronic entertainment and simulation systems.

FIG. 34 is a block diagram illustrating an exemplary architecture for a subsystem of the system for AI-enabled telematics for electronic entertainment and simulation systems, a Machine Learning system.

FIG. 35 is a diagram showing an embodiment of one aspect of the system and method for AI-enabled telematics for electronic entertainment and simulation systems, specifically, using a machine learning system to update actuator position.

FIG. 36 is a diagram showing an embodiment of one aspect of the system and method for AI-enabled telematics for electronic entertainment and simulation systems, specifically, generating racing environments from telematics data.

FIG. 37 is a block diagram illustrating an exemplary architecture for a component of a system for AI-enabled telematics for electronic entertainment and simulation systems, specifically, a user device.

FIG. 38 is a flow diagram illustrating an exemplary method for generating a UI/UX environment using a user experience curation system.

FIG. 39 is a flow diagram illustrating an exemplary method for generating a chatbot using a user experience curation system.

FIG. 40 is a flow diagram illustrating an exemplary method for generating audio, visual, telematics, and haptic experiences using a user experience curation system.

FIG. 41 is a flow diagram illustrating an exemplary method for generating a UI/UX environment using a dynamic experience curation platform with an integrated user experience curation platform.

FIG. 42 illustrates an exemplary computing environment on which an embodiment described herein may be implemented, in full or in part.

### DETAILED DESCRIPTION OF THE INVENTION

The inventor has conceived, and reduced to practice, a system and method a system and method for AI based user experience curation.

It should be appreciated that the described systems and methods may be directed to the generation of experience moments, sequences of moments, and/or the progression of sequences in addition to, or alternative to, the generation of various environments.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Definitions

As used herein, “explainability” (also referred to as “interpretability”) is the concept that a machine learning model and its output can be explained in a way that “makes sense” to a human being at an acceptable level.

As used herein, “graph” is a representation of information and relationships, where each primary unit of information makes up a “node” or “vertex” of the graph and the relationship between two nodes makes up an edge of the graph. Nodes can be further qualified by the connection of one or more descriptors or “properties” to that node. For example, given the node “James R,” name information for a person, qualifying properties might be “183 cm tall,” “DOB Aug. 13, 1965” and “speaks English”. Similar to the use of properties to further describe the information in a node, a relationship between two nodes that forms an edge can be qualified using a “label”. Thus, given a second node “Thomas G,” an edge between “James R” and “Thomas G” that indicates that the two people know each other might be labeled “knows.” When graph theory notation (Graph=(Vertices, Edges)) is applied this situation, the set of nodes are used as one parameter of the ordered pair, V and the set of 2 element edge endpoints are used as the second parameter of the ordered pair, E. When the order of the edge endpoints within the pairs of E is not significant, for example, the edge James R, Thomas G is equivalent to Thomas G, James R, the graph is designated as “undirected.” Under circumstances when a relationship flows from one node to another in one direction, for example James R is “taller” than Thomas G, the order of the endpoints is significant. Graphs with such edges are designated as “directed.” In the distributed computational graph system, transformations within transformation pipeline are represented as directed graph with each transformation comprising a node and the output messages between transformations comprising edges. Distributed computational graph stipulates the potential use of non-linear transformation pipelines which are programmatically linearized. Such linearization can result in exponential growth of resource consumption. The most sensible approach to overcome possibility is to introduce new transformation pipelines just as they are needed, creating only those that are ready to compute. Such method results in transformation graphs which are highly variable in size and node, edge composition as the system processes data streams. Those familiar with the art will realize that transformation graph may assume many shapes and sizes with a vast topography of edge relationships and node types and subgraphs, which may be optionally stored, represented, or acted upon. It is also important to note that the resource topologies available at a given execution time for a given pipeline may be highly dynamic due to changes in available node or edge types or topologies (e.g. different servers, data centers, devices, network links, etc.) being available, and this is even more so when legal, regulatory, privacy and security considerations are included in a DCG pipeline specification or recipe in the DSL. Since the system can have a range of parameters (e.g. authorized to do transformation x at compute locations of a, b, or c) the JIT, JIC, JIP elements can leverage system state information (about both the processing system and the observed system of interest) and planning or modeling modules to compute at least one parameter set (e.g. execution of pipeline may say based on current conditions use compute location b) at execution time. This may also be done at the highest level or delegated to lower level resources when considering the spectrum from centralized cloud clusters (i.e. higher) to extreme edge (e.g. a wearable, or phone or laptop). The examples given were chosen for illustrative purposes only and represent a small number of the simplest of possibilities. These examples should not be taken to define the possible graphs expected as part of operation of the invention

As used herein, “transformation” is a function performed on zero or more streams of input data which results in a single stream of output which may or may not then be used as input for another transformation. Transformations may comprise any combination of machine, human or machine-human interactions Transformations need not change data that enters them, one example of this type of transformation would be a storage transformation which would receive input and then act as a queue for that data for subsequent transformations. As implied above, a specific transformation may generate output data in the absence of input data. A time stamp serves as an example. In the invention, transformations are placed into pipelines such that the output of one transformation may serve as an input for another. These pipelines can consist of two or more transformations with the number of transformations limited only by the resources of the system. Historically, transformation pipelines have been linear with each transformation in the pipeline receiving input from one antecedent and providing output to one subsequent with no branching or iteration. Other pipeline configurations are possible. The invention is designed to permit several of these configurations including, but not limited to: linear, afferent branch, efferent branch and cyclical.

A “pipeline,” as used herein and interchangeably referred to as a “data pipeline” or a “processing pipeline,” refers to a set of data streaming activities and batch activities. Streaming and batch activities can be connected indiscriminately within a pipeline and compute, transport or storage (including temporary in-memory persistence such as Kafka topics) may be optionally inferred/suggested by the system or may be expressly defined in the pipeline domain specific language. Events will flow through the streaming activity actors in a reactive way. At the junction of a streaming activity to batch activity, there will exist a StreamBatchProtocol data object. This object is responsible for determining when and if the batch process is run. One or more of three possibilities can be used for processing triggers: regular timing interval, every N events, a certain data size or chunk, or optionally an internal (e.g. APM or trace or resource based trigger) or external trigger (e.g. from another user, pipeline, or exogenous service). The events are held in a queue (e.g. Kafka) or similar until processing. Each batch activity may contain a “source” data context (this may be a streaming context if the upstream activities are streaming), and a “destination” data context (which is passed to the next activity). Streaming activities may sometimes have an optional “destination” streaming data context (optional meaning: caching/persistence of events vs. ephemeral). System also contains a database containing all data pipelines as templates, recipes, or as run at execution time to enable post-hoc reconstruction or re-evaluation with a modified topology of the resources (e.g. compute, transport or storage), transformations, or data involved.

### Conceptual Architecture

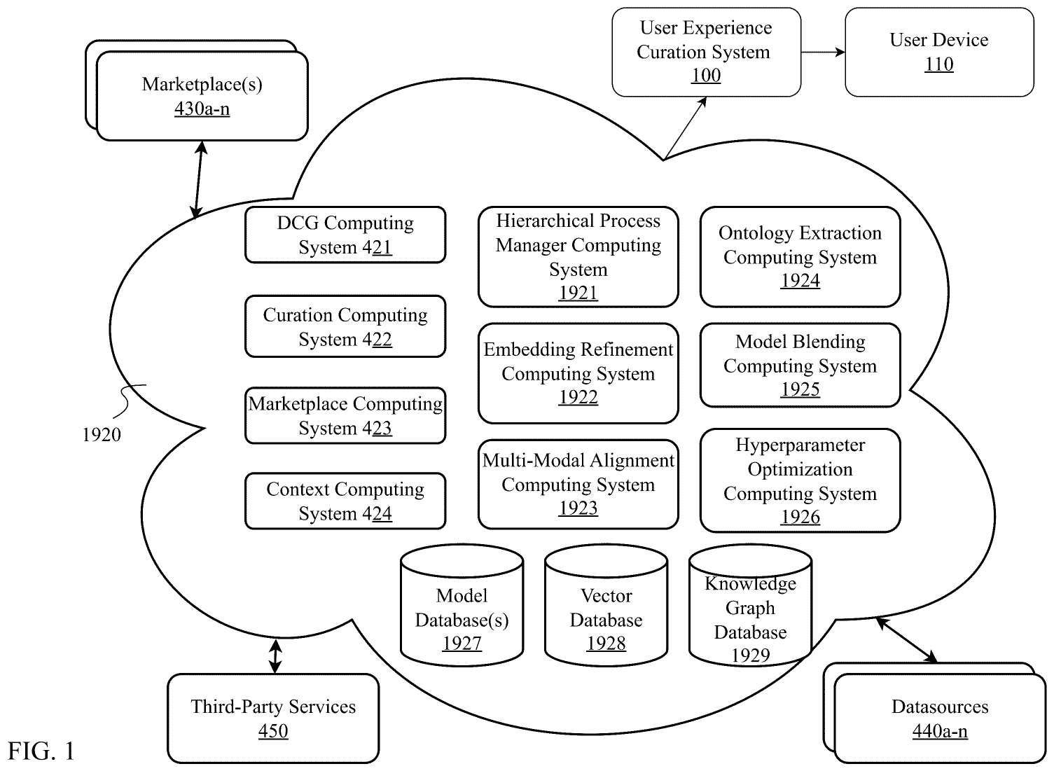

FIG. 1 is a block diagram illustrating an exemplary system architecture for a distributed, composite symbolic and non-symbolic AI platform with user experience curation capabilities. A user experience curation system 100 is a component in a distributed, composite symbolic and non-symbolic AI platform. The system leverages the capabilities of the integrated Gen AI (Gen AI) systems within the platform to create highly personalized and engaging user experiences and interfaces across various domains, such as environments, sounds, visuals, chatbots, and other UI/UX elements. The user experience curation system 100 interacts with multiple components of the AI platform to gather relevant information and generate tailored user experiences. It communicates with the DCG computing system 421 to access and process user data, preferences, and interactions, enabling the creation of user-specific profiles. These profiles form the foundation for generating personalized content and experiences.

In some implementations, the user experience curation system 100 may be located as a central service provider which acts as a central hub that offers various services to multiple clients or users, managing and delivering these services from a single point of control. This centralization can help streamline operations, enhance efficiency, improve security, and provide consistent service delivery. For example, this may be implemented as a cloud-based offering, as a content delivery network (CDN), as a software as a service offering, and/or the like. In another implementation, the user experience curation system 100 may be implemented as a system on the edge (e.g., located at a user's house where curation is provided just-in-time), which encompasses inference at the edge. Instead of relying solely on a centralized data center or cloud, edge computing involves processing data (e.g., experience curation) at or near the source of data generation.

To generate context-aware and coherent user experiences, the user experience curation system 100 collaborates with the context computing system 424. This system provides the necessary contextual information and domain knowledge required to ensure that the generated experiences align with the user's current context and expectations. The user experience curation system 100 also interacts with the curation computing system 422 and the marketplace computing system 423 to access a wide range of curated content, templates, and assets. These resources serve as building blocks for generating rich and diverse user experiences across different domains.

To create truly intelligent and adaptive user experiences, the user experience curation system 100 leverages the capabilities of the hierarchical process manager computing system 1921, which orchestrates the various Gen AI systems within the platform. This includes the embedding refinement computing system 1922 for generating high-quality embeddings, the multi-modal alignment computing system 1923 for ensuring consistency across different modalities, and the ontology extraction computing system 1924 for incorporating domain-specific knowledge into the generated experiences.

The user experience curation system 100 also utilizes the model blending computing system 1925 to combine different AI models and techniques seamlessly, enabling the generation of complex and multi-faceted user experiences. The hyperparameter optimization computing system 1926 is employed to fine-tune the AI models and ensure optimal performance for each user's specific requirements.

To store and manage the generated user experiences, the user experience curation system 100 interacts with various databases within the platform, which may include the model database(s) 1927, vector database 1928, and knowledge graph database 1929. These databases provide efficient storage and retrieval of user-specific data, embeddings, and knowledge representations.

The user experience curation system 100 also communicates with external data sources 440a-n and third-party services 450 to incorporate additional data and functionality into the generated user experiences. This allows for the integration of real-time information, social media data, user interaction data, and other relevant content to enhance the overall user experience. The user experience curation system 100 delivers the generated user experiences to a user device 110, ensuring a seamless and interactive experience for the end-user. The system continuously monitors user interactions and feedback, using this information to refine and improve the generated experiences over time.

The user experience curation system 100 is a powerful addition to an AI platform, enabling the creation of highly personalized, context-aware, and engaging user experiences across various domains. By leveraging the capabilities of the integrated Gen AI systems and collaborating with other components of the platform, this system revolutionizes the way users interact with digital systems, delivering truly intelligent and adaptive experiences tailored to each user's unique preferences and needs. From the perspective of a user, generated environments, sounds, visuals, and other UI/UX elements may feel like “magic,” however, the “magic” is a plurality of AI systems working together to generate and deliver tailored experiences and interfaces to a user.

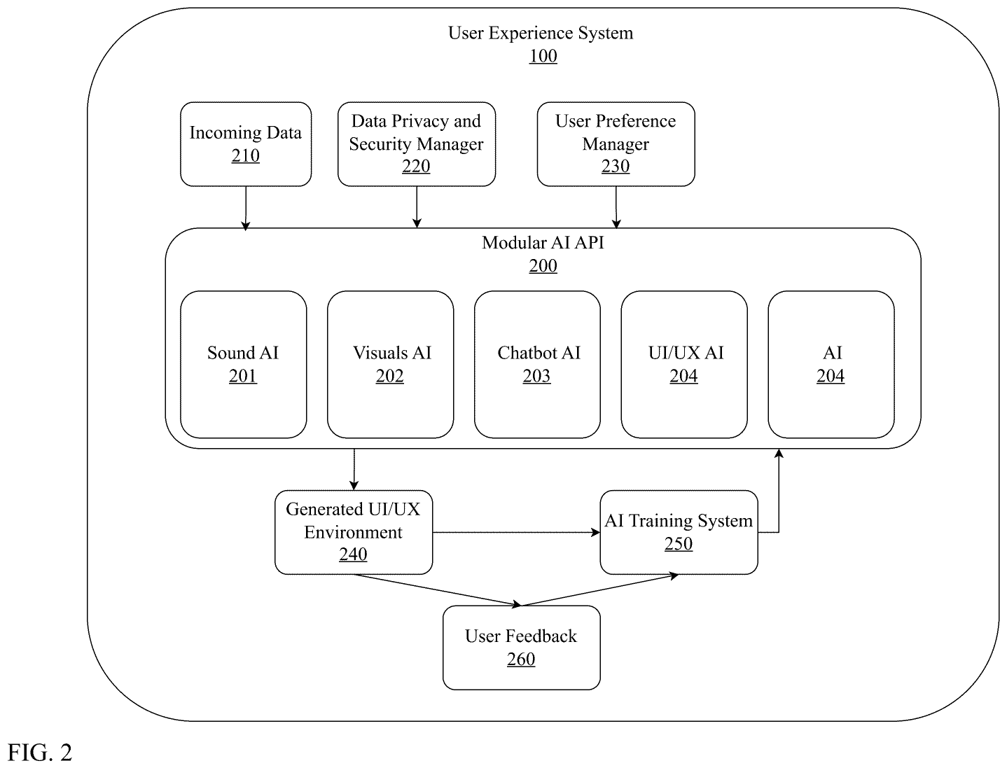

FIG. 2 is a block diagram illustrating a component of a system for a distributed, composite symbolic and non-symbolic AI platform with user experience curation capabilities, a user experience curation system. The user experience curation system 100, in a preferred embodiment, is an AI-driven platform designed to generate personalized and engaging user experiences across various aspects of the interface which comprises a plurality of AI subsystems, each tailored towards a particular part of UI/UX creation. The user experience curation system 100 utilizes a modular AI API 200, which serves as the central hub for communication and coordination between the different AI subsystems. These subsystems may include but are not limited to a sound AI 201, a visuals AI 202, a chatbot AI 203, and a UI/UX AI 204, each focusing on a specific aspect of the user experience.

The sound AI 201 is responsible for generating and manipulating audio elements, such as music, sound effects, and speech synthesis. It ensures that the auditory aspects of the user experience are engaging, immersive, and tailored to the user's preferences. The visuals AI 202 handles the generation and optimization of visual content, including images, videos, and animations. It leverages advanced computer vision techniques to create visually appealing and contextually relevant graphics that enhance the overall user experience.

The chatbot AI 203 powers the conversational interfaces within the system, enabling natural language interactions between the user and the AI. It may utilize natural language processing (NLP) and natural language generation (NLG) techniques to understand user inputs, maintain context, and provide intelligent and personalized responses. It may further utilize retrieval augmented generation (RAG), hyperparameter optimization, knowledge graphs and vector representations and databases. The UI/UX AI 204 focuses on the design and optimization of the user interface and user experience elements. It takes into account user preferences, behavior patterns, and contextual information to generate intuitive, user-friendly, and visually intentional interfaces that adapt to the user's needs, process needs or creators' desires.

Incoming data 210 represents user data from various sources, such as user interactions, preferences, and external data feeds. This data is crucial for understanding user context, personalizing experiences, and enabling the AI subsystems to make informed decisions. To ensure the privacy and security of user data, a data privacy and security manager 220 implements robust encryption, access control, and data protection measures. It ensures compliance with relevant privacy regulations and allows users to control their data sharing preferences. Incoming data 210 may include, but is not limited to, device type information, audio data, visual data, telematics, haptic data, smells, environmental conditions, user security settings, user privacy settings, user disabilities and sensory ranges, user health and faculties, other user device information, user preference settings, fragrances, pressure, temperature, humidity, brain wave data, molecular composition of air or water or solutions in the vicinity of the users, motion data, tastes, and various other inputs.

A user preference manager 230 enables users to set and modify their preferences, including accessibility settings, content preferences, and personalization options. It provides a user-friendly interface for users to tailor their experiences according to their individual needs and preferences. A generated UI/UX environment 240 represents the output of the user experience curation system 100. It is a dynamic, personalized, and context-aware interface that combines the outputs from the various AI subsystems. This environment adapts in real-time based on user interactions, preferences, and contextual factors, providing a seamless and engaging user experience. Examples of various generated elements that may be produced by the system can include, but are not limited to, elements such as audio, visual, smell or fragrance, pressure, temperature, humidity, direct brain stimulus via neural interface, other environmental elements to include molecular composition of air or water or solutions in vicinity of user, telematics motion, taste, haptic, and user inputs.

To continuously improve the performance and effectiveness of the AI subsystems, the AI training system 250 utilizes user feedback, interaction data, and machine learning techniques. It enables the subsystems to learn from user behavior, adapt to changing user needs, and optimize their outputs for better user experiences.

User feedback 260 allows users to provide direct input and ratings on their experiences. This feedback is processed by the AI training system 250 to refine the AI subsystems and ensure that the generated experiences align with user expectations and preferences. User feedback may be provided to the system to real-time feedback to dynamically alter the generated experience moment or sequence of moments or progression of sequences, or environment, according to an embodiment.

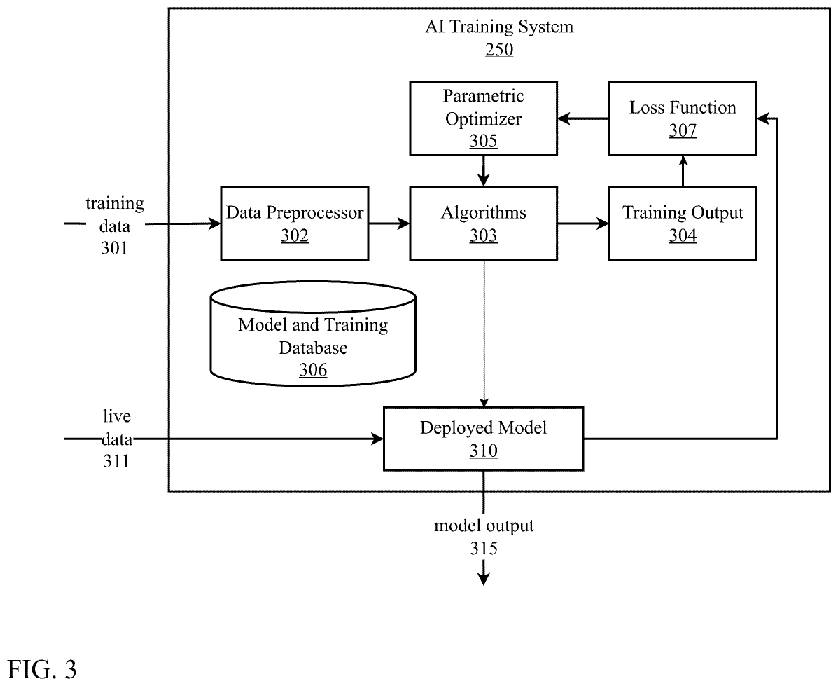

FIG. 3 is a block diagram illustrating a component of a system for a distributed, composite symbolic and non-symbolic AI platform with user experience curation capabilities, an AI training system 250. According to the embodiment, the AI training system 250 may comprise a model training stage comprising a data preprocessor 302, one or more machine and/or deep learning algorithms 303, training output 304, and a parametric optimizer 305, and a model deployment stage comprising a deployed and fully trained model 310 configured to perform tasks described herein such determining correlations between compressed data sets. The correlation network training system 370 may be used to train and deploy a plurality of AI subsystems in order to support the services provided by the AI platform.

At the model training stage, a plurality of training data 301 may be received by the AI training system 250. Data preprocessor 302 may receive the input data (e.g., user feedback, user input data) and perform various data preprocessing tasks on the input data to format the data for further processing. For example, data preprocessing can include, but is not limited to, tasks related to data cleansing, data deduplication, data normalization, data transformation, handling missing values, feature extraction and selection, mismatch handling, and/or the like. Data preprocessor 302 may also be configured to create training dataset, a validation dataset, and a test set from the plurality of input data 301. For example, a training dataset may comprise 80% of the preprocessed input data, the validation set 10%, and the test dataset may comprise the remaining 10% of the data. The preprocessed training dataset may be fed as input into one or more machine and/or deep learning algorithms 303 to train a predictive model for object monitoring and detection.

During model training, training output 304 is produced and used to measure the accuracy and usefulness of the predictive outputs. During this process a parametric optimizer 305 may be used to perform algorithmic tuning between model training iterations. Model parameters and hyperparameters can include, but are not limited to, bias, train-test split ratio, learning rate in optimization algorithms (e.g., gradient descent), choice of optimization algorithm (e.g., gradient descent, stochastic gradient descent, of Adam optimizer, etc.), choice of activation function in a neural network layer (e.g., Sigmoid, ReLu, Tan h, etc.), the choice of cost or loss function the model will use, number of hidden layers in a neural network, number of activation unites in each layer, the drop-out rate in a neural network, number of iterations (epochs) in a training the model, number of clusters in a clustering task, kernel or filter size in convolutional layers, pooling size, batch size, the coefficients (or weights) of linear or logistic regression models, cluster centroids, and/or the like. Parameters and hyperparameters may be tuned and then applied to the next round of model training. In this way, the training stage provides a machine learning training loop.

In some implementations, various accuracy metrics may be used by the AI training system 250 to evaluate a model's performance. Metrics can include, but are not limited to, word error rate (WER), word information loss, speaker identification accuracy (e.g., single stream with multiple speakers), inverse text normalization and normalization error rate, punctuation accuracy, timestamp accuracy, latency, resource consumption, custom vocabulary, sentence-level sentiment analysis, multiple languages supported, cost-to-performance tradeoff, and personal identifying information/payment card industry redaction, to name a few. In one embodiment, the system may utilize a loss function 307 to measure the system's performance. The loss function 307 compares the training outputs with an expected output and determines how the algorithm needs to be changed in order to improve the quality of the model output. During the training stage, all outputs may be passed through the loss function 307 on a continuous loop until the algorithms 303 are in a position where they can effectively be incorporated into a deployed model 315.

The test dataset can be used to test the accuracy of the model outputs. If the training model is establishing correlations that satisfy a certain criterion such as but not limited to quality of the correlations and amount of restored lost data, then it can be moved to the model deployment stage as a fully trained and deployed model 310 in a production environment making predictions based on live input data 311 (e.g., user preferences, user feedback, user inputs). Further, model correlations and restorations made by deployed model can be used as feedback and applied to model training in the training stage, wherein the model is continuously learning over time using both training data and live data and predictions. A model and training database 306 is present and configured to store training/test datasets and developed models. Database 306 may also store previous versions of models.

According to some embodiments, the one or more machine and/or deep learning models may comprise any suitable algorithm known to those with skill in the art including, but not limited to: LLMs, generative transformers, transformers, supervised learning algorithms such as: regression (e.g., linear, polynomial, logistic, etc.), decision tree, random forest, k-nearest neighbor, support vector machines, Naïve-Bayes algorithm; unsupervised learning algorithms such as clustering algorithms, hidden Markov models, singular value decomposition, and/or the like. Alternatively, or additionally, algorithms 303 may comprise a deep learning algorithm such as neural networks (e.g., recurrent, convolutional, long short-term memory networks, etc.).

In some implementations, the AI training system 250 automatically generates standardized model scorecards for each model produced to provide rapid insights into the model and training data, maintain model provenance, and track performance over time. These model scorecards provide insights into model framework(s) used, training data, training data specifications such as chip size, stride, data splits, baseline hyperparameters, and other factors. Model scorecards may be stored in database(s) 306.

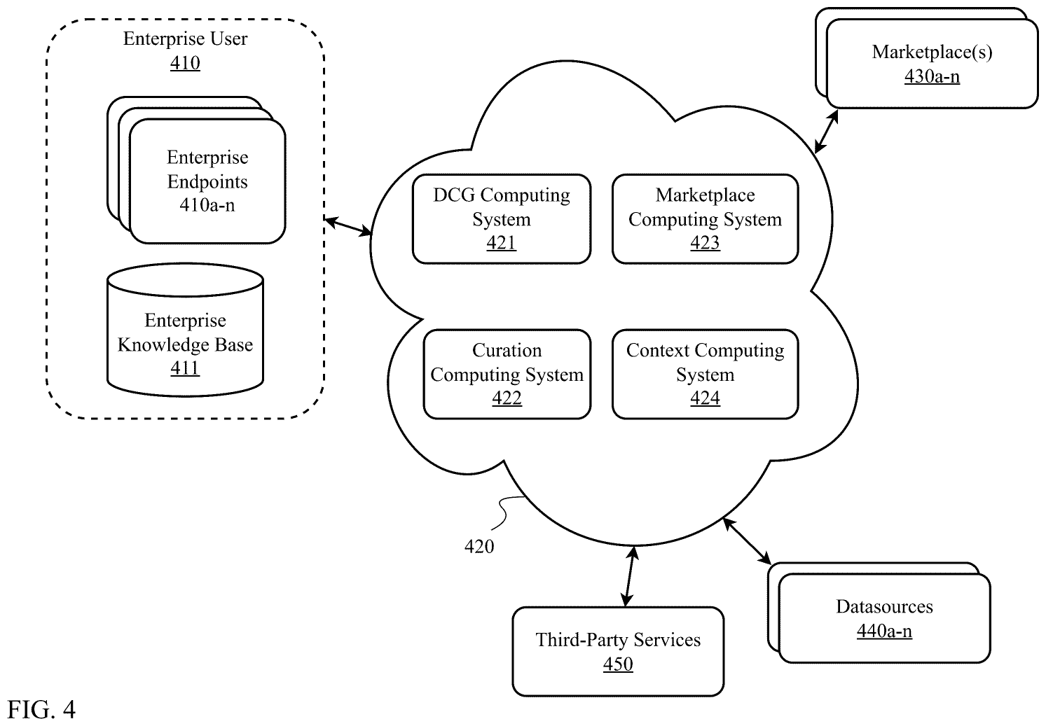

FIG. 4 is a block diagram illustrating an exemplary system architecture for a distributed generative artificial intelligence reasoning and action platform 420, according to an embodiment. According to the embodiment, platform 420 is configured as a cloud-based computing platform comprising various system or sub-system components configured to provide functionality directed to the execution of neuro-symbolic Gen AI reasoning and action. Exemplary platform systems can include a distributed computational graph (DCG) computing system 421, a curation computing system 422, a marketplace computing system 423, and a context computing system 424. In some embodiments, systems 421-424 may each be implemented as standalone software applications or as a services/microservices architecture which can be deployed (via platform 420) to perform a specific task or functionality. In such an arrangement, services can communicate with each other over an appropriate network using lightweight protocols such as HTTP, gRPC, or message queues. This allows for asynchronous and decoupled communication between services. Services may be scaled independently based on demand, which allows for better resource utilization and improved performance. Services may be deployed using containerization technologies such as Docker or containerd and orchestrated using container orchestration platforms like Kubernetes. This allows for easier deployment and management of services.

The distributed Gen AI enhanced reasoning and action platform 420 can enable a more flexible approach to incorporating statistics, modeling simulation, machine learning (ML), and planning models and capabilities into the future of the Internet and software applications via experience, interface, text and media generation and translation into accessible formats and sequences; all facilitated by a highly scalable DCG architecture capable of dynamically selecting, creating, and incorporating trained models with external data sources and marketplaces for data and algorithms and aiding in coordination of such content's production, training, modeling, simulation or federation or distribution across heterogeneous device types and owners (e.g., personal cell phone vs hyperscaler cloud resource vs third party CDN) and the changing regulatory, privacy, legal, cultural and contractual environments that might influence optimal data, compute, storage or transport locality and topography management.

According to the embodiment, DCG computing system 421 provides orchestration of complex, user-defined workflows built upon a declarative framework which can allow an enterprise user 410 to construct such workflows using modular components which can be arranged to suit the use case of the enterprise user. As a simple example, an enterprise user 410 can create a workflow such that platform 420 can extract, transform, and load enterprise-specific data to be used as contextual data for creating and training a ML or AI model. The DCG functionality can be extended such that an enterprise user can create a complex workflow directed to the creation, deployment, and ongoing refinement of a trained model (e.g., LLM). For example, in some embodiments, an enterprise user 410 can select an algorithm from which to create the trained model, and what type of data and from what source they wish to use as training data. DCG computing system 421 can take this information and automatically create the workflow, with all the requisite data pipelines, to enable the retrieval of the appropriate data from the appropriate data sources, the processing/preprocessing of the obtained data to be used as inputs into the selected algorithm(s), the training loop to iteratively train the selected algorithms including model validation and testing steps, deploying the trained model, and finally continuously refining the model over time to improve performance.

A context computing system 424 is present and configured to receive, retrieve, or otherwise obtain a plurality of context data from various sources including, but not limited to, enterprise users 410, marketplaces 430a-n, third-party sources 450, and other data sources 440a-n. Context computing system 424 may be configured to store obtained contextual data in a data store. For example, context data obtained from various enterprise endpoints 410a-n of a first enterprise may be stored separately from the context data obtained from the endpoints of a second enterprise. In some embodiments, context data may be aggregated from multiple enterprises within the same industry and stored as a single corpus of contextual data. In such embodiments, contextual data may be transformed prior to processing and storage so as to protect any potential private information or enterprise-specific secret knowledge that the enterprise does not wish to share.

A curation computing system 422 is present and configured to provide curated (or not) responses from a trained model (e.g., LLM) to received user queries. A curated response may indicate that it has been filtered, such as to remove personal identifying information or to remove extraneous information from the response, or it may indicate that the response has been augmented with additional context or information relevant to the user. In some embodiments, multiple trained models (e.g., LLMs) may each produce a response to a given prompt, which may include additional contextual data/elements, and a curation step may include selecting a single response of the multiple responses to send to a user, or the curation may involve curating the multiple responses into a single response. The curation of a response may be based on rules or policies that can set an individual user level, an enterprise level, or at a department level for enterprises with multiple departments (e.g., sales, marketing, research, product development, etc.).

According to the embodiment, an enterprise user 410 may refer to a business organization or company. An enterprise may wish to incorporate a trained ML model into their business processes. An enterprise may comprise a plurality of enterprise endpoints 410a-n which can include, but are not limited to, mobile devices, workstations, laptops, personal computers, servers, switches, routers, industrial equipment, gateways, smart wearables, Internet-of-Things (IoT) devices, sensors, and/or the like. An enterprise may engage with platform 420 to create a trained model to integrate with its business processes via one or more enterprise endpoints. To facilitate the creation of purpose-built, trained model, enterprise user 410 can provide a plurality of enterprise knowledge 411 which can be leveraged to build enterprise specific (or even specific to certain departments within the enterprise) ML/AI models. Enterprise knowledge 411 may refer to documents or other information important for the operation and success of an enterprise. Data from internal systems and databases, such as customer relationship management (CRM) systems, enterprise resource planning (ERP) systems, rules and policies databases, and transactional databases, can provide information about the operational context of an enterprise. For example, product knowledge, market knowledge, industry trends, regulatory knowledge, business processes, customer knowledge, technology knowledge, financial knowledge, organization knowledge, and risk management knowledge may be included in enterprise knowledge base 411.

According to the embodiment, platform 420 is configured to retrieve, receive, or otherwise obtain a plurality of data from various sources. A plurality of marketplaces 430a-n may be present and configured to provide centralized repositories for data, algorithms, and expert judgment, which can be purchased, sold, or traded on an open marketplace. External data sourced from various marketplaces 430a-n can be used as a training data source for creating trained models for a particular use case. A marketplace computing system 423 is present and configured to develop and integrate various marketplaces 430a-n. Marketplace computing system 423 can provide functionality directed to the registration of experts or entities. An expert may be someone who has a deep understanding and knowledge of a specific industry, including its trends, challenges, technologies, regulations, and best practices. Industry experts often have many years of experience working in the industry and have developed a reputation for their expertise and insights. Examples of experts can include, but are not limited to, consultants, analysts, researchers, academics, or professionals working in the industry. In some embodiments, experts and/or entities can register with platform 420 so that they may become verified experts/entities. In such an embodiment, an expert/entity profile may be created which can provide information about expert judgment, scored data and algorithms, and comparisons/statistics about the expert's/entity's scores and judgment with respect to other expert/entities. Marketplace computing system 423 may further provide functionality directed to the management of the various marketplaces and the data/algorithms provided therein.

According to some embodiments, platform 420 can communicate with and obtain data from various third-party services 450. For example, third-party services can include LLM services such as APIs and LLM hosting platforms, which platform 420 can interface with to obtain algorithms or models to use as starting points for training a neuro-symbolic Gen AI reasoning and action model to be deployed at the enterprise or individual level. As another example, social media platforms can provide data about trends, events, and public sentiment, which can be useful for understanding the social context of a situation. Exemplary data sources 440a-n can include, but are not limited to, sensors, web data, environmental data, and survey and interviews.

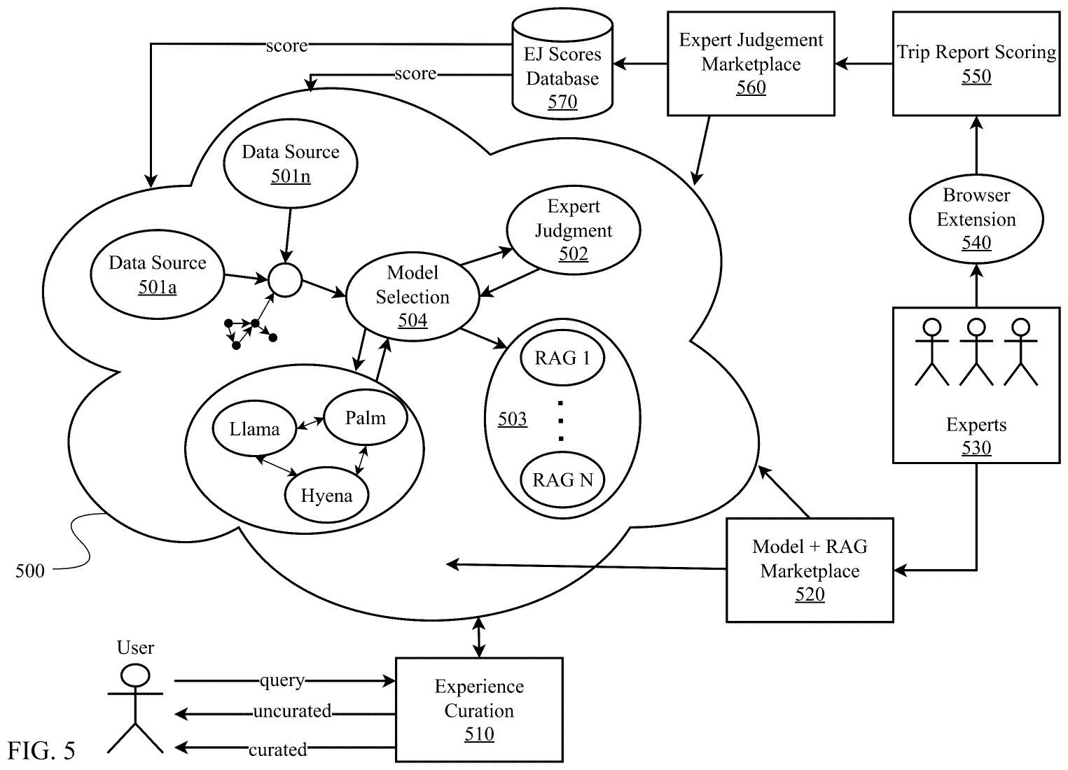

FIG. 5 is a block diagram illustrating an exemplary aspect of a distributed Gen AI reasoning and action platform incorporating various additional contextual data. According to the aspect, a plurality of contextual data from various data sources may be integrated into platform 420. A simple exemplary directed computational graph 500 is illustrated within the cloud and utilizing the plurality of contextual data to create and train a model. Various marketplaces 430a-n are shown which can provide contextual data to platform 420 including an expert judgment marketplace 560 and a model and retrieval augmented generation (RAG) marketplace 520. According to the aspect, DCG 500 orchestrates model (and model weight) selection 504, including multi-model usage in series or parallel (i.e., feed output of one model into another, or compare and choose outputs across multiple models), based on multiple data sources (both trained and external), input from crowdsourced expert judgment, training or tuning data set corpora, and RAG libraries.

Expert judgment will become increasingly important in the world of proprietary or otherwise black box ML or AI models where hallucinations and training data quality may produce misleading or otherwise incorrect results. The expert judgment marketplace 560 provides a way for experts 530 to weigh-in on the correctness of data whether that is training data or model output, and can be facilitated by a browser extension 540, for example, to score things like data sources during their daily “trip around web”. This trip report scoring 550 concept allows experts to score data sources. In an implementation, a browser extension 540 is developed with an accuracy score input where the user can rank a news article they are reading as they consume it. Expert judgment marketplace 560 allows for consumers to pick and rank “experts” based on how well their judgment helps or hinders their overall consumption of model output. For example, experts that routinely highly rank data sources, like news sites, that are known to spread false information should likewise be less trusted over time compared to their peers, and any models trained on that data similarly less trusted. Ultimately a database 570 of data sources and schemas scored by algorithms or experts could be used as input into the DCG 500 for more accurate and real-time inference based on ongoing rating of preferred data set and data format combinations (e.g. the same data might be purchased in unstructured, structured, schematized, normalized, or semantified formats) which may introduce different types of bias or impacts on performance, results, or processing costs.

Accordingly, a RAG marketplace 520 may be implemented to further refine model output. RAG information may be included as additional context which can be supplied to a Gen AI model in addition to a prompt (engineered, or otherwise). This is especially important where companies may want to sell access to their proprietary dataset through the form of a RAG. For example, a medical research company may have valuable information they could sell to other institutions in the form of a RAG to augment related research without specifically providing access to the raw training data. Retrieval-augmented generation is a framework that combines elements of retrieval-based and generative models to improve the performance of natural language processing tasks. In RAG, a retriever component is used to select relevant information from a large corpus, and a generator component is used to produce a final output based on both the retrieved information and the input query. RAG marketplace 520 may be scored by experts for accuracy and effectiveness across domains.

According to the aspect, a user experience curation engine 510 is needed that is able to curate output whether that is in the form of filtering out sensitive data or simply customizing results in a way the user prefers (which may be based on user-/entity-defined rules or policies). A user can submit a query to experience curation engine 510 which can send the query to the DCG trained model to obtain a response. Experience curation 510 may then process the received response to curate it (or not) to meet the preferences of the user.

As illustrated, DCG 500 shows a simple example of a directed computational graph which can be used to create a complex workflow to create and train an MI/AI model (e.g., variations of or standard transformer architecture). A shown, the DCG comprises multiple sources of information for training the selected models(s) including multiple data sources 501a-n which may or may not be scored by experts, expert judgment 502, and one or more RAGs 503 which may be obtained from RAG marketplace 520 or may be obtained directly from enterprise knowledge. DCG may have access to stored models or variants thereof. In the illustration, LLAMA (Learned Layer-wise Attention Metric for Transformers), PALM (Permuted Adaptive Lateral Modulation), and HYENA (Hyperbolic Encoder for Efficient Attention) are shown as possible examples of the types of models which can be selected by the DCG to create and train a Gen AI model. Furthermore, the “model parameters” and mathematical techniques or assumptions used in each model may be cataloged and included in a model-specific template which may be stored in cloud-based storage on platform 420. In some embodiments, platform 420 may store a hierarchical representation of transformer models (e.g., as a graph), which may represent a lineage of the evolution of transformer models. In an implementation, model selection or exploration involves selections based on the evolutionary tree of one or more model types and use said tree (e.g., graph) for selections in heuristic search for best algorithm/data combinations, licensing costs/explorations, etc. It should be appreciated that certain aspects of the invention may be tailored based on what kind of mathematical approach underpins a specific model.

In operation, DCG 500 obtains the various contextual data from the connected data sources, creates training, validation, and test datasets from the obtained data, and uses the various datasets to train, validate, and test the model as it undergoes a model training loop that iteratively trains the model to generate responses based on the plurality of contextual data.

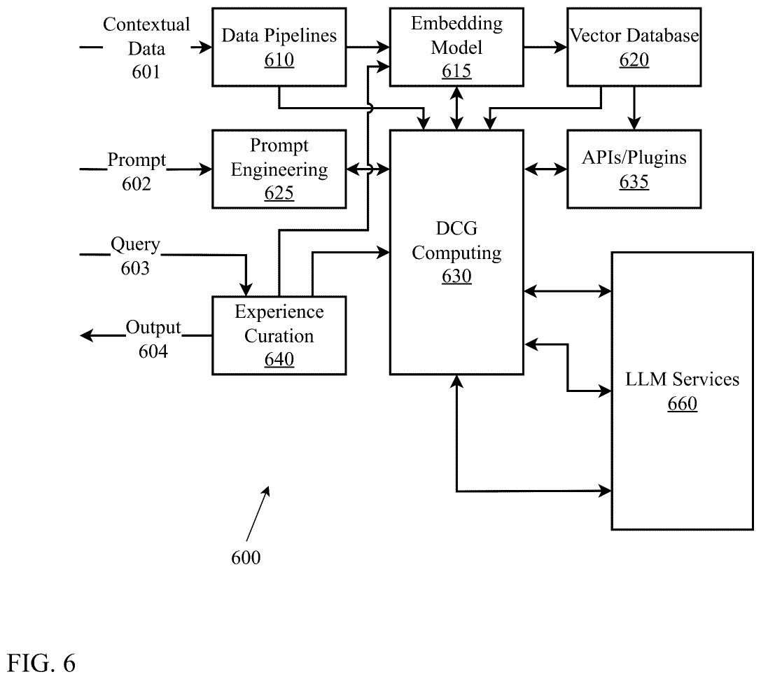

FIG. 6 is a diagram illustrating incorporating symbolic reasoning in support of LLM-based Gen AI, according to an aspect of a neuro-symbolic Gen AI reasoning and action platform. According to the aspect, platform 420 can incorporate symbolic reasoning and in-context learning to create and train off the shelf models (e.g., an LLM foundational model or narrow model) through clever prompting and conditioning on private data or very situation specific “contextual” data. Platform 420 can obtain contextual data 601 and preprocess the data for storage. Contextual data 601 may refer to data obtained from marketplaces 430a-n, third-party services 450, and enterprise knowledge 411, as well as other types of contextual data that may be obtained from other sources. DCG 630 is responsible for orchestrating the entire process and can create data pipelines 610 as needed to facilitate the ingestion of contextual data 601. Contextual data can include text documents, PDFs, and even structure formats like CSV (comma-separated values) or SQL tables or other common generic data formats like OWL or RDF or domain specific content such as the Financial Industry Business Ontology (FIBO) or Open Graph of Information Technology (OGIT). This stage involves storing private data (e.g., context data) to be retrieved later.

Typically, the context data 601 is broken into chunks, passed through and embedding model 615, then stored in a specialized database called a vector database 620. Embedding models are a class of models used in many tasks such as natural language processing (NLP) to convert words, phrases, or documents into numerical representations (embeddings) that capture similarity which often correlates semantic meaning. Exemplary embedding models can include, but are not limited to, text-embedding-ada-002 model (i.e., OpenAI API), bidirectional encoder representations form transformers, Word2Vec, FastText, transformer-based models, and/or the like. The vector database 615 is responsible for efficiently storing, comparing, and retrieving a large plurality of embeddings (i.e., vectors). Vector database 615 may be any suitable vector database system known to those with skill in the art including, but not limited to, open source systems like Pinecone, Weaviate, Vespa, and Qdrant. According to the embodiment, embedding model 615 may also receive a user query from experience curation 640 and vectorize it where it may be stored in vector database 620. This provides another useful datapoint to provide deeper context when comparing received queries against stored query embeddings.

A user may submit a query 603 to an experience curation engine 640 which starts the prompt construction and retrieval process. The query is sent to DCG 630 which can send the query to various components such as prompt engineering 625 and embedding model 615. Embedding model 615 receives the query and vectorizes it and stores it in vector database 620. The vector database 620 can send contextual data (via vectors) to DCG 630 and to various APIs/plugins 635. Prompt engineering 625 can receive prompts 602 from developers to train the model on. These can include some sample outputs such as in few-shot prompting. The addition of prompts via prompt engineering 625 is designed to ground model responses in some source of truth and provide external context the model wasn't trained on. Other examples of prompt engineering that may be implemented in various embodiments include, but are not limited to, chain-of-thought, self-consistency, generated knowledge, tree of thoughts, directional stimulus, and/or the like.

During a prompt execution process, experience curation 640 can send user query to DCG 630 which can orchestrate the retrieval of context and a response. Using its declarative roots, DCG 630 can abstract away many of the details of prompt chaining; interfacing with external APIs 635 (including determining when an API call is needed); retrieving contextual data from vector databases 630; and maintaining memory across multiple LLM calls. The DCG output may be a prompt, or series of prompts, to submit to a language model via LLM services 660 (which may be potentially prompt tuned). In turn, the LLM processes the prompts, contextual data, and user query to generate a contextually aware response which can be sent to experience curation 640 where the response may be curated, or not, and returned to the user as output 604.

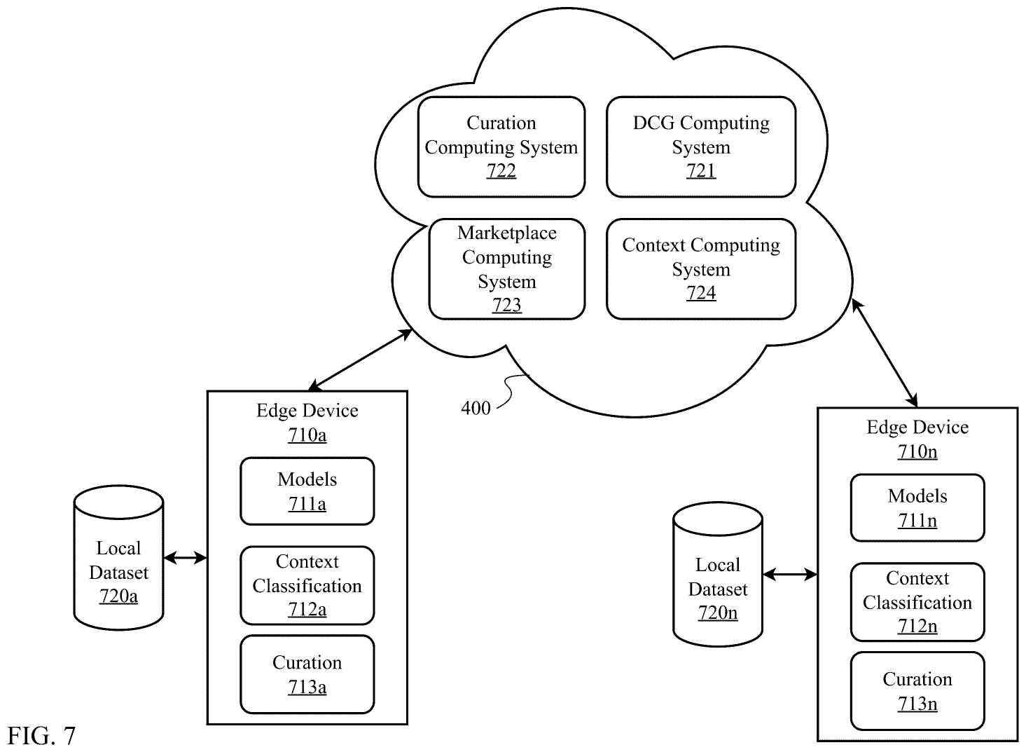

FIG. 7 is a block diagram illustrating an exemplary architecture for a neuro-symbolic Gen AI reasoning and action platform 700 configured for federated learning at a plurality of edge devices 710a-n, according to an embodiment. According to the embodiment, platform 700 comprises DCH computing system 721, curation computing system 722, marketplace computing system 723, and context computing system 724. According to an embodiment, edge devices 710a-n may represent various enterprise endpoints. In other embodiments, edge devices 710a-n may represent various endpoints from two or more separate enterprises. In an embodiment, an edge device 710a-n may be a computing device associated with a platform user, such as someone who engages with the platform for experience curation or an expert who provides expert judgment scores to platform 700 via, for example, expert judgment marketplace 560 or some other mechanism.

As shown, each edge device 710a-n may comprise instances of local models 711a-n, context classification processes 712-n, and experience curation processes 713a operating on the device. Each edge device may have access to a local data or knowledge base 720a-n and which is only accessible by its associated edge device. Edge devices 710a-n may utilize these components to perform various computations wherein the processing of data and execution of algorithms happens locally on the device, rather than relying on the systems and services provided by platform 700. In some embodiments, a plurality of edge devices 710a-n may be implemented as individual computing nodes in a decentralized federated system, wherein tasks and data may be distributed across multiple nodes, allowing for parallel processing and potentially faster computation. Federated systems are often used in scenarios where data privacy and security are important, as data can remain on local nodes and only aggregated or processed results are shared more widely.

In some implementations, the platform 700 may leverage federated learning, where machine learning models 711a-n are trained across multiple decentralized edge devices 710a-n, with the models' updates being aggregated centrally. This approach allows for the training of models without the need to centrally store sensitive data from individual devices. For example, each edge device 710a-n could train local instances of neuro-symbolic Gen AI reasoning and action models and local instances of context classification models 712a-n. According to an embodiment, context classification models 712a-n may be configured to select relevant passages from a knowledge base 720a-n or corpus given a query. This can be done using various techniques such as BM25, TF-IDF, or neural retrieval models like dense passage retrieval. The retrieved passages serve as context or input to a generator (e.g., a transformer-based model).

Federated learning can occur at the edge device wherein the context classification model 712a is trained locally. Periodically, (e.g., hourly, daily, weekly, etc.) platform 700 may collect (e.g., aggregate) model parameters, encrypted data, and/or the like from all of, or a subset of, edge devices 710a-n and apply the aggregated model parameters as an update to a master or global model (e.g., context classification, neuro-symbolic Gen AI model, etc.). The updated global model or just its parameters, may be transmitted to all of, or a subset of, the edge devices 710a-n where they may be applied to the local models operating thereon. Similarly, platform 700 can aggregate obtained training data, which may or may not be encrypted, and apply the training data to global models. These updated models may be transmitted to edge devices as described above.

As shown, edge devices 710a-n may further comprise a curation application 713a-n operating on the device. Curation application 713a may be configured to act as an intermediary between a user who can submit a query and models 711a which receive the query and generate a response back. Curation 713a-n may receive a response from a locally stored model and curate the response based on user (or entity) defined rules or preferences. For example, a response may first be filtered of any personal information by curation 713a prior to the being relayed back to the user. As another example, curation 713a may transform the response into specific format, style, or language based on user defined preferences. This allows the edge device 710a user to have their experience with the local models curated to fit any criteria they deem important.

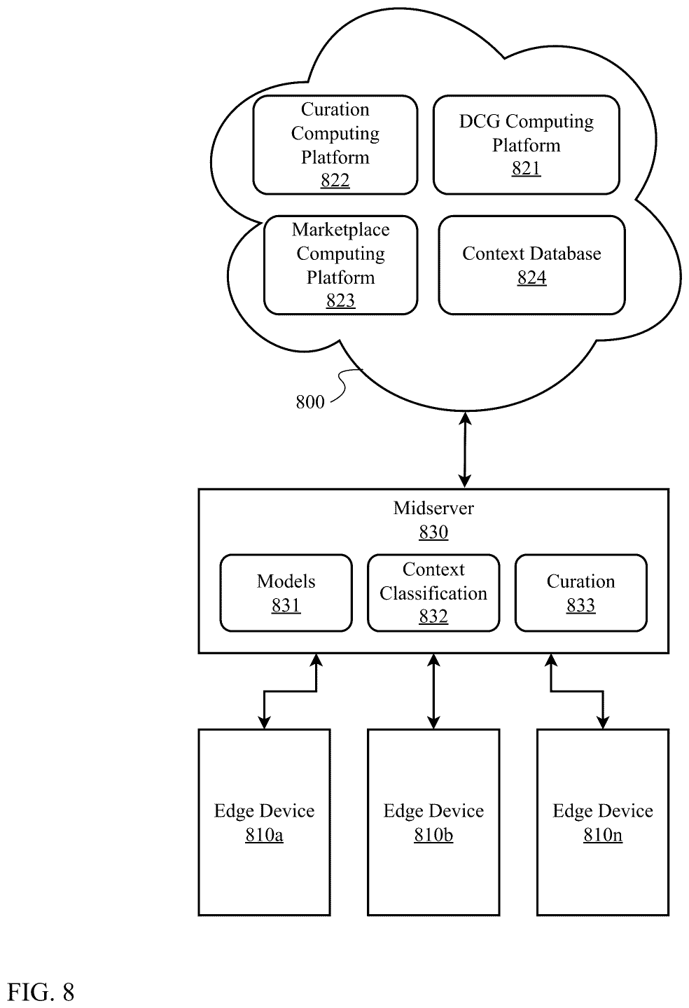

FIG. 8 is a block diagram illustrating an exemplary architecture for a neuro-symbolic Gen AI reasoning and action platform 800 configured to utilize a midserver 830 to act as a computing intermediary between a plurality of edge devices 810a-n and the platform. According to the embodiment, midserver 830 facilitates communication between edge devices 810a-n and the backend systems 821, 822, 823, 824 provided by platform 800. According to the embodiment, midserver 830 may have stored and operating on it one or more neuro-symbolic Gen AI reasoning and action models 831, context classification processes 832, and curation processes 833. Midserver 830 can be configured to periodically receive data (e.g., context data) and state information from each of the connected edge devices 810a-n. Midserver 830 may use this information to train/update the models 831, 832. Additionally, midserver 830 can be configured to receive user-submitted queries from edge devices via curation 833, obtain relevant context associated with the received query via context classification 832, and use a neuro-symbolic Gen AI model 831 to process the query and context data to generate a response to the user. The generated response may be curated (or not) and transmitted back to the user of the edge device.

In some implementations, edge devices 810a-n may have stored upon them local models as described in FIG. 7, and midserver 830 may store global, models or even mid-tier models associated with the local models. In such an implementation, midserver can aggregate model parameters and update the global/mid-tier models accordingly.

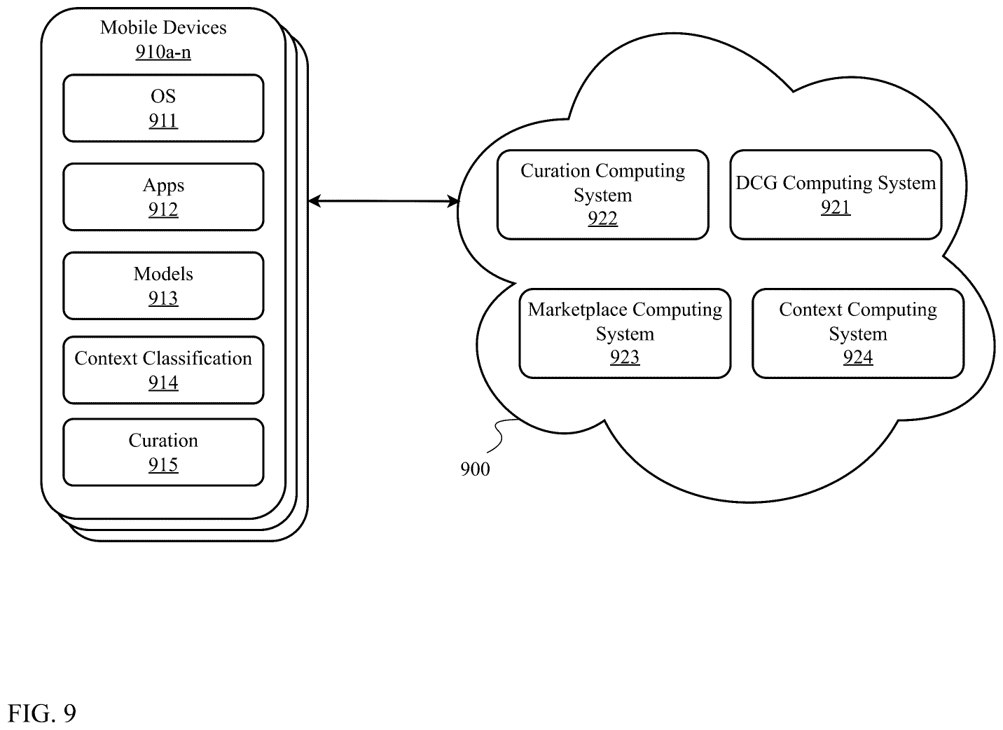

FIG. 9 is a block diagram illustrating an exemplary mobile device 910a-n configured for experience curation using embedded capabilities and functionality provided by a neuro-symbolic Gen AI reasoning and action platform 900, according to an embodiment. According to the embodiment, a mobile device 910a may comprise an operating system 911, various software applications 912 (e.g., text messaging application, social media application, mobile games, music streaming applications, etc.), a local instance of a neuro-symbolic Gen AI model 913, a context classification model 914, and an experience curation application 915. Mobile devices 910a-n may further comprise a processor, memory, sensors, storage, wireless communication modules, a display, audio components, and various other components to enable the functionality of a mobile computing device. Mobile devices 910a-n may connect to platform 900 via a suitable communication network such as the Internet. In some embodiments, mobile device may utilize the systems and services 921, 922, 923, 924 provided by platform to facilitate query-response interactions with a neuro-symbolic Gen AI model.

According to the embodiment, mobile device 910a stores and operates local models 913, 914 and a curation application 915 which can be leveraged during instances when mobile device 910a is unable to connect with platform 900 or otherwise has an intermittent connection thereby making data transmission difficult, slow, or impossible. In such situations, mobile device 910a can leverage the local components to perform computation at the edge. A user of mobile device 910a can use curation application 915 to submit a query to the local neuro-symbolic Gen AI model 913, along with any aggregated context retrieved via context classification 914. The model 913 can generate a response and send it to curation application 915 where it may be curated (or not) based on the mobile device user's preferences or rules.

In some embodiments, when there is only an intermittent connection to platform 900, such as when a mobile device is in an area with poor network coverage, various strategies may be implemented to provide functionality to the mobile device user. For example, data (e.g., a user submitted query or prompt) can be temporarily stored in a buffer on the device until a connection to platform 900 is available. Once the connection is reestablished, the buffered data can be transmitted. Likewise, frequently accessed data or recently transmitted data can be cached on the device. This allows the device to access the data locally when a connection to platform 900 is not available. In some implementations, data can be compressed before transmission to reduce the amount of data that needs to be transmitted. This can help to minimize the impact of intermittent connections on data transmission. In some embodiments, mobile device 910a-n may use protocols that are designed to handle intermittent connections, such as MQTT (Message Queuing Telemetry Transport) or CoAP (Constrained Application Protocol), can help to ensure that data is successfully transmitted even in challenging network conditions. Finally, some use cases may implement an offline mode that allows users to continue using the application (or local instances) and storing data locally until a connection to platform 900 is available again.

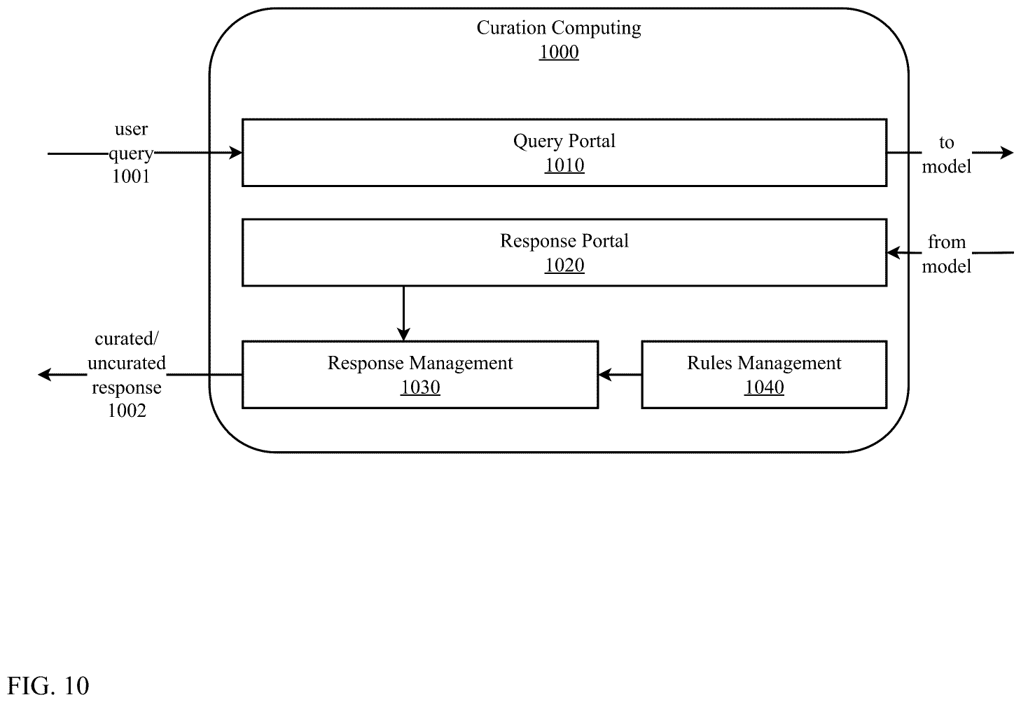

FIG. 10 is a block diagram illustrating an exemplary aspect of a distributed generative artificial intelligence reasoning and action platform, a curation computing system 1000. According to the aspect, curation computing system 1000 is configured to provide curated (or not) responses from a trained model (e.g., transformer-based model) to received user queries. A curated response may indicate that the response has been filtered, such as to remove personal identifying information or to remove extraneous information from the response, or it may indicate that the response has been augmented with additional context or information relevant to the user. The curation of a response may be based on rules or policies that can be set at an individual user level, an enterprise level, or at a department level for enterprises with multiple departments (e.g., sales, marketing, research, product development, etc.). User/entity rules and/or preferences may be stored in a data storage system of platform 420 and retrieved by a rules management component 1040 during experience curation processes.

In operation, curation computing 1000 receives a user query 1001 directed to a neuro-symbolic Gen AI model. A query portal 1010 may be present and configured to receive a query 1001 and prepare it for processing by a Gen AI model. For example, a query may be split into tokens, (e.g., words or sub words) which are basic units of the language model. As another example, a text-based query may undergo normalization (e.g., converting to lowercase, removing punctuation, handling special characters, etc.) to ensure consistency and improve model performance. As yet another example, for models that use attention mechanisms, an attention mask may be applied to the input to indicate which tokens should be attended to and which should be ignored. In some implementations, a query portal 1010 may be configured to send received queries to an embedding model which can vectorize the received query and store it in a vector database. In such embodiments, stored query embeddings may be used as a form of contextual data which may be retrieved and transmitted with the query to a Gen AI model which generates a response based on the received query and contextual data.

According to the aspect, a response portal 1020 is present and configured to receive a response from one a Gen AI model and a response management system 1030 determines if the received response needs to be curated or not. If the response does not need to be curated, then it may be sent as an uncrated response 1002 to the user who submitted the query. Response management 1030 can determine if there are any user/entity defined rules or preferences available such as stored in a user/entity profile in a data storage system of platform 420. Rules management 1040 can retrieve said rules and response management can curate or otherwise augment the received response based on the user/entity rules or preferences. The result is a curated response 1002 which can be transmitted back to the user who submitted the query.

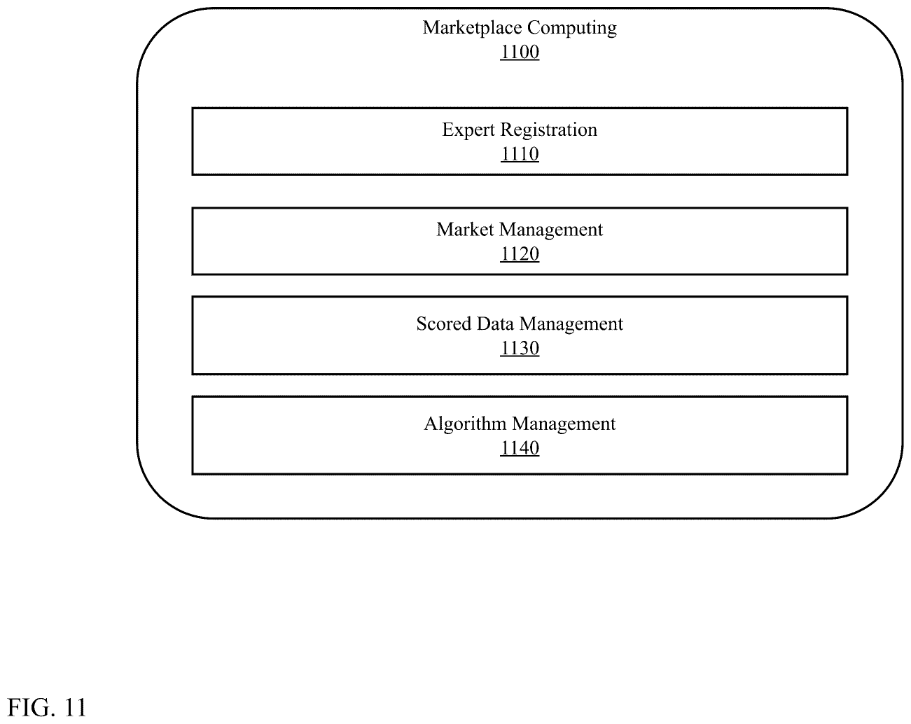

FIG. 11 is a block diagram illustrating an exemplary aspect of a distributed generative artificial intelligence reasoning and action platform, a marketplace computing system 1100. According to the aspect, marketplace computing system 1100 is present and configured to develop and integrate various marketplaces 430a-n for data, algorithms, and RAGs into platform 420. Marketplace computing system 1100 can provide functionality directed to the registration of experts 1110 or entities. An expert may be someone who has a deep understanding and knowledge of a specific industry, including its trends, challenges, technologies, regulations, and best practices. Industry experts often have many years of experience working in the industry and have developed a reputation for their expertise and insights. An expert may be registered by providing proof of identity and qualifications, and creating an expert profile which can store a variety of information about the expert such as their name, industry, credentials, scores (e.g., scores that the expert has assigned to data sources, models/algorithms, model outputs, and/or the like), and reputation. For example, a university professor who specializes in transformer-based algorithms can register as an expert in the realm of generative algorithms. As another example, a virologist could register as an expert and provide scores for academic papers which disclose a new methodology for viral spread modelling.

Marketplace computing system 1100 may further comprise a market management component 1120 which can interface with a plurality of markets 430a-n to integrate information contained therein. A scored data management component 1130 may be configured to interface with a browser extension 540 or expert judgment marketplace 560 to retrieve expert scores and store them in an expert judgment score database 570. According to the aspect, an algorithm management component 1140 is present and configured to acquire algorithms from algorithm marketplaces to be used in the construction and configuration of neuro-symbolic Gen AI models.

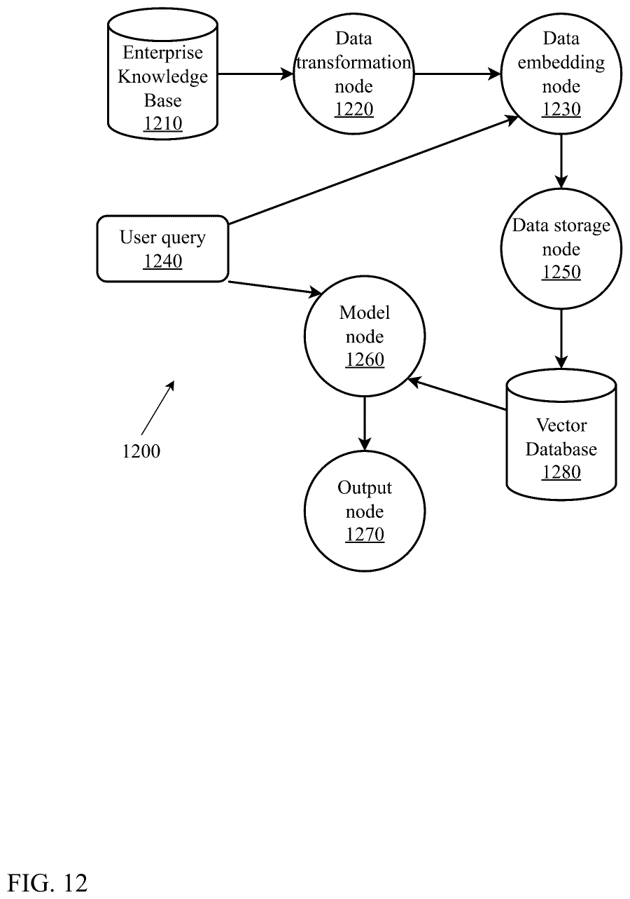

FIG. 12 is a block diagram illustrating a simple example of a distributed computational graph 1200 representation for providing neuro-symbolic Gen AI capabilities, according to an aspect. According to the aspect, the DCG may be represented as a series of nodes which represent discrete computational or data processing functions, and a series of edges connecting the nodes which represent information or data messages being sent between processing nodes. A DCG can be used to acquire a plurality of context data in the form of an enterprise knowledge base 1210. A data transformation node 1220 is created to handle the ingestion and transformation of acquired context data. Obtained data may then be sent to a data embedding node 1230 which can vectorize the received context data. The vectorized data may flow from the embedding node 1230 to a data storage node 1250. Data storage node 1250 may select the appropriate vector database 1280 in which to store the vectorized context data. An input node 1240 may allow for a user to submit a query to the workflow. The user query can be sent to data embedding node 1230 where it may be vectorized and sent to data storage node 1250 for storage in the vector database. The user query can also be sent to a model node 1260 which contains the selected model(s) which will process the user query along with any relevant context data obtained from data storage node vector database 1280. Model node 1260 then processes this information to generate a response which can be sent to output node 1270. In some instances, output node 1270 may output the response directly to the user. In other instances, output node 1270 may be configured to transform the response into a curated response based on user/entity defined rules or preferences.

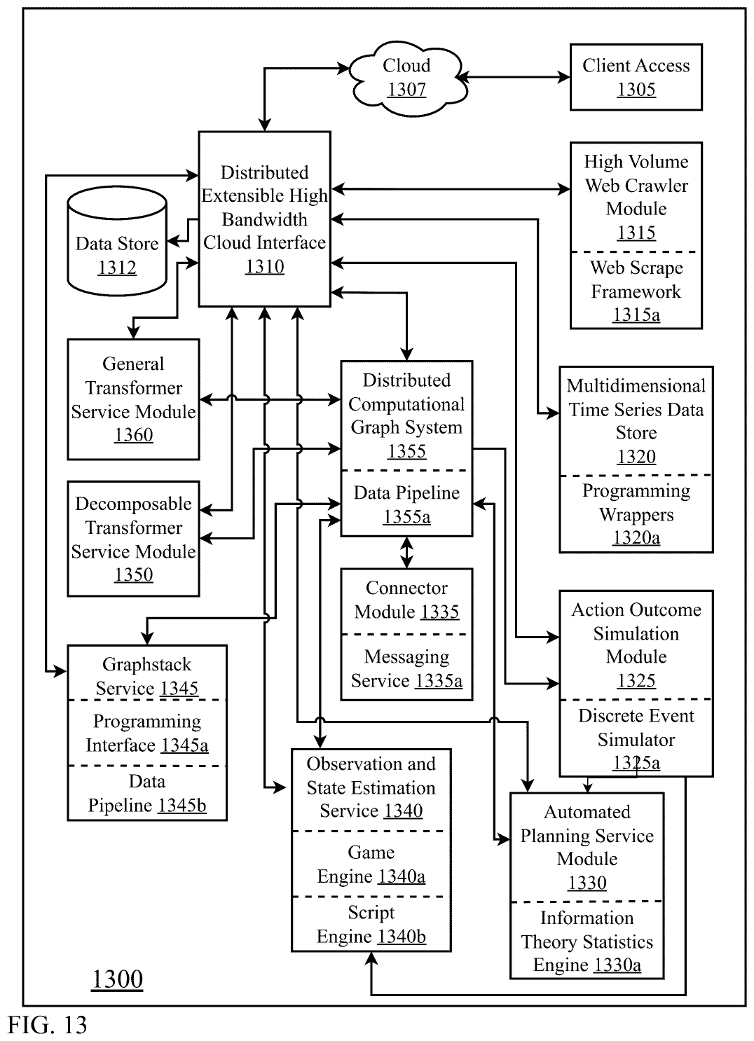

FIG. 13 is a block diagram illustrating an exemplary aspect of an embodiment of a distributed computational graph computing system utilizing an advanced cyber decision platform (ACDP) for external network reconnaissance and contextual data collection. Client access to the system 1305 for specific data entry, system control and for interaction with system output such as automated predictive decision making and planning and alternate pathway simulations, occurs through the system's distributed, extensible high bandwidth cloud interface 1310 which uses a versatile, robust web application driven interface for both input and display of client-facing information via network 1307 and operates a data store 1312 such as, but not limited to MONGODB™, COUCHDB™, CASSANDRA™ or REDIS™ according to various arrangements. Much of the enterprise knowledge/context data analyzed by the system both from sources within the confines of the enterprise business, and from cloud based sources, also enter the system through the cloud interface 1310, data being passed to the connector module 1335 which may possess the API routines 1335a needed to accept and convert the external data and then pass the normalized information to other analysis and transformation components of the system, the directed computational graph module 1355, high volume web crawler module 1315, multidimensional time series database (MDTSDB) 1320 and the graph stack service 1345. The directed computational graph module 1355 retrieves one or more streams of data from a plurality of sources, which includes, but is in no way not limited to, enterprise knowledge, RAGs, expert judgment/scores, a plurality of physical sensors, network service providers, web based questionnaires and surveys, monitoring of electronic infrastructure, crowdsourcing campaigns, and human input device information. Within the directed computational graph module 1355, data may be split into two identical streams in a specialized pre-programmed data pipeline 1355a, wherein one sub-stream may be sent for batch processing and storage while the other sub-stream may be reformatted for transformation pipeline analysis. The data is then transferred to the general transformer service module 1360 for linear data transformation as part of analysis or the decomposable transformer service module 1350 for branching or iterative transformations that are part of analysis. The directed computational graph module 1355 can represent all data as directed graphs where the transformations are nodes and the result messages between transformations edges of the graph. The high volume web crawling module 1315 uses multiple server hosted preprogrammed web spiders, which while autonomously configured are deployed within a web scraping framework 1315a of which SCRAPY™ is an example, to identify and retrieve data of interest from web based sources that are not well tagged by conventional web crawling technology. Data persistence stores such as the multiple dimension time series data store module 1320 may receive streaming data from a large plurality of sensors that may be of several different types. The multiple dimension time series data store module may also store any time series data encountered by the system such as but not limited to enterprise network usage data, component and system logs, environmental context, edge device state information, performance data, network service information captures such as, but not limited to news and financial feeds, and sales and service related customer data. The module is designed to accommodate irregular and high volume surges by dynamically allocating network bandwidth and server processing channels to process the incoming data. Inclusion of programming wrappers 1320a for languages examples of which are, but not limited to C++, PERL, PYTHON, Rust, Scala, GoLang, and ERLANG™ allows sophisticated programming logic to be added to the default function of the multidimensional time series database 1320 without intimate knowledge of the core programming, greatly extending breadth of function. Data retrieved by various data stores such as SQL, graph, key-value, or the multidimensional time series database (MDTSDB) 1320 and the high volume web crawling module 1315 may be further analyzed and transformed into task optimized results by the directed computational graph 1355 and associated general transformer service 1350 and decomposable transformer service 1360 modules. Alternately, data from the multidimensional time series database and high volume web crawling modules may be sent, often with scripted cuing information determining important vertexes 1345a, to the graph stack service module 1345 which, employing standardized protocols for converting streams of information into graph representations of that data, for example, open graph internet technology although the invention is not reliant on any one standard. Through the steps, the graph stack service module 1345 represents data in graphical form influenced by any predetermined scripted modifications 1345a and stores it in a graph-based data store 1345b such as Janus, Tiger Graph, Neptune, Neo4J, GIRAPH™ or a key value pair type data store like Dynamo, REDIS™, or RIAK™, document data stores like DocumentDB, relational data stores like PostgreSQL, among others, all of which are suitable for storing some elements of relational or graph-based information.

Results of the transformative analysis process may then be combined with further client directives, and additional business rules and practices relevant to the analysis and situational information external to the already available data in the automated planning service module 1330 which also runs powerful information theory 1330a based predictive statistics functions and machine learning algorithms to allow future trends and outcomes to be rapidly forecast based upon the current system derived results and choosing each a plurality of possible business decisions. Using all available data, the automated planning service module 1330 may propose business decisions most likely to result in the most favorable business outcome with a usably high level of certainty. Closely related to the automated planning service module in the use of system derived results in conjunction with possible externally supplied additional information (i.e., context) in the assistance of end user business decision making, the action outcome simulation module 1325 with its discrete event simulator programming module 1325a coupled with the end user facing observation and state estimation service 1340 which is highly scriptable 1340b as circumstances require and has a game engine 1340a to more realistically stage possible outcomes of business decisions under consideration, allows business decision makers to investigate the probable outcomes of choosing one pending course of action over another based upon analysis of the current available data.

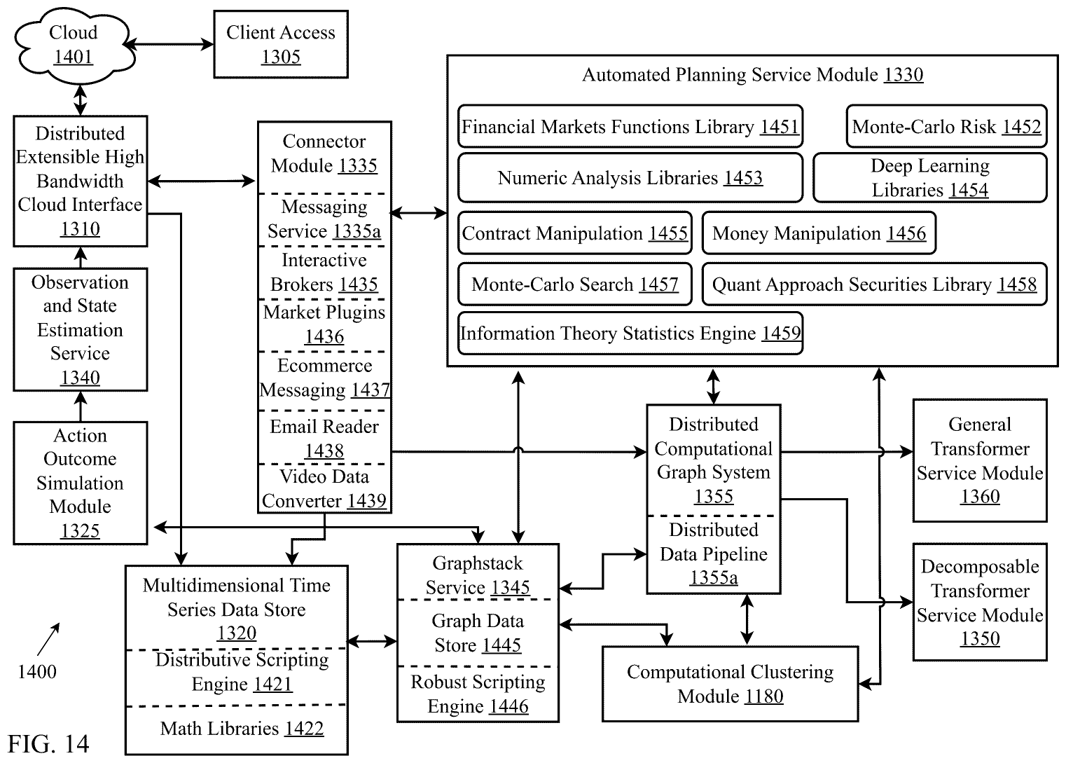

FIG. 14 is a block diagram illustrating another exemplary aspect of an embodiment 1400 of a distributed computational graph computing systems aiding in the operation of an advanced AI reasoning platform. According to the aspect the integrated platform 1400, is very well suited to perform advanced predictive analytics and predictive simulations to produce predictions. Much of the trading specific programming functions are added to the automated planning service module 1330 of the modified advanced cyber decision platform 1400 to specialize it to perform trading analytics. Specialized purpose libraries may include but are not limited to financial markets functions libraries 1451, Monte-Carlo risk routines 1452, numeric analysis libraries 1453, deep learning libraries 1454, contract manipulation functions 1455, money handling functions 1456, Monte-Carlo simulation and Monte Carlo tress search libraries 1457, and quant approach securities routines 1458. Pre-existing deep learning routines including information theory statistics engine 1459 may also be used. The invention may also make use of other libraries and capabilities that are known to those skilled in the art as instrumental in the regulated trade of items of worth. Data from a plurality of sources used in trade analysis are retrieved, much of it from remote, cloud resident 1401 servers through the system's distributed, extensible high bandwidth cloud interface 410 using the system's connector module 435 which is specifically designed to accept data from a number of information services both public and private through interfaces to those service's applications using its messaging service 435a routines, due to case of programming, are augmented with interactive broker functions 1435, market data source plugins 1436, e-commerce messaging interpreters 1437, business-practice aware email reader 1438 and programming libraries to extract information from video data sources 1439.

Other modules that make up the advanced cyber decision platform may also perform significant analytical transformations on trade related data. These may include the multidimensional time series data store 1320 with its robust scripting features which may include a distributive friendly, fault-tolerant, real-time, continuous run prioritizing, programming platform such as, but not limited to Erlang/OTP 1421 and a compatible but comprehensive and proven library of math functions of which the C++ math libraries are an example 1422, data formalization and ability to capture time series data including irregularly transmitted, burst data; the GraphStack service 445 which transforms data into graphical representations for relational analysis and may use packages for graph data storage such as Titan 1445 or the like and a highly interface accessible programming interface although other, similar, combinations may equally serve the same purpose in this role 1446 to facilitate optimal data handling; the directed computational graph module 455 and its distributed data pipeline 455a supplying related general transformer service module 460 and decomposable transformer module 450 which may efficiently carry out linear, branched, and recursive transformation pipelines during trading data analysis may be programmed with multiple trade related functions involved in predictive analytics of the received trade data. Both possibly during and following predictive analyses carried out by the system, results must be presented to clients 1305 in formats best suited to convey both important results for analysts to make highly informed decisions and, when needed, interim or final data in summary and potentially raw for direct human analysis. Simulations which may use data from a plurality of field spanning sources to predict future trade conditions these are accomplished within the action outcome simulation module 1325. Data and simulation formatting may be completed or performed by the observation and state estimation service 1340 using its case of scripting and gaming engine to produce optimal presentation results.

In cases where there are both large amounts of data to be ingested, schematized, normalized, semantified or otherwise cleansed, enriched or formalized and then intricate transformations such as those that may be associated with deep machine learning, predictive analytics and predictive simulations, distribution of computer resources to a plurality of systems may be routinely required to accomplish these tasks due to the volume of data being handled and acted upon. The advanced cyber decision platform employs a distributed architecture that is highly extensible to meet these needs. A number of the tasks carried out by the system are extremely processor intensive and for these, the highly integrated process of hardware clustering of systems, possibly of a specific hardware architecture particularly suited to the calculations inherent in the task, is desirable, if not required for timely completion. The system includes a computational clustering module 1480 to allow the configuration and management of such clusters during application of the advanced cyber decision platform. While the computational clustering module is drawn directly connected to specific co-modules of the advanced cyber decision platform these connections, while logical, are for case of illustration and those skilled in the art will realize that the functions attributed to specific modules of an embodiment may require clustered computing under one use case and not under others. Similarly, the functions designated to a clustered configuration may be role, if not run, dictated. Further, not all use cases or data runs may use clustering.

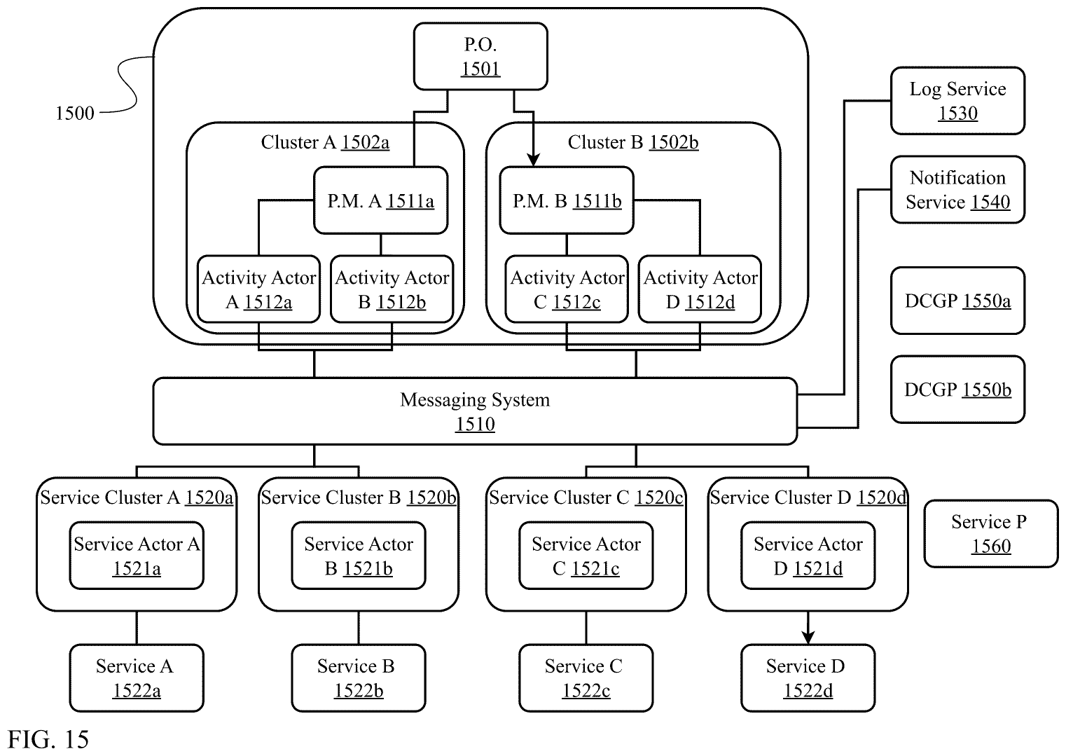

FIG. 15 is a diagram of an exemplary architecture for a system for rapid predictive analysis of very large data sets using an actor-driven distributed computational graph 1500, according to one aspect. According to the aspect, a DCG 1500 may comprise a pipeline orchestrator 1501 that may be used to perform a variety of data transformation functions on data within a processing pipeline, and may be used with a messaging system 1510 that enables communication with any number of various services and protocols, relaying messages and translating them as needed into protocol-specific API system calls for interoperability with external systems (rather than requiring a particular protocol or service to be integrated into a DCG 1500).

Pipeline orchestrator 1501 may spawn a plurality of child pipeline clusters 1502a-b, which may be used as dedicated workers for streamlining parallel processing. In some arrangements, an entire data processing pipeline may be passed to a child cluster 1502a for handling, rather than individual processing tasks, enabling each child cluster 1502a-b to handle an entire data pipeline in a dedicated fashion to maintain isolated processing of different pipelines using different cluster nodes 1502a-b. Pipeline orchestrator 1501 may provide a software API for starting, stopping, submitting, or saving pipelines. When a pipeline is started, pipeline orchestrator 1501 may send the pipeline information to an available worker node 1502a-b, for example using AKKA™ clustering. For each pipeline initialized by pipeline orchestrator 1501, a reporting object with status information may be maintained. Streaming activities may report the last time an event was processed, and the number of events processed. Batch activities may report status messages as they occur. Pipeline orchestrator 1501 may perform batch caching using, for example, an IGFS™ caching filesystem. This allows activities 1512a-d within a pipeline 1502a-b to pass data contexts to one another, with any necessary parameter configurations.

A pipeline manager 1511a-b may be spawned for every new running pipeline, and may be used to send activity, status, lifecycle, and event count information to the pipeline orchestrator 1501. Within a particular pipeline, a plurality of activity actors 1512a-d may be created by a pipeline manager 1511a-b to handle individual tasks, and provide output to data services 1522a-d. Data models used in a given pipeline may be determined by the specific pipeline and activities, as directed by a pipeline manager 1511a-b. Each pipeline manager 1511a-b controls and directs the operation of any activity actors 1512a-d spawned by it. A pipeline process may need to coordinate streaming data between tasks. For this, a pipeline manager 1511a-b may spawn service connectors to dynamically create TCP connections between activity instances 1512a-d. Data contexts may be maintained for each individual activity 1512a-d, and may be cached for provision to other activities 1512a-d as needed. A data context defines how an activity accesses information, and an activity 1512a-d may process data or simply forward it to a next step. Forwarding data between pipeline steps may route data through a streaming context or batch context.

A client service cluster 1530 may operate a plurality of service actors 1521a-d to serve the requests of activity actors 1512a-d, ideally maintaining enough service actors 1521a-d to support each activity per the service type. These may also be arranged within service clusters 1520a-d, in a manner similar to the logical organization of activity actors 1512a-d within clusters 1502a-b in a data pipeline. A logging service 1530 may be used to log and sample DCG requests and messages during operation while notification service 1540 may be used to receive alerts and other notifications during operation (for example to alert on errors, which may then be diagnosed by reviewing records from logging service 1530), and by being connected externally to messaging system 1510, logging and notification services can be added, removed, or modified during operation without impacting DCG 1500. A plurality of DCG protocols 1550a-b may be used to provide structured messaging between a DCG 1500 and messaging system 1510, or to enable messaging system 1510 to distribute DCG messages across service clusters 1520a-d as shown. A service protocol 1560 may be used to define service interactions so that a DCG 1500 may be modified without impacting service implementations. In this manner it can be appreciated that the overall structure of a system using an actor-driven DCG 1500 operates in a modular fashion, enabling modification and substitution of various components without impacting other operations or requiring additional reconfiguration.

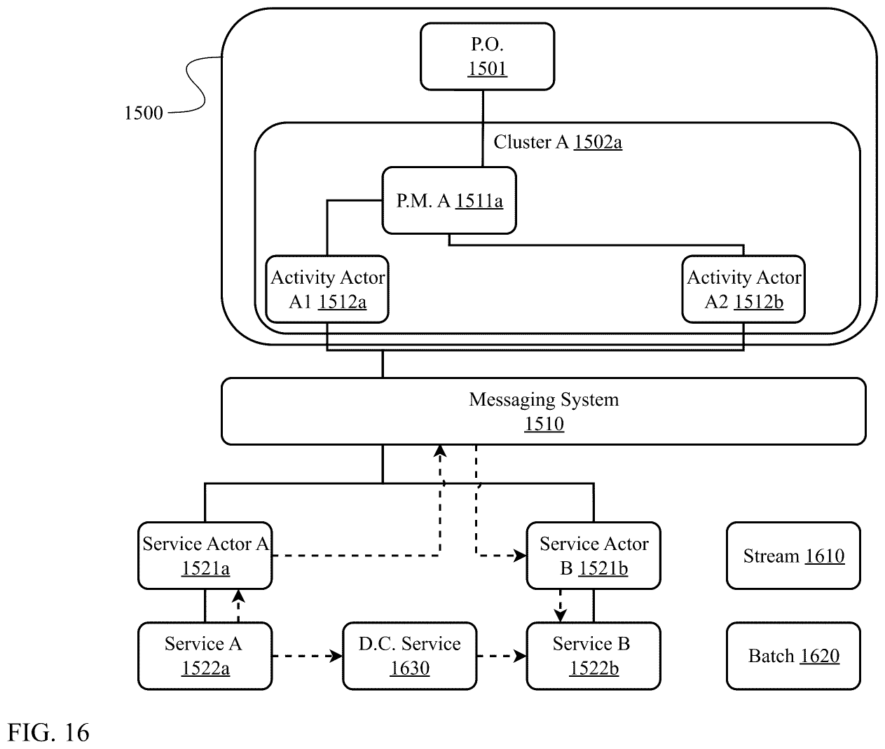

FIG. 16 is a diagram of an exemplary architecture for a system for rapid predictive analysis of very large data sets using an actor-driven distributed computational graph 1500, according to one aspect. According to the aspect, a variant messaging arrangement may utilize messaging system 1510 as a messaging broker using a streaming protocol 1610, transmitting and receiving messages immediately using messaging system 1510 as a message broker to bridge communication between service actors 1521a-b as needed. Alternately, individual services 1522a-b may communicate directly in a batch context 1620, using a data context service 1630 as a broker to batch-process and relay messages between services 1522a-b.

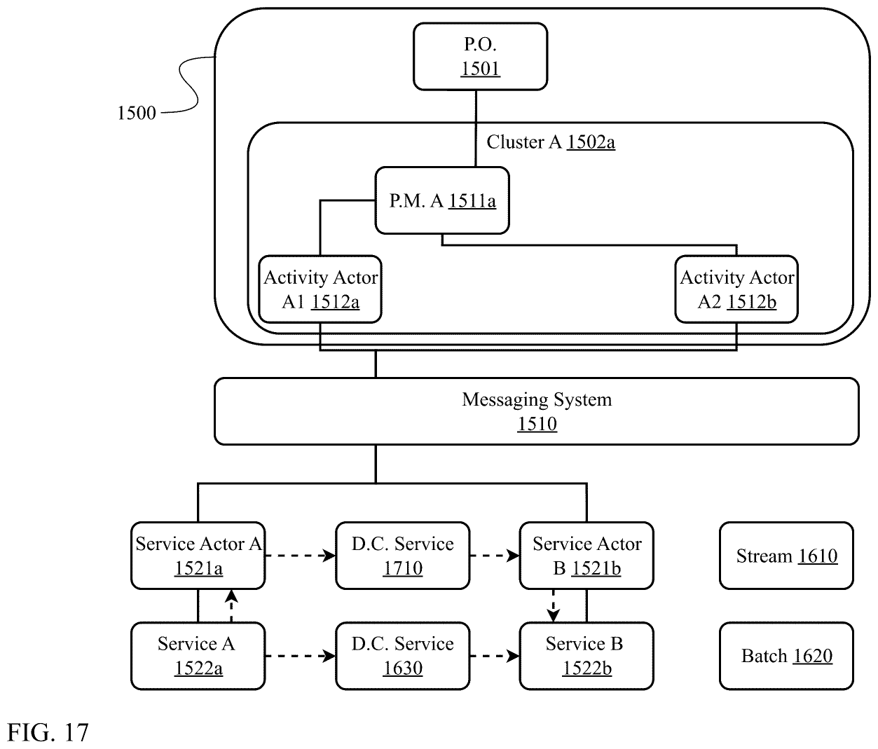

FIG. 17 is a diagram of an exemplary architecture for a system for rapid predictive analysis of very large data sets using an actor-driven distributed computational graph 1500, according to one aspect. According to the aspect, a variant messaging arrangement may utilize a service connector 1710 as a central message broker between a plurality of service actors 1521a-b, bridging messages in a streaming context 1610 while a data context service 1630 continues to provide direct peer-to-peer messaging between individual services 1522a-b in a batch context 1620.

It should be appreciated that various combinations and arrangements of the system variants described above (referring to FIGS. 13-17) may be possible, for example using one particular messaging arrangement for one data pipeline directed by a pipeline manager 1511a-b, while another pipeline may utilize a different messaging arrangement (or may not utilize messaging at all). In this manner, a single DCG 1500 and pipeline orchestrator 1501 may operate individual pipelines in the manner that is most suited to their particular needs, with dynamic arrangements being made possible through design modularity as described above in FIG. 15.

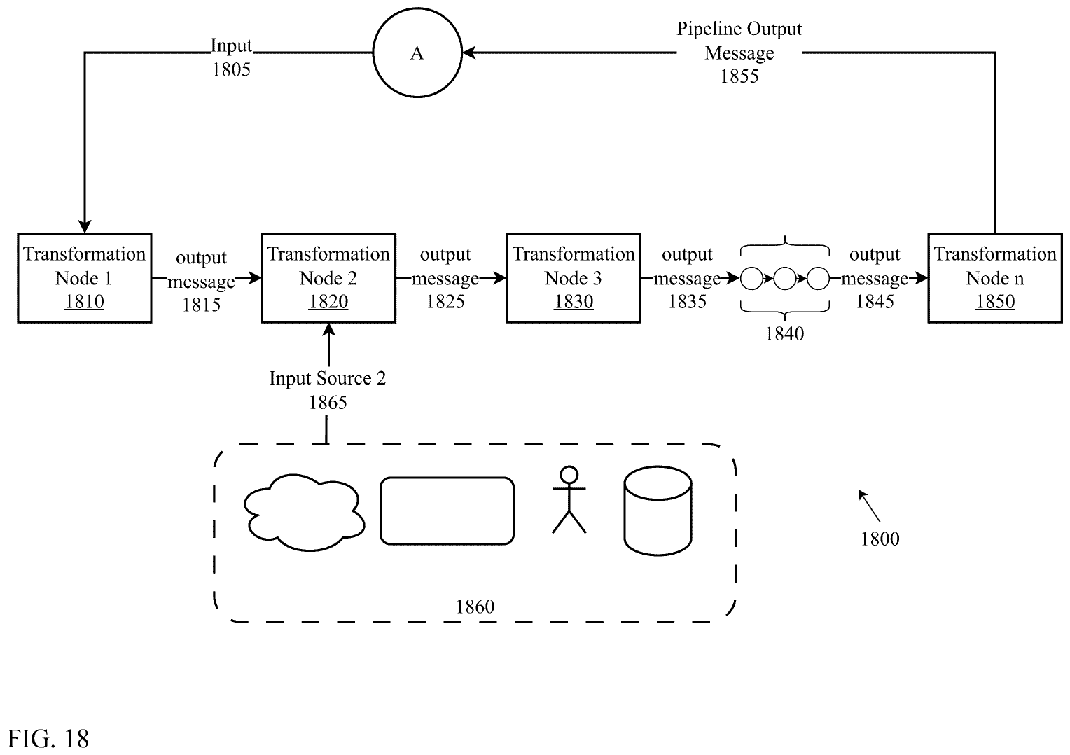

FIG. 18 is a block diagram of an architecture for a transformation pipeline within a system for predictive analysis of very large data sets using distributed computational graph computing system 1800. According to the aspect, streaming input from a data filter software module, 1805 serves as input to the first transformation node 1810 of the transformation pipeline. Each transformation node's function 1810, 1820, 1830, 1840, 1850 is performed on input data stream and transformed output message 1815, 1825, 1835, 1845, 1855, 1865 is sent to the next step. In this aspect, transformation node 2 1820 has a second input stream 1860. The specific source of this input is inconsequential to the operation of the invention and could be another transformation pipeline software module, a data store, human interaction, physical sensors, monitoring equipment for other electronic systems or a stream from the internet as from a crowdsourcing campaign, just to name a few possibilities 1860. For example, a first input stream may comprise enterprise knowledge and a second input stream may comprise RAG data from a RAG marketplace. Functional integration of a second input stream into one transformation node requires the two input stream events be serialized. The illustrated system can perform this serialization using a decomposable transformation software module. While transformation nodes are described according to various aspects as uniform shape, such uniformity is used for presentation simplicity and clarity and does not reflect necessary operational similarity between transformations within the pipeline. It should be appreciated that one knowledgeable in the field will realize that certain transformations in a pipeline may be entirely self-contained; certain transformations may involve direct human interaction, such as selection via dial or dials, positioning of switch or switches, or parameters set on control display, all of which may change during analysis; other transformations may require external aggregation or correlation services or may rely on remote procedure calls to synchronous or asynchronous analysis engines as might occur in simulations among a plurality of other possibilities. For example, engines may be singletons (composed of a single activity or transformation). Furthermore, leveraging the architecture in this way allows for versioning and functional decomposition (i.e. embedding entire saved workflows as single nodes in other workflows). Further according to the aspect, individual transformation nodes in one pipeline may represent function of another transformation pipeline. It should be appreciated that the node length of transformation pipelines depicted in no way confines the transformation pipelines employed by the invention to an arbitrary maximum length 1810, 1820, 1830, 1840, 1850, as, being distributed, the number of transformations would be limited by the resources made available to each implementation of the invention. It should be further appreciated that there need be no limits on transform pipeline length. Output of the last transformation node and by extension, the transform pipeline, 1850 may be sent back to messaging software module 862 for pre-decided action.

### DETAILED DESCRIPTION OF EXEMPLARY ASPECTS

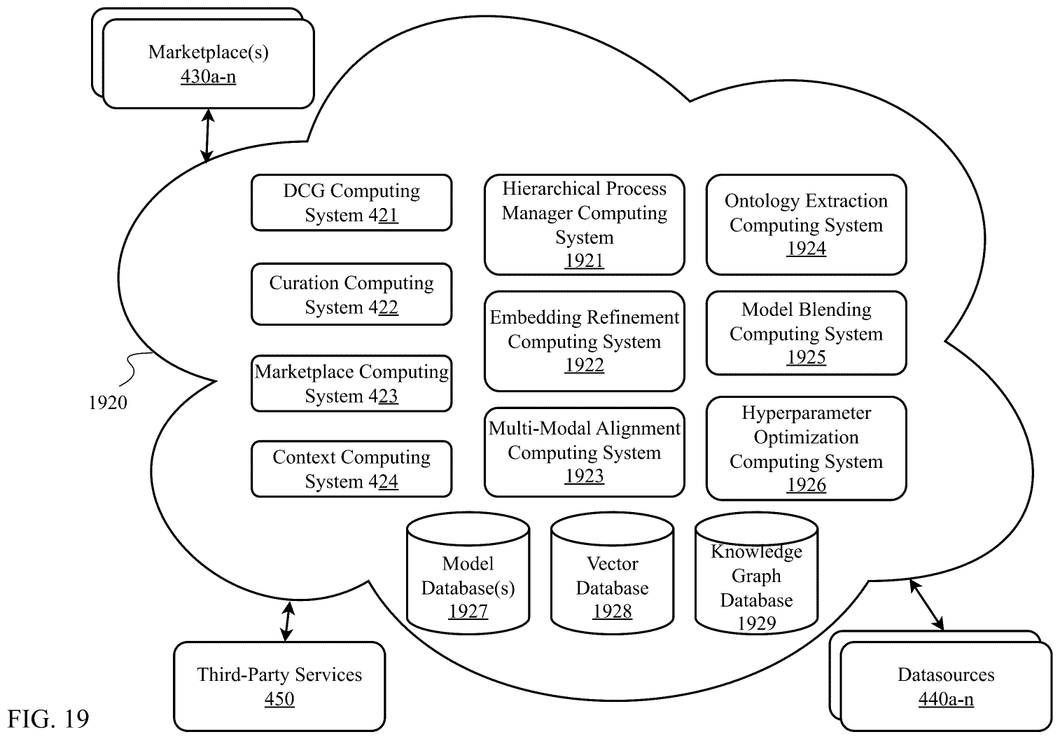

FIG. 19 is a block diagram illustrating an exemplary system architecture for a distributed, composite symbolic and non-symbolic AI platform for advanced reasoning 1920, according to an embodiment. According to the embodiment, the platform 1920 aims to enable vast automation of modeling/analysis workflows by exploring large potential parameter combinations. Platform 1920 can be configured for extracting and curating knowledge into structured ontologies to complement neuro-symbolic AI capabilities. Platform 1920 can provide an iterative multi-dimensional optimization and evaluation process to explore the relative performance of the different techniques, datasets, and “fitness of purpose” definitions (e.g., security, licenses, traceability/provenance, etc.) associated with a plurality of AI models.

According to the embodiment, platform 1920 is configured as a cloud-based computing platform comprising various system or sub-system components configured to provide functionality directed to the execution of composite symbolic Gen AI reasoning and action. Exemplary platform systems can include a distributed computational graph (DCG) computing system 421, a curation computing system 422, a marketplace computing system 423, and a context computing system 424, a hierarchical process manager computing system 1921, an embedding refinement computing system 1922, a multi-modal alignment computing system 1923, an ontology extraction computing system 1924, a model blending computing system 1925, and a hyperparameter optimization computing system 2126. Platform 1920 may further comprise various databases for storing a plurality of data sets, models 1927, vectors/embeddings 1928, and knowledge graphs 1929. In some embodiments, systems 421-424 and 1921-1926 may each be implemented as standalone software applications or as a services/microservices architecture which can be deployed (via platform 420 or 1920) to perform a specific task or functionality. In such an arrangement, services can communicate with each other over an appropriate network using lightweight protocols such as HTTP, gRPC, or message queues (e.g., AMQP or Kafka). This allows for asynchronous and decoupled communication between services. Services may be scaled independently based on demand, which allows for better resource utilization and improved performance. Services may be deployed using containerization technologies such as Docker or containerd and orchestrated using container orchestration platforms like Kubernetes. This allows for more flexible deployment and management of services.

The composite symbolic AI reasoning and action platform 1920 can enable a more flexible approach to incorporating machine learning (ML) or artificial intelligence (AI) models into the future of the Internet and software applications; all facilitated by a distributed computational graph (DCG) architecture capable of dynamically creating, persisting, retraining, augmenting, selecting, executing, decommissioning, and incorporating trained models with both internal and external data sources and marketplaces for data and algorithms and expertise (e.g. expert or layperson or user feedback or knowledge) at the data, model, knowledge, or process levels.

The platform 1920 emphasizes the importance of considering various types of semantics, including, but not limited to, symbolic, distributional, compositional distributional, and information-theoretic compositional distributional semantics. This consideration allows the platform to capture and represent meaning at different levels of abstraction and compositionality, enabling more comprehensive and nuanced understanding of the input data in its original, intermediate, or curated forms. By explicitly addressing these different types of semantics, the platform 1920 can leverage the strengths of each approach and combine them in a unified framework.

In some cases, platform may be configured to label non-textual data (e.g., images or scenes) with textual descriptions before computing embeddings. This labeling step converts the non-textual data into a textual representations (or other representations like image or domain similar to Fourier transforms), which can then be processed using language-based techniques that are more well-developed and understood or consistent or otherwise advantageous. By bridging the gap between non-textual and textual data through labeling, the platform can take advantage of the rich semantic information captured by language models and embeddings into text or alternative media or domain formats. After labeling non-textual data (if applicable), the platform computes numerical embedding representations of the input data in a given format. These embeddings capture the semantic properties and relationships of the data in a dense vector format, enabling efficient storage, retrieval, and comparison. The computed embeddings may then be persisted in memory or in a database such as a vector database, which allows for fast and scalable similarity search (e.g., cosine, dot product, Euclidean, etc.) and other vector operations or graph operations or hybrid representations depending on the data type, representation, and elements such as facts, spatial or temporal dynamics of the systems and/or entities of interest. The persisted embeddings serve as input features for downstream ML or AI models, such as neural networks or symbolic reasoning engines, or knowledge bases. By incorporating the embeddings or representations into these versioned models, the platform can leverage the information captured by the embeddings to improve the performance and generalization of the AI system under different operating environments or conditions and assess ongoing fitness for purpose using ongoing pipeline fitness evaluation functions executed on event or periodic basis. The integration of embeddings with downstream models allows for seamless knowledge accumulation and transfer and enables the AI system to make informed curation and event or context-based decisions based on the semantic understanding of observed input data, simulated input data, submitted user actions, submitted event data, ongoing system state information or operational information or simulated versions of potential versions of the aforementioned elements.

According to the embodiment, platform 1920 utilizes a plurality of neural network models that generate vector embeddings representing input data. The plurality of neural network models may be stored in model database 1926. Each of the plurality of neural network models may be associated with a specific type of AI system (e.g., gaming, medical diagnosis, sentiment analysis, LLM, recommendation system, virtual reality, autonomous vehicle, etc.). As such, models and AI systems may be used interchangeably throughout this specification. Platform can use various neural network architectures as previously detailed such as Transformers, Long Short-Term Memory (LSTM), or convolutional neural networks (CNNs) to process different types of input data (text, images, audio, video, 3d or 4-d models, etc.). In some implementations, platform can train these models on large datasets to learn meaningful vector or graph or SQL or NoSQL representations that capture the properties and relationships of the input data-ideally based on semantified representations of the data but also on unstructured, structured, schematized, normalized or partially semantified basis. Platform may leverage techniques like transfer learning, fine-tuning, or multi-task learning to improve the quality and generalizability of the embeddings. For example, a text classification system that uses a BERT model to generate embeddings for input documents, and a CNN model to generate embeddings for images associated with the documents. The embeddings may then be concatenated and fed into a final classification layer.

Embeddings are dense vector representations that capture the semantic meaning and relationships of data points. Vector databases 1928 store and index these embeddings for efficient retrieval and similarity search. Platform 1920 can facilitate iterative refinement which updates the embeddings based on new data or feedback to improve their quality and representational power. For example, a recommendation AI system uses embeddings to represent user preferences and item characteristics. As users interact with the system, their feedback is used to iteratively refine the embeddings, making them more accurate predictors of user interests. The refined embeddings are stored in a vector database for fast retrieval during recommendation generation.

According to the embodiment, a knowledge graph database 1929 is present comprising symbolic facts, entities, and relations. Platform may use an ontology or schema for the knowledge graph that defines the types of entities, relationships, and attributes relevant to the given AI system's domain. Platform populates the knowledge graph with data from structured sources (e.g., databases) and unstructured sources (e.g., text documents) using information extraction techniques like named entity recognition, relation extraction, and/or co-reference resolution. Knowledge graph database 1929 may be implemented as a graph database (e.g., Neo4j, ArangoDB) or a triple store (e.g., Apache Jena) to efficiently store and query the knowledge graph. Knowledge graph database 1929 may comprise a plurality of knowledge graphs, wherein knowledge graphs may be associated with a specific domain. For example, a biomedical knowledge graph that contains entities such as drugs, diseases, and genes, and relationships like “treats”, “causes”, and “interacts_with”. This exemplary knowledge graph is populated from structured databases like DrugBank and UniProt, as well as from unstructured sources like publications.

According to the embodiment, hierarchical process manager computing system 1921 is present and configured to route processing based on certainty thresholds (e.g., certification) and challenge-based verification. Platform may define a hierarchy of reasoning tasks and subtasks that break down the AI system's (e.g., models) decision-making process into manageable steps. Process manager 1921 orchestrates the execution of these tasks and routes data to the appropriate models or knowledge sources based on predefined rules or learned policies. Process manager 1921 or an administrator may set certainty thresholds for each task to determine when the system should proceed to the next step or seek additional information/verification. Process manager 1921 can design and leverage challenge-based verification mechanisms (e.g., adversarial examples, counterfactual reasoning, etc.) to test the robustness and reliability of the AI system's decisions. For example, a fraud detection system that first uses a rule-based model to flag potentially fraudulent transactions based on simple heuristics. If the certainty of the rule-based model is below a threshold, the transaction is routed to a more complex machine learning model for further analysis. The final decision is then verified through a challenge-response mechanism that asks the user to provide additional authentication.

Hierarchical process definitions break down complex reasoning tasks into smaller, more manageable steps. System may note decomposable workflows which can be independently evaluated and also evaluations which require coordination or contextualization based on ongoing feedback from aggregated data or evaluation results and therefore require intermediate state sharing across resources at the actor, virtual or physical resource level. Specialized routing dynamically selects the most appropriate AI models or knowledge sources for each subtask based on their capabilities and performance. For example, an autonomous vehicle AI system uses a hierarchical process to handle different driving situations. At a top level, the platform decides whether to use models specialized for highway driving, city navigation, or parking. Within each specialization, further routing occurs to handle specific challenges like merging, pedestrian detection, or parallel parking.

Certification involves validating the performance and reliability of AI models through rigorous testing and evaluation. Challenge-based verification sets up specific test cases or benchmarks that models must pass to be considered certified for a given task. Model blending combines the outputs of multiple models using weighted averaging or more sophisticated methods to improve overall performance. For example, a financial forecasting AI system blends the predictions of several certified models, each specializing in different asset classes or market conditions. The blending weights are adjusted based on each model's historical performance and current market challenges.

According to the embodiment, embedding refinement computing system 1922 is present and configured to incorporate data from one or more knowledge graphs. Embedding refinement 1922 may utilize algorithms that can query the knowledge graph to retrieve relevant facts, entities, and relationships based on the input data and the current reasoning context. Retrieved knowledge may be used to refine the vector embeddings generated by the neural networks models, incorporating symbolic information into the distributed representations (embeddings). In some implementations, techniques like attention mechanisms, graph convolutions, and/or knowledge-aware language models to effectively combine the embeddings with the knowledge graph data. For example, consider a recommendation system that generates initial embeddings for users and items based on their interaction history. The platform then queries a knowledge graph of user demographics, item categories, and contextual factors (e.g., time, location) to retrieve relevant information. This information can be used to refine the user and item embeddings through, for example, a graph attention network, incorporating the contextual knowledge into the recommendations.

A Graph Attention Network (GAT) is a type of neural network architecture designed to operate on graph-structured data. It leverages the concept of self-attention to compute the importance of neighboring nodes in a graph, allowing the network to focus on the most relevant information when making predictions or generating representations. The key advantage of GATs is their ability to capture the importance of neighboring nodes based on their feature compatibility, allowing the network to focus on the most relevant information. This attention mechanism enables GATs to effectively handle graph-structured data and learn meaningful representations of nodes and their relationships.

According to the embodiment, model blending computing system 1925 is present and configured to apply expressive weighting schemes to model combinations. Platform may leverage a model blending architecture that can combine the outputs of multiple neural network models based on their individual strengths and weaknesses. Such a system may use weighting schemes that can dynamically adjust the contribution of each model based on factors like uncertainty, task complexity, or domain relevance. Techniques such as Bayesian model averaging, mixture of experts, and/or ensemble learning may be implemented to optimally blend the model outputs. For example, consider a sentiment analysis system that combines the outputs of three models: a Naive Bayes model, an LSTM model, and a BERT model. Model blending 1925 assigns weights to each model based on their confidence scores and the complexity of the input text. The weights are learned through a reinforcement learning approach that optimizes the overall sentiment classification performance.

According to the embodiment, platform 1920 implements feedback loops considering security, licensing, provenance, and collaborative development. Feedback loops allow the AI system to learn and adapt based on real-world performance and user feedback. Security considerations ensure that the AI system is protected against malicious attacks or misuse. For example, implementing secure communication protocols and access controls mechanisms to protect sensitive data and prevent unauthorized access to the AI system. Economic factors optimize the cost-benefit trade-offs of different model configuration and deployment strategies. Licensing takes into account the legal rights and restrictions associated with using certain datasets or model components. Platform 1920 can monitor and ensure compliance with the terms and conditions of licensing of datasets, models, and tools used by the platform. Traceability/provenance keeps track of the lineage of data sources, training processes, and model versions used in each output. Model collaboration enables different teams or organizations to jointly develop, test, deploy, and improve AI models while maintaining security and provenance. For example, a healthcare AI system incorporates feedback from doctors and patients to continually refine its diagnosis and treatment recommendations. The system logs each decision's provenance and securely shares performance data with research partners under appropriate licensing terms. As another example, consider a federated learning system for medical image analysis that allows multiple hospitals to collaboratively train a deep learning model without sharing raw patient data. The system uses secure multi-party computation and differential privacy techniques to protect patient privacy. The model's provenance is tracked using a blockchain-based ledger, ensuring transparency and accountability. The system also includes a licensing management component that enforces usage restrictions based on each hospital's data sharing agreements.

According to the embodiment, multi-modal computing system 1923 is present and configured to align and synchronize representations across different data modalities (e.g., text, images, audio, etc.) to create a unified and consistent representation of the input data. Multi-modal system 1923 may implement techniques such as cross-modal attention, multi-modal fusion, and/or joint embedding spaces to effectively combine information from different modalities. Platform can utilize domain-specific knowledge (e.g., physics, psychology) (from knowledge graphs) to ensure the generated representations are consistent and realistic across modalities. For example, consider a virtual assistant that can process user queries in the form of text, speech, and images. The multi-modal system 1923 uses cross-modal attention to align the representations of the different input modalities, creating a unified query representation. For example, if the user asks, “What is the breed of the dog in this picture?”, the engine aligns the image embedding with the relevant parts of the text embedding to understand that the query is about identifying the dog breed.

According to the embodiment, hyperparameter optimization computing system 1926 is present and configured to use information theoretic guidance for optimization tasks. System 1926 may implement an automated hyperparameter optimization framework (e.g., Bayesian optimization, evolutionary algorithms, etc.) to search for the best combination of model architectures, training settings, and embedding techniques. System 1926 can use information-theoretic measures (e.g., mutual information, Kullback-Leibler divergence) to guide the optimization process and select hyperparameters that maximize the information content and generalization ability of the learned representations. In some implementations, platform 1920 may develop efficient parallel computing strategies to speed up the hyperparameter search process and explore a larger space of configurations. For example, consider a natural language generation system that uses a variational autoencoder (VAE) to generate diverse and coherent sentences. The hyperparameter optimization system 1926 uses Bayesian optimization to search for the best combination of latent space dimensionality, regularization strength, and decoder architecture. The optimization is guided by an information-theoretic objective that maximizes the mutual information between the latent space and the generated sentences, ensuring that the VAE captures meaningful and interpretable representations.

In some embodiments, hyperparameters may also be defined by expert judgment via experts and made available via a hyperparameter expert judgment marketplace.

Embedding generation techniques convert raw data into dense vector representations. Different techniques (e.g., Word2Vec, GloVe, BERT, etc.) have different strengths and weaknesses. Training data selection and processing impact the quality and generalizability of the learned embeddings. Model type (e.g., perceptron, feedforward, radial basis network, deep feed forward, recurrent, long-short term memory, gated recurrent unit, auto encoder, variational autoencoder, denoising auto encoder, sparse autoencoder, Markov chain, Hopfield network, Boltzmann machine, restricted Boltzmann machine, deep belief network, deep convolutional network, convolutional network, deconvolutional network, deep convolutional inverse graphics network, general adversarial network, liquid state machine, extreme learning machine, echo state network, deep residual network, Kohonen network, support vector machine, neural Turing machine etc.) and architecture (e.g., number of hidden layers, hidden units, etc.) influence the embedding learning process. Hyperparameter optimization searches and explorations for the best combination of embedding generation technique, training data, model type, and architecture to maximize the embedding quality and downstream task performance. For example, a sentiment analysis AI system experiments with different embedding generation techniques (Word2Vec, GloVe) and model architectures (long short-term memory, convolutional neural network) and dimensionality reduction techniques (e.g., none vs PCA vs ICA vs information sieve) to find the best combination for the specific domain and language as well as different system states (e.g. based on clustering algorithms for different operational modalities). The platform also tunes hyperparameters such as, for example, embedding dimensionality, context window size, randomness/temperature and learning rate to further improve performance or other measures of efficacy based on a narrow or system-wide or process-wide objective or fitness function.

Information theory provides another exemplary mathematical framework for quantifying and understanding the properties of embeddings, such as their information content or gain when compared to an alternative, compression, and generalization ability. Theoretical analysis may apply information-theoretic concepts and measures to study the effectiveness of different embedding methods and guide their development or data set or model or parameter or encoding/serialization/compression. For example, platform 1920 analyzes the mutual information between word embeddings and their context to quantify the amount of semantic information captured or gained. Platform may then use this analysis to propose a new embedding method that maximizes mutual information while minimizing redundancy, resulting in more informative and compact representations on either a marginal or absolute basis, or both.

According to the embodiment, ontology extraction computing system 1924 is present and configured to link data elements, facts, or embeddings to symbolic knowledge graphs or ontological entities. Connectionist models (e.g., neural networks) learn distributed representations that capture patterns and relationships in data, but these representations are not directly interpretable as symbolic knowledge. Extracting symbolic representations involves techniques like rule extraction, decision tree induction, or clustering to distill the learned knowledge into a symbolic form in terms of both allowed elements in an ontology or instances of such elements. Linking the extracted symbolic representations to existing knowledge graphs (or extending or amending underlying ontologies dynamically based on accumulated data or experiences) enables the integration of the learned knowledge with or without prior domain expertise, facilitating more comprehensive and explainable reasoning for both connectionist and symbolic modeling regimes as well as for simulation based modeling initiatives supporting synthetic data generation for simulation-based and empirical real-world observation and refinement. For example, a medical diagnosis AI system based on a deep neural network learns to classify diseases from patient data. The platform extracts symbolic rules or representations from data of interest via a model (e.g., a trained network), expressing the learned decision boundaries in terms of interpretable clinical features. These rules are then linked to a medical knowledge graph consisting of both an ontological framework, a corresponding query formalism, and a data set consisting of allowed ontology instances and characteristics, allowing the system to explain both its available reasoning in terms of known disease mechanisms and treatment guidelines. It is important to note that every version of such composite knowledge corpus may be numbered or uniquely identified as an element of a given decision, model training, or other system action for its stated purpose or for administrative or maintenance/system operation functions.

Ontology extraction system 1924 can leverage algorithms that can analyze the learned vector embeddings and extract symbolic representations (e.g., entities, relationships, rules, etc.) that capture the underlying semantic structure. In some implementations, techniques such as, for example, clustering, dimensionality reduction, and/or rule mining may be used to capture the underlying semantic structure. Ontology alignment and linking methods can be used to map the extracted symbolic representations to existing concepts and relationships in the knowledge graph, enabling seamless integration of the learned knowledge with prior domain expertise. For example, consider a legal case analysis system that uses a BERT model to generate embeddings for legal documents. The ontology extraction system can use hierarchical clustering to group the embeddings into semantically related clusters, and then apply association rule mining to discover relationships between the clusters. The extracted ontology is then linked to a legal knowledge graph that contains concepts like laws, precedents, and jurisdictions, enabling the system to reason about legal cases using both the learned embeddings and the symbolic knowledge.

Symbolic knowledge represents facts, rules, and relationships using structured formalisms like ontologies or knowledge graphs. Connectionist models, such as neural networks, learn distributed representations from data with explicit symbolic structure. Retrieval augmented generation (RAGs) enhance language models by incorporating an external knowledge retrieval mechanism. During the generation process, the model queries a knowledge base to retrieve relevant information and condition its outputs on both the input context and the retrieved knowledge. Expressive weightings allow the platform to dynamically adjust the influence of different knowledge sources based on their relevance to the current context. For example, a customer support AI system uses a knowledge graph of product information and troubleshooting procedures (symbolic) alongside a neural language model trained on past support interactions (connectionist). When generating responses to customer inquiries, the system employs RAG to retrieve relevant information from the knowledge graph and the language model to condition the responses on both the customer's input and the retrieved knowledge. The system assigns higher weights to knowledge sources that are more pertinent to the specific inquiry, ensuring accurate and context-appropriate responses.

According to the embodiment, platform 1920 can implement scene generation with knowledge graph elements for contextual refinement. Scene generation creates realistic images, videos, or three-dimensional (3D) environments based on textual descriptions or other input data. Knowledge graph elements, such as object properties, relationships, and constraints, can be leveraged to guide the scene generation process to ensure consistency and realism. Contextual refinement adjusts the generated scene based on the specific context and purpose of the AI application. For example, a virtual reality AI system generates immersive scenes for training simulations. The platform can use a knowledge graph of object properties (e.g., materials, size, physics) and relationships (e.g., spatial constraints) to ensure physically plausible layouts. The generated scenes may be refined based on the specific training scenario and user interactions.

In addition to visual and textual data, platform 1920 incorporates other sensory modalities like sound and smell to create more immersive and realistic experiences. Harmonizing multiple senses involves aligning and synchronizing the different modalities to create a coherent and consistent output. For example, a gaming AI system generates realistic soundscapes and ambient scents to match the visual environment. The platform 1920 ensures that the sound of footsteps matches the character's movement and the smell of a forest scene includes the scent of pine trees and damp moss.

According to some embodiments, platform 1920 can be leveraged to develop enterprise-specific or domain-specific models, which can be “small models” that are more efficient, accurate, or predictable in specific contexts and prompts. These small models can be integrated into platform 1920 as specialized components that are selected and deployed based on the specific domain or task at hand. Hierarchical process manager 1921 can route the input data to the appropriate small model based on the context, ensuring optimal performance and efficiency.

Furthermore, platform 1920 can provide effective orchestration, selection, and management of small models, particularly in restricted or regulated domains such as medicine, investing, law, insurance, and banking. Platform's model blending system 1925 and feedback loops can be extended to incorporate the orchestration and management of small models, taking into account factors such as data nutrition labels, model labels, and administrative processes. The system can leverage existing system/platforms, and ML ops to facilitate the effective deployment and governance of small models.

In some implementations, the platform can train and deploy hybrid models that combine foundational connectionist models with additional symbolic models, simulations, or datasets and training processes to generate explanations, estimations, and specialized model combinations with different performance characteristics or fitness regimes or envelopes based on their provenance, included data or modeling elements, or even the people or other algorithms or AI agents involved in their creation or execution. The platform can incorporate these hybrid models as part of its model blending and composition capabilities, leveraging the strengths of different models for tasks such as explainability, auditing, and ML ops training/supervision. The ontology extraction system 1924 can help in generating explanations and traces from these hybrid models, enhancing the interpretability and transparency of the system's reasoning process.

The platform addresses the security and intellectual property concerns associated with foundational models, which are considered core IP and may be less likely to be exposed due to their immense cost, time, and sensitivity. The platform can utilize small models as a means of model obfuscation, where the sensitive foundational models are distilled into smaller, more focused models that can be deployed with less risk of information leakage. The platform can also incorporate techniques for model theft detection, such as using vector similarity scoring and hash-based functions to identify potential infringement of small models derived from foundational models.

The platform can leverage the use of ML ops optimization routines for model selection, training, classification, and dynamic deployment based on fitness for purpose. The platform can integrate these optimization techniques to dynamically select and deploy the most suitable small models based on the specific task, context, and performance requirements. The platform can also optimize model hyperparameters, such as temperature and token length, to balance performance, efficiency, and the generation of hallucinations or other undesired outputs.

By integrating the concepts and techniques related to small models, the platform can achieve greater efficiency, specialization, explainability, security, and adaptability. The use of domain-specific small models allows the system to tailor its reasoning and decision-making processes to specific contexts, while the orchestration and management capabilities ensure the effective deployment and governance of these models. The hybrid models and explainability techniques enhance the interpretability and transparency of the platform, enabling users to understand and trust its reasoning process. Simulations and uncertainty quantification routines to isolate the factors influencing deviation between expected and actual observations in empirical and synthetic data sets may be handled by the system, to include via DCG specified processes, to guide ongoing model and simulation training and fitness and selection routines and to guide AI agent and or human decision makers in the evaluation of data, ontology, model, simulation or process level decisions or fitness for a given situation or task. The model obfuscation and theft detection mechanisms may help protect the intellectual property and sensitive information associated with the core foundational models. Overall, the integration of small models into platform 1920 aligns with the broader goals of achieving advanced reasoning, adaptability, explainability, and security in AI systems. By leveraging the strengths of small models and incorporating them into the various components and processes of the system, the platform aims to push the boundaries of AI capabilities while addressing the practical challenges and requirements of real-world applications.

In some implementations, platform 1920 can be configured to provide capabilities directed to automatic error identification and correction, such as those provided by a self-healing neural graph AI. This AI system continuously monitors the operation of the computing device's hardware and software components, identifying anomalies, errors, or suboptimal performance. Upon detecting an issue, the self-healing neural graph AI dynamically reconfigures the system's resources, reroutes data flows, and adapts the computing graph to mitigate the problem and maintain optimal performance. This autonomous error identification and correction mechanism enhances the computing device's reliability, resilience, and ability to operate in demanding or unpredictable environments without the need for manual intervention.

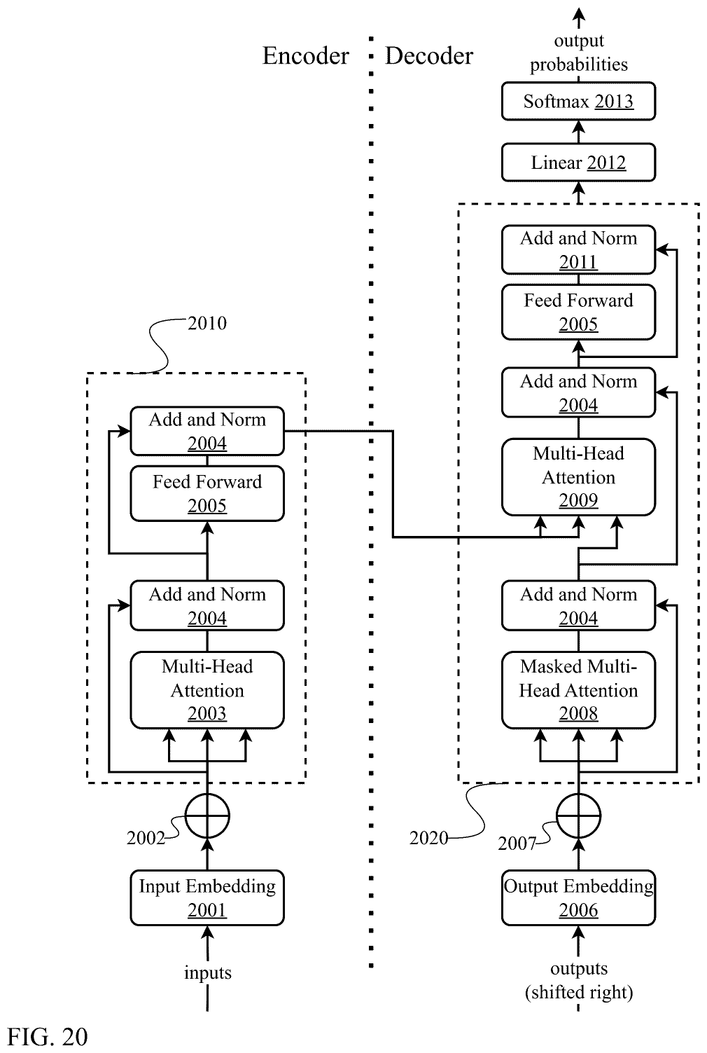

FIG. 20 is a block diagram illustrating an exemplary model architecture of the Transformer, consisting of an Encoder (the components on the left side of the illustration) and a Decoder (the components on the right side of the illustration). Transformers form the backbone of large language models. A large language model (LLM) is a type of artificial intelligence algorithm that utilizes deep learning techniques and massively large datasets to understand, summarize, generate and predict new content. The term Gen AI is also closely connected to LLMs, which are a type of Gen AI that has been specifically architected to help generate text-based content. All language models are first trained on a set of data, and then they make use of various techniques to infer relationships and then generate new content based on the trained data. Language models are commonly used in natural language processing (NLP) applications where a user inputs a query in natural language to generate a result.

An LLM is the evolution of the language model concept in AI that dramatically expands the data used for training and inference. In turn, it provides a massive increase in the capabilities of the AI model. While there isn't a universally accepted figure for how large the data set for training needs to be, an LLM typically has at least one billion or more parameters. Parameters are a machine learning term for the variables present in the model on which it was trained that can be used to infer new content.

Modern LLMs that have emerged within the last decade are based on transformer models, which are neural networks commonly referred to as transformers. With a large number of parameters and the transformer model, LLMs are able to understand and generate accurate responses rapidly, which makes the AI technology broadly applicable across many different domains. Some LLMs are referred to as foundation models, a term coined by the Stanford Institute for Human-Centered Artificial Intelligence in 2021. A foundation model is so large and impactful that it serves as the foundation for further optimizations and specific use cases.

LLMs take a complex approach that involves multiple components. At the foundational layer, an LLM needs to be trained on a large volume, sometimes referred to as a corpus, of data that is typically petabytes in size. The training can take multiple steps, usually starting with an unsupervised learning approach. In that approach, the model is trained on unstructured data and unlabeled data. The benefit of training on unlabeled data is that there is often vastly more data available. At this stage, the model begins to derive relationships between different words and concepts.

The next step for some LLMs is training and fine-tuning with a form of self-supervised learning. Here, some data labeling has occurred, assisting the model to more accurately identify different concepts.

Next, the LLM undertakes deep learning as it goes through the transformer neural network process. The transformer model architecture enables the LLM to understand and recognize the relationships and connections between words and concepts using a self-attention mechanism. That mechanism is able to assign a score, commonly referred to as a weight, to a given item (called a token) in order to determine the relationship.

Once an LLM has been trained, a base exists on which the AI can be used for practical purposes. By querying the LLM with a prompt, the AI model inference can generate a response, which could be an answer to a question, newly generated text, summarized text or a sentiment analysis report.

LLMs have become increasingly popular because they have broad applicability for a range of NLP tasks, including but not limited to, text generation, translation, content summary, rewriting content, classification and categorization, sentiment analysis, and conversational AI and chatbots.

There are numerous advantages that LLMs provide to organizations and users including, for example, extensibility and adaptability, flexibility, performance, accuracy, and case of training. LLMs can serve as a foundation for customized use cases. Additional training on top of an LLM can create a finely tuned model for an organization's specific needs. One LLM can be used for many different tasks and deployments across organizations, users and applications. Modern LLMs are typically high-performing, with the ability to generate rapid, low-latency responses. As the number of parameters and the volume of trained data grow in an LLM, the transformer model is able to deliver increasing levels of accuracy. Many LLMs are trained on unlabeled data, which helps to accelerate the training process.

While there are many advantages to using LLMs, there are also several challenges and limitations such as, development costs (e.g., LLMs generally require large quantities of expensive graphics processing unit hardware and massive data sets), operational costs, bias, hallucination (e.g., AI hallucination occurs when an LLM provides an inaccurate response that is not based on trained data), complexity (e.g., with billions, or more, of parameters, modern LLMs are exceptionally complicated technologies that can be particularly complex to troubleshoot), and glitch tokens which are maliciously designed prompts to cause the LLM to malfunction.

There is an evolving set of terms to describe the different types of large language models. Among the common types are zero-shot model, fine-tuned or domain-specific models, language representation models, and multimodal model. A zero-shot model is a large, generalized model trained on a generic corpus of data that is able to give a fairly accurate result for general use cases, without the need for additional training. GPT-3 is often considered a zero-shot model. Fine-tuned/domain-specific models require additional training on top of a zero-shot model and can lead to a fine-tuned, domain-specific model. One example is OpenAI Codex, a domain-specific LLM for programming based on GPT-3. One example of a language representation model is Bidirectional Encoder Representations from Transformers (BERT), which makes use of deep learning and transformers well suited for NLP. Originally LLMs were specifically tuned just for text, but with the multimodal approach it is possible to handle both text and images. GPT-4 is an example of this type of model.

There are multiple important components significantly influencing the architecture of LLMs. The size of an LLM, often quantified by the number of parameters, greatly impacts its performance. Larger models tend to capture more intricate language patterns but require increased computational resources for training and inference. Effective input representations, like tokenization, are vital as they convert text into formats that the model can process. Special tokens, like [CLS] and [SEP] in BERT, enable the model to understand sentence relationships and structure. Pre-training objectives define how a model learns from unlabeled data. For instance, predicting masked words in BERT helps the model learn contextual word relationships, while autoregressive language modeling in GPT-3 teaches coherent text generation. The computational demands of LLMs can be mitigated through techniques like knowledge distillation, model pruning, and quantization. These methods maintain model efficiency without sacrificing performance. How a model generates output is essential. Greedy decoding, beam search, and nucleus sampling are techniques used in LLMs for coherent and diverse output generation. These methods balance between accuracy & creativity, while creating a significant difference between LLMs and traditional language models.

The illustrated Transformer comprises an Encoder and a Decoder. The Encoder takes input embeddings and processes them through a stack of layers (represented as dashed box 2010). Each layer consists of: positional encoding, which adds position information to the input embeddings; multi-head attention, which allows the model to attend to different parts of the input sequence; add and norm, which applies residual connection and layer normalization; feed forward, which is a fully connected feed-forward network; and add and norm which is another residual connection and layer normalization.

The power of the transformer model lies in the self-attention mechanism. This mechanism contributes to accelerated learning compared to traditional models such as long short-term memory models. Self-attention empowers the transformer model with the remarkable capability to meticulously scrutinize distinct segments of a given sequence or even encompass the entire contextual essence of a sentence. This profound contextual awareness enables the model to make predictions with an elevated degree of accuracy and relevance.

The input embedding 2001 to the Encoder is a sequence of tokens, typically represented as integers. Each token is mapped to a learnable embedding vector of a fixed size. The embedding layer is a lookup table that converts each token into its corresponding dense vector representation. The embeddings are learned during training and capture semantic and syntactic relationships between tokens.

A dense vector representation, also known as a dense embedding or a continuous vector representation, is a way of representing data, particularly words or tokens, as dense vectors in a high-dimensional continuous space. In the context of natural language processing (NLP) and language models, dense vector representations are used to capture semantic and syntactic information about words or tokens. Each word or token is mapped to a fixed-size vector of real numbers, typically with hundreds or thousands of dimensions. Each word or token is represented by a vector of a fixed size, regardless of the length of the input sequence. The size of the vector is a hyperparameter that is determined during model design. The vectors exist in a continuous high-dimensional space, where each dimension represents a latent feature or aspect of the word or token. The continuous nature allows for capturing fine-grained relationships and similarities between words. The dense vector representations are learned during the training process of the model. The model learns to assign similar vectors to words that have similar meanings or occur in similar contexts. The dense vector representations aim to capture semantic and syntactic relationships between words. Words that have similar meanings or are used in similar contexts tend to have similar vector representations. Dense vector representations allow for performing algebraic operations on words, such as addition and subtraction. These operations can capture analogies and relationships between words, such as “prince”−“man”+“woman”≈“princess”. Dense vector representations serve as input features for various downstream NLP tasks, such as text classification, sentiment analysis, named entity recognition, and machine translation. The dense representations provide a rich and informative input to the models, enabling them to learn patterns and make predictions. Some popular examples of dense vector representations include, but are not limited to, Word2Vec, Global Vectors for Word Representations (GloVe), FastText, and BERT.

After the input embedding layer, positional encoding 2002 is added to the input embedding to provide position information to the model. Since the Transformer architecture doesn't have inherent recurrence or convolution, positional encodings help capture the order and relative positions of tokens. The positional encodings are typically sine and cosine functions of different frequencies, allowing the model to learn relative positions. The positional encodings have the same dimensionality as the input embeddings and are summed with them.

The Encoder utilizes a multi-head attention mechanism 2003 which is a key component of the Transformer architecture. It allows the Encoder to attend to different parts of the input sequence and capture dependencies between tokens. The attention mechanism computes three matrices: Query (Q), Key (K), and Value (V). The Query, Key, and Value matrices are obtained by linearly projecting the input embeddings using learned weight matrices. The attention scores are computed by taking the dot product of the Query matrix with the transpose of the Key matrix, followed by scaling and applying a softmax function. The attention scores determine the importance of each token in the input sequence for a given position. The Value matrix is then multiplied with the attention scores to obtain the weighted sum of the values, which forms the output of the attention mechanism. Multi-Head Attention splits the Query, Key, and Value matrices into multiple heads, allowing the model to attend to different aspects of the input simultaneously. The outputs from each head are concatenated and linearly projected to obtain the final output of the Multi-Head Attention layer 2003.

After the Multi-Head Attention layer, a residual connection is applied, followed by Layer Normalization at add and norm 2004. The residual connection adds the input embeddings to the output of the attention layer, helping the model learn faster and deeper. Layer Normalization normalizes the activations across the features, stabilizing the training process.

The Feed Forward layer 2005 is a fully connected neural network applied to each position of the Encoder's hidden states. It consists of two linear transformations with a Rectified Linear Unit (ReLU) activation function in between. The purpose of the Feed Forward layer is to introduce non-linearity and increase the model's capacity to learn complex representations. The output of the Feed Forward layer has the same dimensionality as the input embeddings. A residual connection and Layer Normalization 2004 are applied after the Feed Forward layer.

The Encoder layers 2010 are stacked Nx times, where N is a hyperparameter that determines the depth of the Encoder. Each layer follows the same structure: Multi-Head Attention, Add & Norm, Feed Forward, and Add & Norm. By stacking multiple Encoder layers, the model can capture hierarchical and long-range dependencies in the input sequence. The output of the final Encoder layer represents the encoded input sequence, which is then passed to the Decoder for generating the output sequence.

The Decoder generates the output probabilities. It has a similar structure to the Encoder, with a few additions. The Decoder takes output embeddings and processes them through a stack of layers (represented as dashed box 2020). The output embedding layer 2006 takes the previous output tokens (shifted right by one position) and converts them into dense vectors. Each token is mapped to a learnable embedding vector of a fixed size. The embedding vectors capture semantic and syntactic relationships between tokens.

Positional encoding 2007 is added to the output embedding to provide position information to the model. Since the Transformer architecture does not have inherent recurrence or convolution, positional encodings help capture the order and relative positions of tokens. The positional encodings are typically sine and cosine functions of different frequencies, allowing the model to learn relative positions.

The masked multi-head attention 2008 mechanism prevents the model form attending to future tokens. This layer performs self-attention on the Decoder's input sequence. It allows the Decoder to attend to different parts of its own input sequence. The attention is “masked” to prevent the Decoder from attending to future tokens, ensuring that the predictions are based only on the previously generated tokens. Multi-head attention splits the input into multiple heads, allowing the model to attend different aspect of the input simultaneously.

After the masked multi-head attention, a residual connection is applied follows by layer normalization via add and norm 2004. The residual connection adds the input to the output of the attention layer, helping the model learn faster and deeper. Layer normalization normalizes the activations across the features, stabilizing the training process.

The multi-head attention 2009 layer performs attention between the Decoder's hidden states and the Encoder's output. It allows the Decoder to attend to relevant parts of the input sequence based on the Encoder's representations. The attention weights are computed based on the compatibility between the Decoder's hidden states and Encoder's outputs.

Another add and norm 2004 layer is then followed by feed forward network 2005. This a fully connected feed-forward network applied to each position of the Decoder's hidden states. It consists of two linear transformations with a Rectified Linear Unit (ReLU) activation in between. The feed forward layer helps the model capture non-linear interactions and increases the model's capacity.

Another add and norm 2004 layer is followed by linear 2012 and softmax 2013 layers. The final hidden states of the Decoder are passed through a linear transformation to project them into the vocabulary space. Vocabulary space refers to the set of all unique tokens or words that the model can generate or predict. In the context of language models, the vocabulary is a predefined set of tokens that the model is trained on and can output. When the Decoder's final hidden states are passed through a linear transformation, they are projected into a vector space with the same dimensionality as the size of the vocabulary. Each dimension in this space corresponds to a specific token in the vocabulary. For example, the model has a vocabulary of 10,000 unique tokens. The linear transformation would project the Decoder's hidden states into a 10,000-dimensional vector space. Each element in this vector represents the model's predicted probability or score for the corresponding token in the vocabulary.

A softmax function is applied to the projected values (vectors) to generate output probabilities over the vocabulary. The softmax function normalizes the values so that they sum up to 1, representing a probability distribution over the vocabulary. Each probability indicates the likelihood of a specific token being the next output token. The token with the highest probability is selected as the next output token. During the model's training, the objective is to maximize the probability of the correct next token given the input sequence and the previously generated tokens. The model learns to assign higher probabilities to the tokens that are more likely to appear based on the context. At inference time, the token with the highest probability in the vocabulary space is selected as the next output token. This process is repeated iteratively, with the generated token being fed back into the Decoder as input for the next step, until a stopping criterion is met (e.g., reaching a maximum length or generating an end-of-sequence token). The size and composition of the vocabulary can vary depending on the specific task and the data the model is trained on. It can include words, subwords, or even characters, depending on the tokenization strategy used.

The Decoder layers 2020 can be stacked Nx times, allowing the model to capture complex dependencies and generate coherent output sequences.

This transformer architecture allows the model to process input sequences, capture long-range dependencies, and generate an output sequence based on the encoded input and the previously generated tokens.

There are at least three variations of transformer architecture that enable different LLMs. A first such variation comprises Auto-Encoding Models. In autoencoders, the decoder portion of the transformer is discarded after pre-training and only the encoder is used to generate the output. The popular BERT and ROBERTa models are examples of models based on this architecture and perform well on sentiment analysis and text classification. These types of models may be trained using a process called masked language modeling (MLM).

The primary goal of an autoencoder is to learn efficient representations of input data by encoding the data into a lower-dimensional space and then reconstructing the original data from the encoded representation. Autoencoders are trained in an unsupervised manner, meaning they don't require labeled data. They learn to capture the underlying structure and patterns in the input data without explicit guidance. An autoencoder consists of two main components: an encoder and a decoder. The encoder takes the input data and maps it to a lower-dimensional representation, often referred to as the latent space or bottleneck. The decoder takes the latent representation and tries to reconstruct the original input data. Autoencoders can be used for dimensionality reduction by learning a compressed representation of the input data in the latent space. The latent space has a lower dimensionality than the input data, capturing the most salient features or patterns. The training objective of an autoencoder is to minimize the reconstruction error between the original input and the reconstructed output. The model learns to encode and decode the data in a way that preserves the essential information needed for reconstruction. Variants and extensions of autoencoders can include denoising autoencoders, variational autoencoders (VAEs) which introduce a probabilistic approach to autoencoders wherein they learn a probabilistic encoder and decoder, allowing for generating new samples from the learned latent space, and conditional autoencoders which incorporate additional conditions or labels as input to the encoder and decoder, enabling the generation of samples conditioned on specific attributes.

Autoencoders can have various applications. Autoencoders can be used to detect anomalies by measuring the reconstruction error. Anomalous samples tend to have higher reconstruction errors compared to normal samples. Autoencoders can be used as a pre-training step to learn meaningful features from unlabeled data. The learned features can then be used for downstream tasks like classification or clustering. Additionally, or alternatively, autoencoders, particularly VAEs, can be used as generative models to generate new samples similar to the training data by sampling from the learned latent space. It's worth noting that while autoencoders can be effective for certain tasks, they have some limitations. They may struggle to capture complex dependencies and may generate blurry or less sharp reconstructions compared to other generative models like Generative Adversarial Networks (GANs).

Another type of variation is the auto-regressive model which feature the use of only the decoder portion of the transformer architecture. In autoregressive architectures, the decoder portion of the transformer is retained and the encoder portion is not used after model pre-training. Auto-regressive models are a class of models that generate outputs by predicting the next element based on the previously generated elements. In the context of the Transformer architecture and language modeling, auto-regressive models are commonly used for tasks such as text generation, machine translation, and language understanding.

Auto-regressive models generate outputs sequentially, one element at a time. In the case of language modeling, the model predicts the next word or token based on the previous words or tokens in the sequence. The prediction of the next element is conditioned on the previously generated elements. The model learns the conditional probability distribution P (x_t|x_1, x_2, . . . , x_{t−1}), where x_t is the element at position t, and x_1, x_2, . . . , x_{t−1} are the previously generated elements. The Transformer architecture, particularly the Decoder component, is well-suited for auto-regressive modeling. The Decoder generates the output sequence one element at a time, conditioned on the previously generated elements and the encoded input sequence from the Encoder. In the Transformer Decoder, the self-attention mechanism is masked to prevent the model from attending to future positions during training. This masking ensures that the model relies only on the previously generated elements to make predictions, following the auto-regressive property. During training, the Transformer Decoder uses a technique called teacher forcing. Instead of feeding the model's own predictions as input for the next step, the ground truth target sequence is used. This helps the model learn to generate the correct output sequence based on the input sequence and the previous target tokens. During inference or generation, the Transformer Decoder generates the output sequence one element at a time. At each step, the model takes the previously generated elements as input and predicts the next element. This process continues until a stopping criterion is met, such as reaching a maximum sequence length or generating an end-of-sequence token. Auto-regressive models, including the Transformer, have achieved state-of-the-art performance in language modeling tasks. They excel at capturing the statistical properties and dependencies in sequential data, making them effective for generating coherent and fluent text.

While text generation is the most suitable use case of auto-regressors, they perform exceptionally well on a wide variety of tasks. Most modern LLMs are auto-regressors including, for example, the popular GPT series of LLMs, BERT, and XLNet.

The third variation of the transformer model is the sequence-to-sequence model which utilizes both the encoder and decoder portions of the transformer and can be trained in multiple ways. One of the methods is span corruption and reconstruction. These models are, generally, best suited for language translation. The T5 and BART family of models are examples of sequence-to-sequence models.

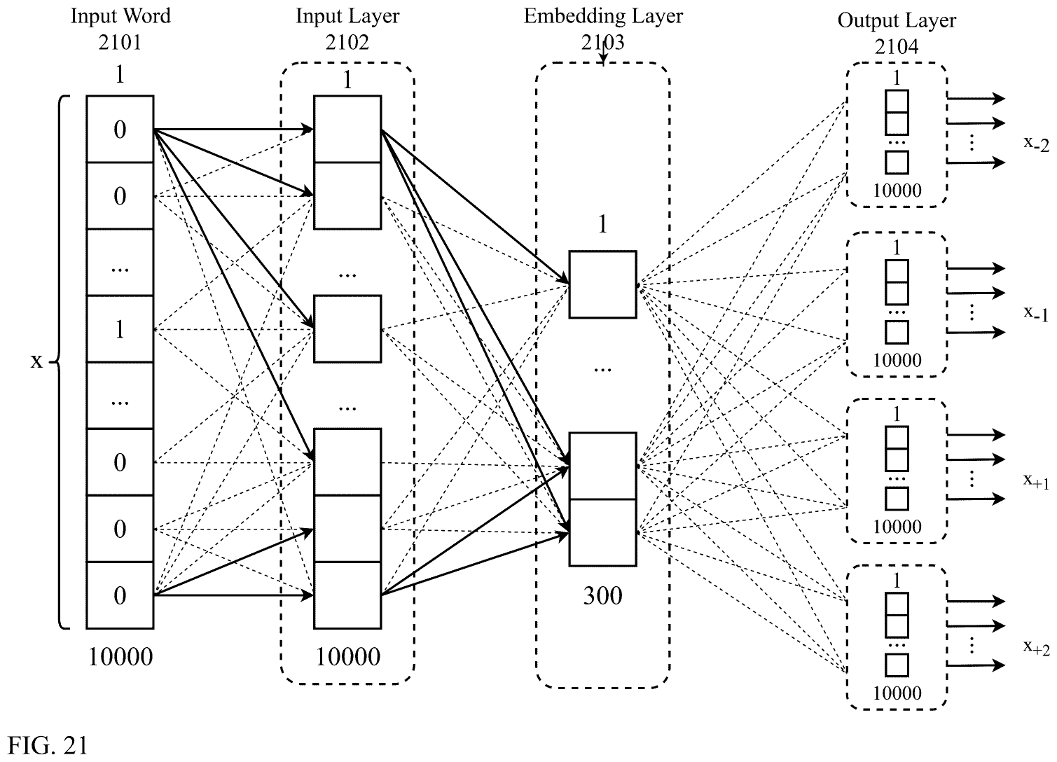

FIG. 21 is a block diagram illustrating an exemplary basic embedding layer generation process, according to an embodiment. The illustration shows the basic structure of an embedding layer, which is commonly used in natural language processing tasks to convert input words into dense vector representations. The diagram shows an input word 2101, an input word layer 2102, an embedding layer 2103, and an output layer 2104. As shown, the input word 2101 is represented as one-hot encoded vectors, where each word is represented by a vector of size 10,000 (i.e., the vocabulary size). One-hot encoding is a common technique used to represent categorical variables, such as words in a vocabulary, as binary vectors. In one-hot encoding, each word is represented by a vector with a length equal to the size of the vocabulary. The vector consists of zeros in all positions except for a single position, which is set to one, indicating the presence of the corresponding word. The input word is one-hot encoded with a 1 at the corresponding word index and 0s elsewhere. For example, if a vocabulary of 10,000 words exists, each word will be represented by a vector of size 10,000. If the input word is the 5th word in the vocabulary, its one-hot encoded vector will have a 1 at the 5th position and 0s everywhere else. It is important to note that the one-hot encoding is just one way to represent input words. Other techniques, such as integer encoding or using pre-trained word embeddings (e.g., Word2Vec or GloVe), can also be used depending on the specific requirements of the task and the available resources.

The input layer 2102 takes the one-hot encoded input word vectors and passes them to the embedding layer 2103. The input layer in the embedding generation process is responsible for handling the initial representation of the input words before they are passed to the embedding layer. The one-hot encoding ensures that each word has a unique representation, but it also results in sparse and high-dimensional vectors. The embedding layer 2103 then transforms these sparse vectors into dense, lower-dimensional representations (embeddings) that capture semantic and syntactic relationships between words. The embedding layer 2103 is a fully connected layer without an activation function. It maps the one-hot encoded input vectors to dense vector representations of a specified dimension (in this case, 300). The embedding layer has a weight matrix of size (vocabulary_size, embedding_dimension), which is learned during training. In the given example, the vocabulary size is 10,000, and the embedding dimension is 300. Each row in the weight matrix corresponds to a word in the vocabulary, and the columns represent the dimensions of the embedding space. When a one-hot encoded vector is passed to the embedding layer, it performs an embedding lookup. Since the one-hot vector has a single 1 at the position corresponding to the input word, the embedding lookup effectively selects the corresponding row from the weight matrix, which represents the embedding vector for that word.

The embedding size (dimension) is a hyperparameter that determines the size of the dense vector representations. In the example, the embedding size is 300, meaning each word is represented by a vector of length 300. The choice of embedding size depends on the complexity of the task, the size of the vocabulary, and the available computational resources. Larger embedding sizes can capture more fine-grained semantic information but also require more memory and computation. The embedding layer's weights (the embedding vectors) are learned during the training process through backpropagation. The model adjusts these weights based on the downstream task's objective, such as minimizing a loss function. As a result, the learned embeddings capture semantic and syntactic relationships between words, with similar words having similar vector representations. Once the embeddings are learned, they can be reused for various downstream tasks. The learned embeddings can be used as input features for other models, such as recurrent neural networks (RNNs) including echo state network (ESN) and graph neural network (GNN) variants or convolutional neural networks (CNNs), in tasks like text classification, sentiment analysis, or language translation.

The output layer 2104 consists of the dense word embeddings generated by the embedding layer. In this example, there are four output embedding vectors, each of size 300, corresponding to different words in the vocabulary. The embedding layer allows the model to learn meaningful representations of words in a lower-dimensional space, capturing semantic and syntactic relationships between words. These embeddings can then be used as input to downstream tasks such as text classification, sentiment analysis, or language modeling.

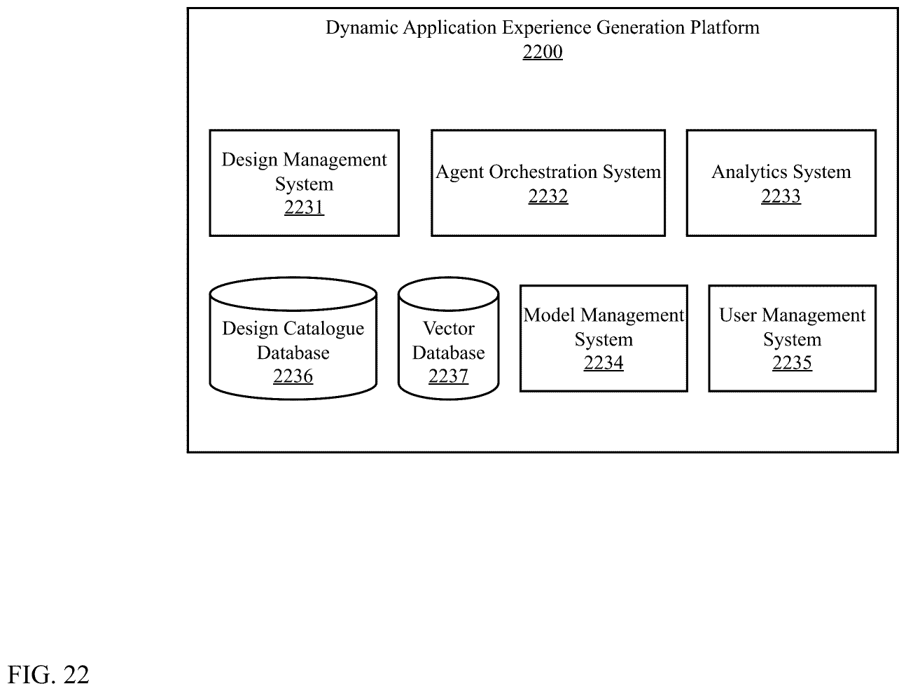

FIG. 22 is a block diagram illustrating an exemplary system architecture for dynamic generation of application experiences, according to an embodiment. According to the embodiment, dynamic application experience generation platform 2200 comprises a design management system 2231, an agent orchestration system 2232, an analytics system 2233, a model management system 2234, a user management system 2235, and one or more databases for storing design elements and templates 2236 and a vector database 2237 for storing vectorized data such as, for example, user specification, design elements/templates, etc.

According to the embodiment, design management system 2231 is present and configured to provide a portal for application owners/designers to create and design a UX/UI for an application or website. According to an aspect of an embodiment, an owner/designer can select from a set of prospective categories or sites they like. For example, the set of categories/sites/templates/elements may be implemented as a visual workboard for design elements which allows users to browse and select design elements that appeal to them or their website/application use case. This could be tagged for things like “design”, “color”, “layout”, “function”, “imagery”, “workflow”, etc. This may be performed manually (e.g., via a wizard) or via interrogation (i.e., chatbot prompts) to get sufficient user clarity through a series of interactions. The clarity of the user specification may be scored or otherwise analyzed to determine if there is sufficient clarity for Gen AI prompt generation/engineering and feedback loop purposes. According to an aspect, a clarity score may be determined based on how clear and specific the user specification is.

Platform 2200 may gather a collection of existing websites/applications that represent a variety of design styles and functionalities. In some implementations, one or more AI systems may be configured to analyze these websites/applications to identify common design patterns, elements, and layouts that can be used as templates. These design patterns, elements, and layout may be stored in a design catalogue database 2236. Design catalogue database 2236 may store templatized versions of existing websites/applications. Design catalogue database 2236 may store the raw, non-templatized websites/applications. Design catalogue database 2236 may store a plurality of design elements such as, for example, colors, shapes, formats, functions, widgets, cards, tiles, panels, tabs, dropdown menus, accordion menus, sliders, form elements, icons, progress indicators. These design elements can be used individually or combined to create more complex and interactive user interfaces. Design management system 2231 may utilize a user-friendly interface allowing designers to easily browse and search the catalogue of templates/design elements. This can include features such as filtering by category, style, and functionality to help designers find the relevant templates.

In some implementations, an AI system may be used to catalogue and suggest historical templatized interfaces and concepts that are part of an ongoing “generative content” catalogue which may be stored in design catalogue database 2236. This can not only be used for design explorations/suggestions in the visual editing/suggestion workflows, but may inspire alternate process definition elements. For example, the platform can provide expanded capabilities in cross-platform and human-machine team application generation to generate and design applications that integrate with various legacy systems such as Appian, Pega System, and ServiceNow. These legacy system are known for their ability to define forms, workflows, and other components using Business Process Notation Language and similar languages. Platform 2200 can use these definitions and inputs to generate templated applications that meet the specifications provided by the user. This approach would allow for rapid development and deployment of applications that integrate with existing systems and adhere to established workflows and processes.

It should be appreciated that platform 2200 may be configured for the ability to do “language shifts” for legacy applications where there is some need to shift. For example, Cobalt core banking applications may require a language update as there are few Cobalt developers left and they are costly to employ. Translation of applications by merging process expectations, design expectations, and even things like Binary Executable Transform based execution analysis, (with optional JITing emulation instruction for testing validation, stability, functionality, and security) can improve results when used in an interactive/orchestrated fashion.

Similarly, there are a lot of case where old software is not optimized for newer chips (e.g., the AMD Threadripper 3D chips can't use all their cores in a lot of gaming software). As another example, Autocad is not well optimized (basically single threaded in some cases). It should be appreciated that this composite “application reimaging” can work to preserve experience or function elements by using at least one of the generation/validation model steps proposed herein. Furthermore, explanations of limitations in the software would be valuable to identify (e.g., user just wrote this in a way that is single threaded-did you intend to? Can I optimize this for a specific hardware platform for you?). This could be returned as text-to-voice or generate a video to explain it to the user with an avatar.

In an embodiment, a Gen AI model may be configured for generating interfaces and managing data transfer contracts. In such an embodiment, platform 2200 may comprise data contract enforcement mechanisms and data registries. For interface generation, Gen AI can help create user interfaces for applications, websites, or other systems. It can generate UI components based on specifications or requirements, which can be particularly useful for rapid prototyping or creating consistent UI designs. Regarding data transfer contracts, Gen AI can assist in creating or managing contracts that govern the transfer of data between different parties or systems. This includes formats like Avro or Protobufs, which are used to serialize data for efficient transmission and storage. A data transfer contract is a legal agreement that governs the transfer of data from one party to another. These contracts are often used when sensitive or personal data is being transferred, such as in the context of data processing agreements, international data transfers, or sharing data between organizations. Data transfer contracts typically include provisions related to the following: data protection, data security, data processing, data subject rights, data retention, data breach notification, liability and indemnification, and jurisdiction and governing laws. Data transfer contracts are important for ensuring that data transfers comply with legal requirements and that the rights of data subjects are protected.

The implementation of data contracts can vastly improve cross platform application development workflows and code generation when combined with Gen AI techniques. According to an aspect, the data contract may be decentralized. This ensures that teams with diverse data uses or multiple engineering teams are not hindered and facilitate healthy, timely evolution of data products. Data producers should be responsible for data contract enforcement. If there's no enforcement of the contract on the producer side then it is not a contract and downstream teams cannot utilize or plan appropriately. Contract data should be available to all consumers (e.g., transparent access to schema and structure to the data user and not only the data platform). Other services should be able to consume versioned contract data and data descriptions separate from the data. Data contracts may be public to authenticated/authorized users and services. Implementation must support evolving contracts over time without breaking downstream consumers, which necessitates versioning and strong change management. This again begins at the producer so that downstream teams can plan to version hop as the producer releases new and enhanced variants. Data contracts must always cover both the schemas and semantics. At the most basic level, contracts cover the schema of entities and associated events, while preventing backward incompatible changes like dropping a required field. In API design, altering the APIs behavior is considered a breaking change even if the API signature remains the same. Here, this means contracts must contain additional metadata beyond the schema, including descriptions, value constraints, and so on.

Data contracts should not hinder iteration speed for developers. Defining and implementing data contracts should be handled with tools already familiar to backend developers, and enforcement of contracts may be automated as part of the existing CI/CD pipeline. The implementation of data contracts reduces the accumulation of tech debt and tribal knowledge at a company, having an overall net positive effect on iteration speed. Data contracts, when used properly, enhance, and should not hinder iteration speed for data scientists. Access to raw (non-contract) production data should be available in a limited “sandbox” capacity to allow for exploration and prototyping. However, users should avoid pushing prototypes of unsupported schemas or semantics into production directly. Once again, the implementation of data contracts reduces the accumulation of tech debt and tribal knowledge at a company, having an overall net positive effect on iteration speed in the client-facing production services.

Contracts are abstractions. Reading directly from databases and copying into data platforms directly (CDC) is an anti-pattern. Data contracts may be used to decouple the internal details of the database to provide consumers with the data they actually need to do their jobs internal to the engineering organization or within the ultimate client/user base.

According to the embodiment, agent orchestration system 2232 is present and configured to parse a user specification to select the appropriate Gen AI systems (also referred to herein as agents) to generate the UX/UI content based on the user specification. Agent orchestration system 2232 may perform prompt engineering tasks to create one or more prompts based on the user specification and the selected Gen AI systems to be submitted to the selected Gen AI systems. The selected agents may then generate UX/UI content based on the prompt. In some embodiments, this process may be an iterative one, wherein the one or more selected Gen AI systems generate the content as defined by the user specification and the designer and/or industry experts can provide feedback about the performance of the generated UX/UI content. This feedback may be used to generate a new design and the designer may select from the available designs the one they wish to continue using.

According to the embodiment, analytics system 2233 is present and configured to collect, process, analyze, and interpret data to provide insights that can help application owners and designers and/or application users to make informed decisions related to generated UX/UI content. Analytics system 2233 can collect data from various sources, such as databases, files, application programming interfaces (APIs), third-party services, and streaming data sources. Exemplary data that might be collected can include but is not limited to, load times, observability, conversion rates, site metrics, user demographic or contextual factors, user behavior, usage patterns, and latency, to name a few. For example, analytics system 2233 may use tools similar to Google Analytics, Hotjar, or custom tracking scripts to collect data on load times, observability, conversion rates, site metrics, demographic/contextual factors, user behavior, etc. The system may integrate APIs of data pipelines to gather data from different sources and formats into a centralized data warehouse or data lake.

Data analytics system 2233 may clean and preprocess the collected data to handle missing values, outliers, and inconsistencies. Collected data may be transformed into a format suitable for analysis, such as aggregating data points over time intervals or user sessions, or vectorizing data (using an embedding model) for processing by one or more artificial intelligence (AI) systems (e.g., neural network, transformer model, etc.). Analytics system 2233 may use statistical analysis and machine learning techniques to analyze the data and extract insights. For example, AI may be used to identify patterns, trends, correlations, and anomalies in the data related to UX/UI performance and/or user behavior. In some embodiments, analytics system 2233 may be configured to create visualizations (e.g., charts, graphs, dashboards, etc.) to represent the analyzed data and insights. For example, system may visualize metrics like load times, conversion rates, user demographics, and behavior patterns to make them easier to understand and interpret.

The collected and analyzed data may be used to generate insights and recommendations based on the analysis to improve UX/UI design, optimize website performance (based on one or more optimization factors or goals), and enhance user experience. For example, the system may generate actionable recommendations for improving conversion rates, reducing latency, and addressing user needs/preferences. In some implementations, the actionable recommendations may be implemented dynamically wherein the changes/optimizations are automatically applied in real-time or near real-time to enhance the experience of the application user. Analytics system 2233 may continuously monitor website/application performance and user interactions to identify areas of improvement. System may implement A/B testing and other optimization strategies to test and validate proposed changes based on data-driven insights. For example, individual design elements might be swapped (e.g., button colors or specific images or terms) to look at optimization of conversion funnels for specific elements linked to site value, performance, profitability, and/or the like.

A model management system 2234 is present and configured to obtain, train, and/or maintain one or more Gen AI or ML models which may be used by agent orchestration system 2232 to generate UX/UI content, according to an embodiment. For the use case directed to curating a user's experience with the Internet there are several types of Gen AI systems that could be used to curate and render content on a custom web page (or some other type of representation such as a mobile app render, an AR/VR environment, etc.). One of many possible examples can include a conditional image generation system which generates images based on conditional inputs such as, for example, generating different versions of a product image based on user preferences. The one or more Gen AI models which may be implemented by platform 2200 may be trained on a plurality of training data comprising design elements, websites and applications, functionalities, various coding languages (e.g., JavaScript, Swift, HTML, CSS, etc.), design templates, user and expert feedback, and/or the like.

A user management system 2235 is present and configured to implement user management features, such as user accounts and permissions, to allow for collaboration among team members. Designers can be enabled to share design projects and collaborate on them within the design portal.

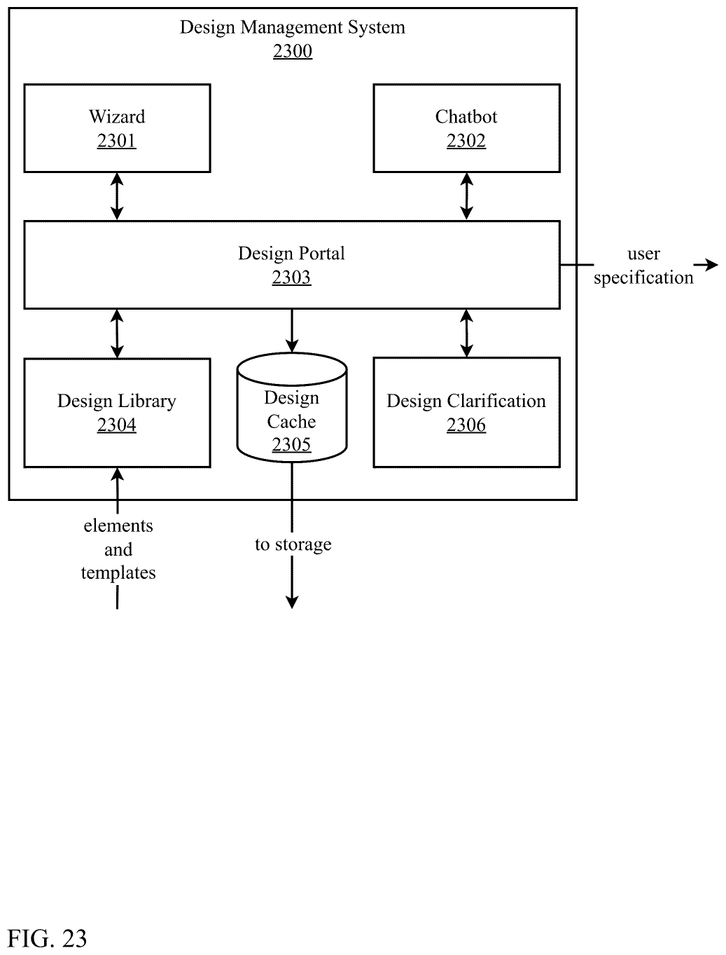

FIG. 23 is a block diagram illustrating an exemplary aspect of dynamic application experience generation platform, a design management system 2300. According to the aspect, design management system 2300 comprises a design portal 2303, a design library 2304, a design clarification subsystem 2306, and a design cache 2305. Design portal 2303 may be configured to allow users to select from a set of prospective categories or sites they like in order to create a user specification which captures all the design elements, functionality, and purpose of generated UX/UI content for a website or application. At the design portal, a user (e.g., website/application owner/designer) can interact with design library 2304 to browse and view various design elements. This may be performed manually via a wizard 2301 or via interrogation using, for example, chatbot 2302 prompts. A wizard is a user interface that leads a user through a sequence of small steps, like a dialog box to configure a program for the first time. Wizard 2301 may be configured to lead the user through the design selection process by asking the user for input related to UX/UI design implementation. For example, wizard 2301 may ask the user to select a defined goal from a list of potential goals for the UX/UI content and provide any available context, specifics, or examples. In some implementations, a chatbot 2302 may be configured to perform the functionality of wizard 2301, but in a conversational manner. In some implementations, chatbot 2302 may be based on a transformer model, LLM, or mamba model. The answers provided by the user to the chatbot may be used to choose a set of or specific design elements. For example, wizard or chatbot may obtain from the user a type of website/application they want to create and a set of templates associated with the type may be retrieved from design catalogue database 2236 and displayed to the user via design library 2304.

According to the aspect, design library 2304 is configured to provide a graphic user interface (GUI) which presents a plurality of design elements and/or templates which a user may peruse and select from. The displayed set of elements/templates may be arranged in a “workboard” layout where a plurality of design elements and templates may be organized and displayed to the user so that the user can browse, search, and preview various design elements/templates. For example, users may search by website/application type such as, for example, e-commerce websites/applications, social media platforms, content management system (e.g., blogs and other digital content), online learning platforms, new websites/applications, entertainment platforms (e.g., video or music streaming), gaming platforms, travel and booking, financial services, health and fitness, and/or the like. If a user wishes to create the UX/UI for an online learning platform, then design management system 2300 may retrieve all templates associated (e.g., tagged) with online learning websites or applications from design catalogue database 2236 and display them to the user via design library 2304.

The responses to wizard/chatbot, the design elements and/or templates selected by the user, the users interaction with the workboard (e.g., search queries, mouse clicks, hover time, etc.), and any available user preferences (e.g., retrieved from a preference database or submitted directly by the user) may be included in a user specification. It should be appreciated that a user specification may comprise more or less information than what was described above. A user specification may be sent to a design clarification subsystem 2306 which is configured to assess the clarity of the user specification based on various factors and assign a clarity score to the user specification. In some embodiments, the clarity score may be used to determine if the user specification comprises adequate information (e.g., in quality and quantity) to engineer a prompt for one or more Gen AI systems. For example, a computed clarity score may need to match or exceed a predetermined threshold value to be submitted to a prompt engineering subsystem.

A design cache 2305 is present and configured to capture and temporarily store user specifications, user design choices, responses to wizard/chatbot, and a clarity score for a given user specification. This information may be periodically sent to and stored in design catalogue database 2236. This information may be used to train or improve the one or more ML/AI/scoring models used by platform 2200. For example, a scoring model may be improved by using historical user specification data with its assigned clarity score as well as user behavior/interaction data collected when the user interacts with the generated content, to improve its scoring capabilities by, for example, adjusting the weights assigned to one or more clarity factors.

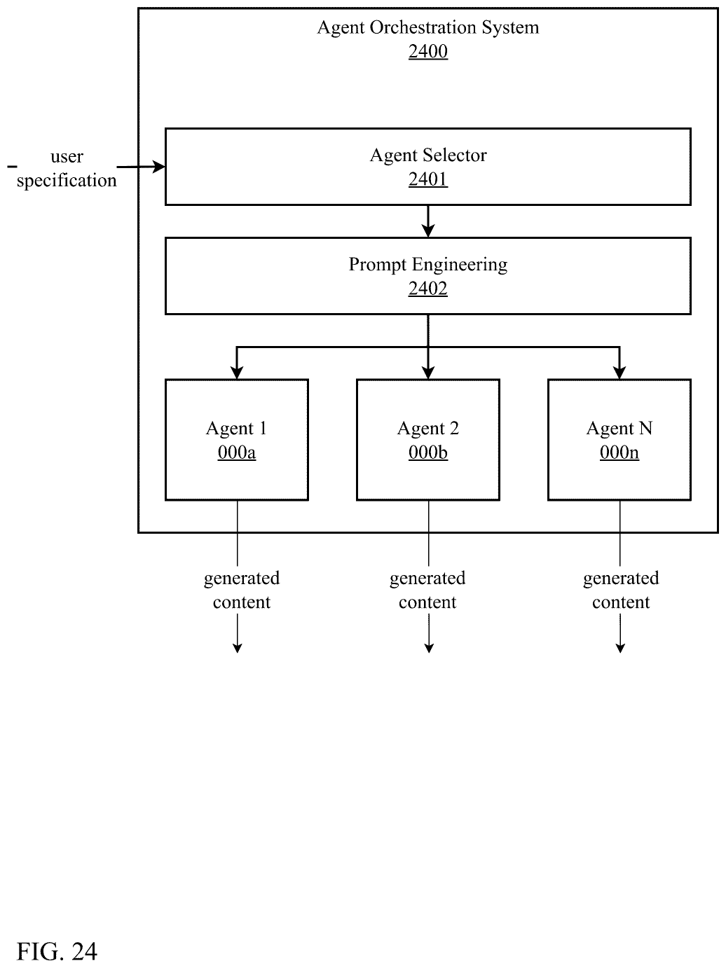

FIG. 24 is a block diagram illustrating an exemplary aspect of dynamic application experience generation platform, an agent orchestration system 2400. According to the aspect, agent orchestration system 2400 comprises an agent selector subsystem 2401, a prompt engineering subsystem 2402, and one or more agents 2403a-n which represent one or more Gen AI systems. According to the aspect, agent orchestration system 2400 receives a user specification from design management system 2400 via agent selector 2401. Agent selector 2401 may be configured to parse the user specification and select one or more appropriate Gen AI systems (also referred to herein as agents) to generate the UX/UI content described by the user specification. The selection of the one or more agents may be based on various factors including, but not limited to, the user defined requirements (e.g., target audience, design goals, functionality, platform/device, etc.), Gen AI (gen AI) system compatibility (e.g., using an LLM to generate text, diffusion models to generate images or sound, etc.), model performance (e.g., factors such as the quality of designs, the range of design options, and the ability to customize to meet the user's needs), model integration (e.g., models which can easily be integrated into existing workflows and tools), cost and licensing, and user/expert feedback (e.g., gathered feedback from stakeholders and iterate on design).

There are several Gen AI systems that are used across various industries and there will be more Gen AI systems that develop in the near future which may be incorporated into platform 2200. Some notable examples of Gen AI system that may be implemented by platform include transformers and its variants (e.g., autoregressive), neural networks and its variants (e.g., convolutional neural network, recurrent neural network), generative adversarial networks (GANs), image recognition, image editing, natural language understanding, and/or the like. For example, a large language model may be selected to generate textual content for a UX/UI and a convolutional neural network to perform text-to-image synthesis for a UX/UI. Examples of Gen AI systems can further include OpenAI's GPT models, DeepArt.io, RunwayML, Google's DeepDream, Artbreeder, and various others.

Agents may be selected based on the platform the UX/UI needs to be displayed on. Once the proper agents have been selected, the user specification may be sent to prompt engineering subsystem 302. Prompt engineering is a process used to design prompts or instructions that guide the behavior of Gen AI systems. It involves crafting specific inputs that help the model understand the desired task or context and generate relevant content. The first step is to clearly define the task or goal the user wants the agents to perform. This could be anything from answering a question to summarizing a text or generating creative content. Based on the task, prompt engineering subsystem 2402 designs a prompt that provides the necessary context for the agent(s). The prompt should be clear, concise, and include any relevant information or examples that the model needs to generate a response. In some implementations, system 2300 may experiment with different prompts and parameters to see how they affect the model's performance. This may involve adjusting the length of the prompt, the type of information included, and other factors. Additionally, system 2300 can test the agent(s) with different prompts to evaluate their performance. This could involve measuring the accuracy of its responses, its ability to generalize to new tasks, and other metrics. Overall, prompt engineering is an iterative process that involves designing and refining prompts to help Gen AI systems perform specific tasks (e.g., UX/UI content generation) effectively.

The one or more selected agents 2403a, 2403b, and 2403n may be fed as inputs the engineered prompt to generate UX/UI content based on the user specification. In some embodiments, prompt engineering subsystem 2402 may be configured to only generate prompts for user specifications that have a sufficient clarity score. For example, a predetermined threshold value may need to be met or surpassed for prompt engineering system 2402 to generate a prompt.

In some implementations, each agent may be given modified versions of the same prompt. A first agent 2403a may generate a first design variation based on user preferences and user specification. A second agent 2403b may generate a second design variation and so on for each operational agent. This provides designers with multiple options to choose from. Designers may provide feedback on generated designs and request iterations or adjustments as needed. This feedback may be used to improve the agent's ability to generate designs that meet the user expectations. In some implementations, the designers may export generated designs in standard formats (e.g., PSD, Sketch, HTML/CSS, etc.) for further customization or integration into their projects. For example, platform 2200 may be integrated with popular design tools and platforms to streamline the design workflow for designers.

Platform 2200 can provide cross platform UX/UI content generation responsive to user specification. A user may specify the types of devices/platforms on which their designed UX/UI should be generated for. For example, a user specification may indicate that the UX/UI should be generated for websites, mobile device applications, and smart wearable devices. Agent(s) 2403a-n may then generate computer code in various coding languages to implement the design criteria represented in the user specification. For creating the structure and content of web pages Hypertext Markup Language (HTML) code may be generated as well as Cascading Style Sheets (CSS) code for styling the appearance of web pages, including layout, colors, and fonts, and JavaScript code for adding interactivity and dynamic behavior to web pages, such as animations, form validation, and user interface components. For mobile device applications, an agent can generate UX/UI for iOS using coding languages Swift or Objective-C. For Android devices the coding language may be Java or Kotlin. For cross-platform use of frameworks such as React Native, Flutter, and Xamarin to generate code that runs on both iOS and Android platforms. Many smart wearable devices have their own Software Development Kits (SDKs) and development environments, for example, WatchKit with Swift or Objective-C. The selection of the appropriate coding language the agents will use to generate UX/UI content is based on the information provided in the user specification. In addition to these languages, technologies, and frameworks, the Gen AI systems may also be trained on specific tools and libraries for each platform and device to create effective UX/UI designs and ensure compatibility and performance. This can enable everyday users to generate significantly more effective workflows/sites. This also enables not just “concept to code” mapping for users but ongoing site evolution. For example, link the site performance (e.g., load times, observability, etc.) with conversion rates and site metrics (e.g., shopping checkouts/revenue and site analytics on time per page, etc.) and more detailed user click/trace/eye tracking elements the system can provide programmatic A/B testing.

A/B testing and monitoring site performance is a useful element for Gen AI workflows and on the fly customization since metrics such as load times might encourage image or content compression, size changes, etc. to get to superior performance, even in case with network instability, to result in more efficient commercial conversion. As it relates to advertisements, the system may leverage other demographic or contextual factors to change “sets” of things such as, for example, image/word combinations (e.g., a consumer estimated to be a hippy kind of persona might get “all natural” and “green” language and imagery where a science focused consumer might see “lab coats” and equipment/science text/arguments. This can evolve during the session or across sessions with a single user or group of users and can be related to the site owner for suggestions or approvals of content experiences or paths that might lead to engagement or conversion goals of interest.

It is also possible to allow the users (not the owner of designer) to directly modify their content/experience. By allowing users to interact with chatbot 2302 they would have the ability to make requests and ask information about a particular site or site element/content. The AI agent could then use this information to dynamically modify or navigate the site in a way that is organic and tailored to this particular user's needs and preferences for engagement (e.g., browser vs. a search vs. an explorer etc.). This process can also happen automatically by observing user behavior in real time. The system could learn and adapt to how a user browses a website (or application), and with enough users also learn the most common things these users need to do. Dynamically reshaping a page to suit these needs not only would make the user experience drastically more efficient, but may negate the need for any UI/UX humans. By allowing the UX workflow to be generated by a model after observing ongoing usage patterns, novel new architectures and design patterns can emerge. Experts, users, designer and engineer feedback maybe collected and implemented as feedback loops to improve model results.

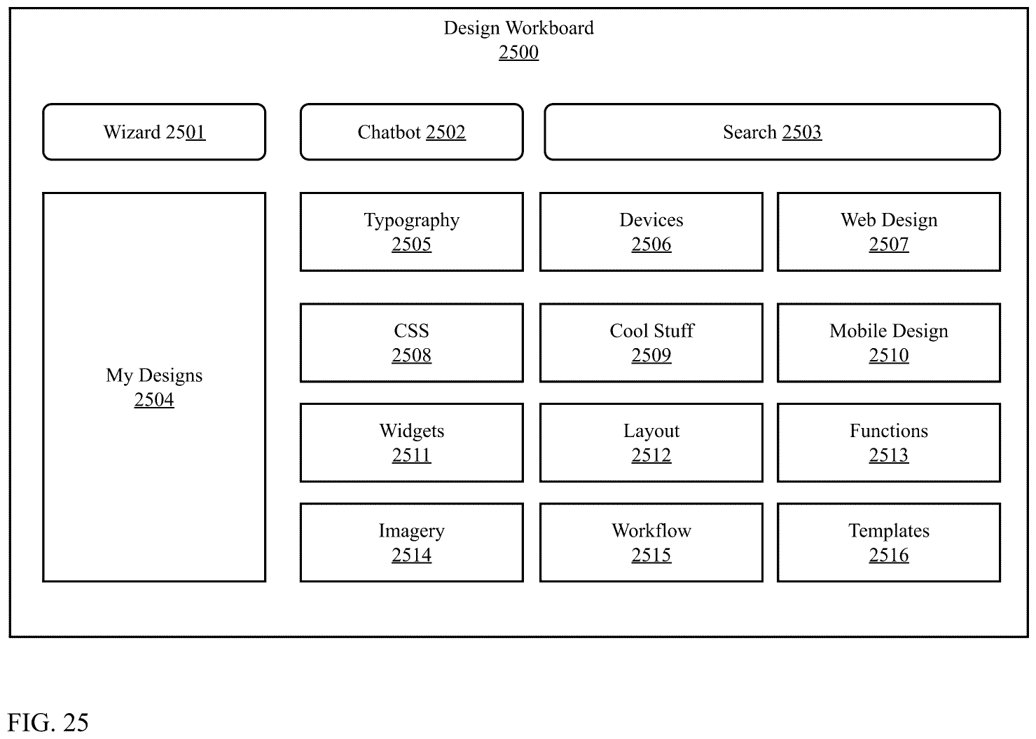

FIG. 25 is a block diagram illustrating an exemplary design workboard 2500 which may be implemented by dynamic application experience generation platform, according to an aspect. A design portal and design library may be integrated to provide the user with graphic user interface in which they can browse, search, and preview a plurality of templates and design elements. According to the aspect, designers can access wizard 2501 or chatbot 2502 to assist them with the design process and to construct a user specification. A search bar 2503 is present which allows designers to search for templates and/or design elements. For example, a designer may conduct a search for templates related to health and fitness websites/applications. As another example, the designer could search for a specific design element such as accordion menus. The workboard may obtain the display and/or search results from design catalogue database. A search may be performed on all available design elements/templates. A search may be performed within a specific category 2504-2516 of design elements/templates.

A shown, workboard 2500 may display various templates and design elements 2505-2516. Additionally, workboard 2500 can display a designer's previous or in-progress designs 2504 allowing the designer to use previous designs as a starting point for new or updated content. Examples of design elements which may be displayed on workboard 2500 can include, but are not limited to, typography 2505, devices 2506 (e.g., device-specific design elements/templates), web design 2507 (e.g., templates of different categories of websites), CSS 2508 (e.g., templates of different CSS designs), cool stuff 2509 (which may be a user curated list of design elements/templates the user has “liked”, “tagged”, or otherwise indicated that they would like to add the content to their curated list), mobile design 2510 (e.g., templates of mobile device applications), widgets 2511, layout 2512, functions 2513 (e.g., different functionality provided by various websites), imagery 2514 (e.g., types of images displayed in UX/UI content), workflow 2515 (e.g., examples of different types of workflows), and templates 2516 which may comprise all available templates.

In some implementations, user behavior during and interactions with design workboard 2500 may be monitored and collected by platform 2200 and used to improve one or more systems and functionalities provided by platform 2200. For example, user design preferences may be inferred by a ML/AI model based on user behavior and interactions with workboard components such as user clicks, hover time, search queries, liked/tagged content, and/or the like.

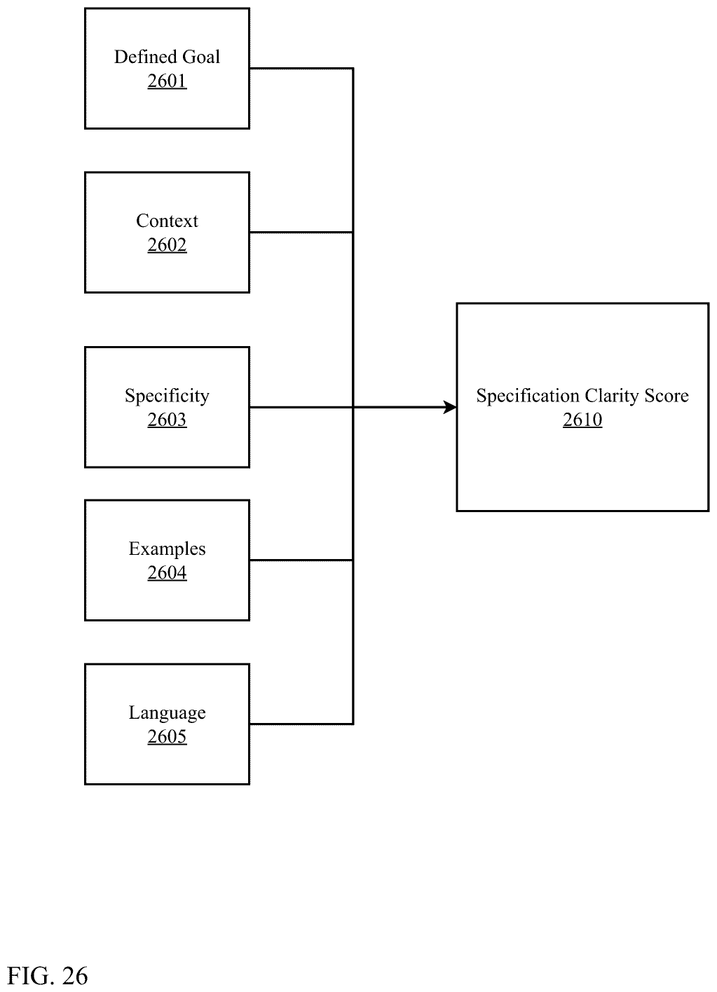

FIG. 26 is a block diagram illustrating exemplary clarity factors which may be used for determining a clarity score 2610 associated with a user specification for UX/UI content, according to an aspect. The user in this case is a website/application owner and/or designer. According to the aspect of the embodiment, a design clarification subsystem 2206 may compute a specification clarity score 2610 based on multiple factors including but not limited to, one or more defined goals 2601, specific context 2602, a level of specificity 2603, available examples 2604, and the user's natural language 2605. A general approach to crafting a prompt for Gen AI system may involve obtaining a clearly defined goal of the prompt, or in other words, what the user wants the Gen AI system to generate. This could be a text description, a piece of code, an image, or any other type of content. Generally, the user specification is directed to the goal of generating UX/UI content for a website/application. If the user's goal is not clearly defined, then the Gen AI systems may produce output which is not relevant to the user's use case. Another scoring factor involves the use of specific context 2602 which can provide relevant context to help the Gen AI system understand the task. This could be background information, constraints, or requirements. Specific context may further comprise user preferences. Some of the user preferences may allow selectable user privacy sharing of cookies and user released data that enables contextual ads and other services where valuable to user experience. For example, a user (website visitor) might get faster page loads or more downloads or content access for limited profile “unmasking: when they directly visit a website/application or a user's digital doppelganger does.

Another scoring factor can include the level of specificity 2603 of the user specification. The user should be as specific as possible about what they want the Gen AI system to generate. A check may be made for ambiguous or vague language that could lead to unexpected results. For example, the use of ambiguous or vague language may result in a lower clarity score. A chatbot may be configured to ask clarifying questions if a user response to a chatbot inquiry is vague or overly technical.

If possible, the user specification can include examples 2604 of the desired output to give to the Gen AI systems a clear reference point. For example, a user selected template or design elements from the catalogue of templates/design elements can be used as an example for the Gen AI systems. Additionally, the language 2605 of the user specification may be evaluated as a component of the clarity score. When crafting a prompt, it is important to use natural language that is easy for the Gen AI systems to understand. The inclusion of unnecessary complex or technical language may result in a reduced clarity score.

In some implementations, the clarity score 2610 may be based on aggregated scores assigned to each of multiple scoring factors. In some implementations, each scoring factor may be assigned a weight or some other coefficient value which determine the relative importance of each factor in calculating the total clarity score. For example, if the defined goals factor 2601 has a score of eight and a weight of 0.3, the weighted score for the defined goals factor is 8*0.3=2.4. Each of these weighted scores may be added up for all factors to yield the total clarity score. Incorporating weights allows the system to emphasize certain factors over others based on their importance in the overall scoring system. Importance may be determined in various ways. Factors with higher weights contribute more to the total score, while factors with lower weights have less influence. A first way may be user defined importance which is communicated by the user to the system via wizard 2301 or chatbot 2302. Another way to determine importance may be by observing user behavior when interacting with the system and the generated content to infer and/or derive the importance of one or more factors based on user behavior.

According to an aspect, after generating output from the one or more Gen AI systems, the system reviews the results and may refine the prompt and/or clarity score if needed. Iterating on the prompt can help improve the quality of the output.

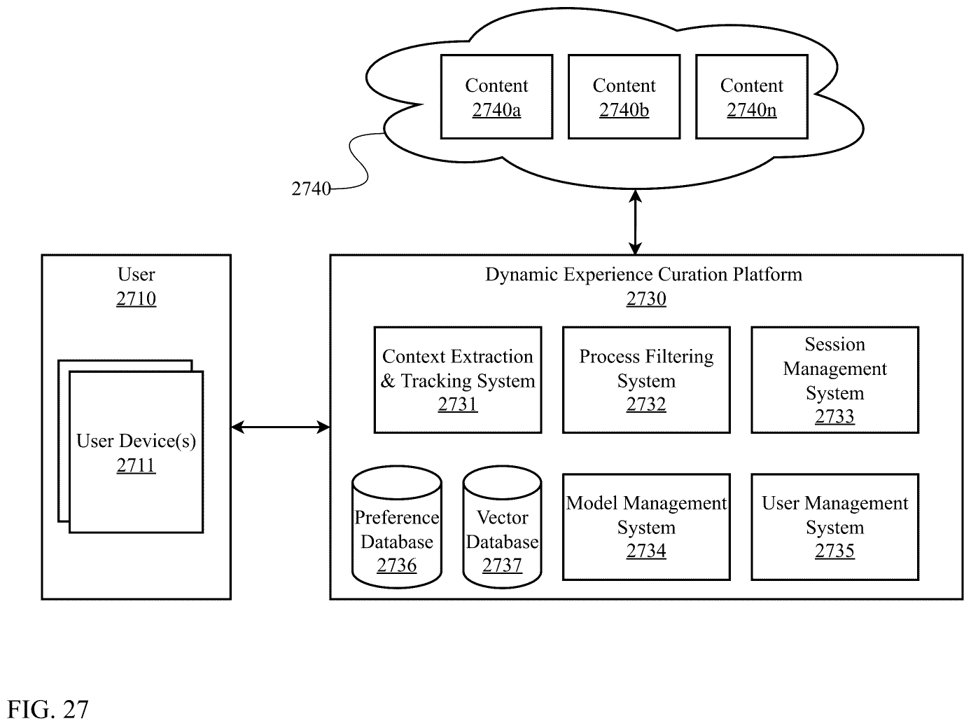

FIG. 27 is a block diagram illustrating an exemplary system architecture of a dynamic experience curation platform, according to an embodiment. According to an aspect, one productive use of the powerful artificial intelligence (AI) and machine learning (ML) techniques including neural networks, generative adversarial networks, large language models (LLMs), and the like is to rapidly process and classify or categorize information. According to an aspect, user-operated devices 2711 or applications may access curated experiences via an Experience Broker (EB) service provided by dynamic experience curation platform 2730, which can disintermediate one or more user devices or applications from the Internet and may enhance the user experience while improving security of data while the user engages with services and content 2740a-n via the Internet 2740. This may also enable better cross-device and platform synchronization and workflows.

In a preferred embodiment, consider first current common user experiences such as normal browsing, online shopping, news, and social media. In these cases, the Experience Broker (which could be on the device, across multiple devices, or on a server or container separate from the user device(s)) engages in browsing the actual content. This content may then be rendered (e.g. could be in a headless browser that emulates a user and renders JS (JavaScript) for single page applications and basic web pages), and relevant content may be extracted from the rendered content. In some implementations, the raw, extract content may be sent to a content administration AI which can perform tasks including content filtering, content categorization and tagging, content summarization, content adaption, content linking and enrichment, content personalization, and content moderation. The extracted content, which may or may not have been processed by the content administration AI, can then be passed into a Gen AI process filter that renders the source content into a user interface/user experience (UI/UX) that is consistent with the preferences in the recorded user preferences as defined in a declarative formalism. This is important because it enables the process facilitated by the Experience Broker to strip out superfluous or unwanted content (e.g., ads or harmful content) and to inject helpful content (e.g., accessibility, desired ads/deals, fact checks, etc.). It also potentially allows the user to avoid interacting with parts of the web that are outside of their intended scope (e.g. terms of service or privacy/not allowed) and can seamlessly direct (both with user notice and silently) to alternative content that is similar to the requested content but remains within the overall constraint set. This might mean the same item for purchase online but at a store that accepts Amazon Pay or Shop Pay vs PayPal/Venmo or a site that has a return policy or privacy policy consistent with desires. In some implementations, sites can create a robots.txt type file which could provide some clarification or guidance on the content or its structure. Users could choose to abide or ignore this. Its contents could include additional references, requests not to filter components, suggested filtering via rating system (PG-13 style) or other metadata/suggestion.

One benefit of content extraction followed by new curated generation, according to an aspect, is that it also allows the service or user to consider how much “reconstruction” to do. An originalist configuration or setting might preserve all photos and text from the original listing, while allowing curated augmentation. A more aggressive setting might be configured to dynamically modify the images to reflect the size of the user and replace the model with the user's likeness. This can enable more seamless shopping and analysis experiences for the user when desired or enable accurate “historical” exploration of content if so desired. This could be context specific and automated as well (for example, “shop for me but learn about historical events as they occurred”).

Specialized content generation tools may be selected during the content generation phase based on the classification of the content (or segments of the content) identified during the extraction and classification elements which are passed to the generation phase of the curated content process. This information can be used to run different models in generation—that might be responsive for various licensing, cost, specialization, efficiency, timeliness, and other objectives.

According to an aspect, the same process may also be used to change the location of content generation and hosting. For example, the processes outlined herein may impact content delivery networks (CDNs) commonly used today for security and availability considerations (e.g., time to load, DDOS prevention/absorption); accordingly, it may be desirable for the content extraction, generation, or hosting to be distributed across at least one point-of-presence (POP) during the process. This may be done again based on a multitude of factors that include inputs from the content owner, the content itself, user preferences, timeliness, costs, CDN status, and any other relevant factors. This may be even more important in cases where the user is responsible for the costs of compute time/cycles/effort associated with their curated experience at the individual level or at some aggregation of users (e.g., an organization or company). For example, an enterprise may choose to have an Experience Broker on AWS or Google based on other corporate workloads and pricing. This may have advantages or disadvantages for select actions on the Web. With an open standard, it is possible to distribute such actions intelligently across federated CDNs or devices. Since this enables the system, in one preferred embodiment of the invention, to leverage a domain-specific declarative formalism for compute, transport and storage locality with resource, transformation, and content localities, users can control economic, legal, content, and provider (i.e., digital supply chain) preferences in a reproducible and auditable fashion.

According to an embodiment, location of collection could also be distributed to identify and account for any local filtering by nation state. The same internet search executed in multiple countries won't necessarily return the same set of content.

Extending user sessions based on workstreams across multiple devices (that may not be collocated) may also be advantageous, according to an aspect. While basic browser synchronization methods offered by CHROME or SAFARI offer to synchronize bookmarks, history, and some preferences, they lack sophistication for power users. Ongoing push updates to devices can enable individual user or team based user groups to remain in improved control across multiple devices and media. This is heightened in practice because even the same website could be declaratively “generated” during the content transformation process. Since user preferences declared across devices can then consume the raw core information content (e.g., text, image, sound), it can be contextualized based on the appropriate device-specific sensory engagement modalities. For example, a shopping website might look like today's common experience (e.g., Lululemon on Shopify) on web but appear as a dynamically generated native application on a mobile device (i.e., not a mobile web browsing experience with JS/CSS) and a fully immersive “VR fitting room” on a VR/AR headset. This kind of translation where the user's engagement (e.g., with a specific product) can seamlessly begin on a laptop for research, see a virtual fitting/test it out in a metaverse space (e.g., mock nightclub outfit check), and then purchase on mobile or wearable device enroute to work is a compelling future cross platform experience and engagement model.

In a preferred embodiment of the invention, the range of personalization to standardization would lie on a spectrum with intermediate states being a superposition of multiple systems. A particular user would have a particular set of preferences and configuration they apply to all content they consume. This configuration would then be taken into account with the (for example) corporate content filter which has rules that may supersede preferences set by the user. This would allow the organization to define broad rules and preferences, with the user's settings then fine-tuning them and presenting content in a form best consumed by the user. This personal content filter is an operator the user can access and integrate with from anywhere, meaning the way they experience information and content has consistency regardless of the specific method of access (e.g., phone, work laptop, augmented reality/virtual reality set). Note that these preference filters can be stored and shared and hierarchically nested, for example the NSFW corporate filter could limit a personal filter that would be subordinate at work or on work computers/internet access but the personal filter might be primary (no work filter applies) at the user's home computer/address. With the use of virtual machines (or solutions like isolated OS containers) this kind of split personalization may be contemporaneously active on devices (e.g., a BYOD laptop for an at home worker). This could also be achieved with virtual machines.

Extending these concepts to more specific applications versus general web activities requires additional domain specific configuration and/or learning. For example, preferences and rules may be established not only for how content or experiences are provided to a user, but also what the user is allowed to do, and how user actions are to be interpreted. For example, in a gaming scenario user curated user experiences could include a degree of realism of video or audio content, in some sense dictated by the hardware and software through which it will be rendered to the user but also in terms of preferences and/or rules that may be provided by the user or others (or required in certain regulatory regions or certain contexts). For example, the degree of realism of in-game violence can be curated; the acoustic range (both in frequency and amplitude) could be automatically adjusted based on a combination of users' medical conditions, surroundings (quieter in public places), time of day, psychological condition of the user, and so forth. The EB may also perform real-time language translation not just as a literal conversion, but by taking into account the intent and style of the original speech or text and how it could be relayed in a preferred language, and/or from a particular region, culture, or style. As another example of how the Experience Broker service could be more of an dynamic user experience curation platform, responses by an LLM to user queries may be edited after generation by the curation platform to adopt a more historically important style (e.g., if the user is immersed in Edwardian England or the French Resistance in 1942 or the battlefields of Stalingrad, text style and content may be curated to more closely fit into the milieu—while still adhering to relevant regulatory issues based for example of the age of each user).

Additional curation possibilities will be appreciated according to various aspects for special content types (e.g., art, books, movies, music)—especially where there are particular standards, codecs, etc. that better enable their common utilization across diverse hardware providers already. As an example, a variety of codecs are provided under the DivX standard that are suitable for different devices and settings; this idea can be generalized and extended with dynamic user experience curation platform 130 so that any content or capability can be curated both in terms of how it is presented but also in terms of what and when it is presented, what options are provided to users and how user actions are given effect, and so forth. As another example, in a gaming environment that includes strong haptic feedback (for example, motion platforms and vibration generators in racing or flight simulators may be “curated” by limiting the range of certain actions based on user preferences, medical needs, insurance regulations, and so forth).

Extending these concepts to more specific applications versus general web activities requires additional domain specific configuration and/or learning. For example, preferences and rules may be established not only for how content or experiences are provided to a user, but also what the user is allowed to do, and how user actions are to be interpreted. For example, in a gaming scenario user curated user experiences could include a degree of realism of video or audio content, in some sense dictated by the hardware and software through which it will be rendered to the user but also in terms of preferences and/or rules that may be provided by the user or others (or required in certain regulatory regions or certain contexts). For example, the degree of realism of in-game violence can be curated; the acoustic range (both in frequency and amplitude) could be automatically adjusted based on a combination of users' medical conditions, surroundings (quieter in public places), time of day, psychological condition of the user, and so forth.

Many enhancements and extensions of the dynamic user experience curation platform are envisioned by the inventors. For example, if users are given, through experience curation, the ability to live in a specific bubble more convincingly, then how can a user know or perceive that there is a bubble, and how can users tune the platform to minimize the existence of bubbles? For example, in a manner analogous to how LLMs do not always provide the “most likely next response”—because to do so would give wooden and non-natural sounding results—the curation platform may allow users to specify or influence how “hard” their bubble is. That is, should no viewpoints known to be adverse to a user's strongly stated (in word or in action) preferences be provided in the user experiences by the curation platform (a very hard bubble), or should only a slight bias toward “in line with my views” inputs be used, possibly regulated by a fact-based reputation score (e.g., “I want to be exposed to factually reliable, and not too extreme liberal/conservative/globalist/nativist views or content almost as much as I am to my more natural stuff.”). This kind of approach could be offered for state- or country-level filters on content to avoid breaking laws. It can also improve content filtering for children with “child lock” content safety bumpers. For example, the platform could ensure that users in Russia are not exposed to legal risk by viewing materials disparaging the Soviet Union's actions in World War 2, while users in Poland would get quite a different treatment—consider simply the hot button issue of “Katyn Forest 1940” to imagine how differently the curation platform will perform for Russian and Polish users (and of course many other types of users, and not only based on nationality or religious viewpoint, but many other factors such as sex, military orientation/experience, knowledge level of relevant history, degree of engagement with issues such as Soviet imperialism, Russian/Polish hostility, antisemitism, and so forth).

According to some aspects, dynamic experience curation platform 130 may be implemented as a single integrated platform computer system where all computing resources, including hardware, software, and data, are centralized and managed within a single physical or virtual environment. In this arrangement, there is typically one central processing unit (CPU), memory, storage, and other resources that serve all computing needs. In other aspects, dynamic experience curation platform 130 may be implemented as a distributed platform where computing resources are distributed across multiple interconnected computers or nodes, often geographically dispersed. In a distributed platform, each node can have its own CPU, memory, storage, and other resources, and they work together to achieve to provide content curation for platform users.

According to the embodiment, dynamic experience curation platform 2730 comprises various components which support and provide capabilities directed to experience curation for platform users 2710. A user management system 2735 is present and configured to provide a portal for each user to create and manage their own user profile. A user profile may be created and stored in a preference database 2736. The user profile may comprise information associated with the user including, but not limited to, user contact information (e.g., name, email address, address, IP address, etc.), demographic information (e.g., age, ethnicity, political party, etc.), login information (e.g., username and password), and a plurality of preferences. A user 2710 may provide this information and their preferences via user management system 2735. A user 2710 may provide this information to platform 2730 via a website or web application accessible via an appropriate Internet browser operating on a user device 2711 or by using a mobile device experience curation software application (App) to access platform 2730. A user 2710 may have multiple user devices 2711 which can be used to access the platform and received curated content. For example, a user 2710 may have a work computer, a personal computer or laptop, a mobile device (e.g., smart phone or tablet), a smart wearable device, and/or virtual reality/augmented reality (VR/AR) headsets.

According to the embodiment, a user 2710 can submit a content request to dynamic experience curation platform 2730 to access some type of content 2740a, 2740b, 2740n accessible via the Internet 2740. A context extraction and tracking system 2731 is present and configured to receive the content request from a user device 2711, format the request and submit it to the service provider/content provider on the user's behalf, receive un-curated content from the service provider/content provider, and extract and classify relevant content from the received un-curated content. Additionally, context extraction and tracking system 2731 may receive device context or state data such as, for example, device type, operating system, device model, screen resolution, IP address, browser type and version, cookies, device ID, sensor data, location data, battery level, metadata from file, and/or the like. In some implementations, the extracted and classified content data and/or device context data may be stored in a database (e.g., preference database 2736). Context extraction and tracking system 2731 may send classified content and context data to a process filtering system 2732. According to some embodiments, context extraction and tracking system 2731 may be configured to obtain user interaction and/or feedback data associated with a user's curated experience. This information may be stored in a user profile and used for model training purposes and/or other platform 2730 applications.

According to the embodiment, a process filtering system 2732 is present and configured to obtain a plurality of information comprising at least user preference data, classified content, and context data and to use the obtained plurality of information as an inputs to create one or more filters which can be used to curate the user's experience when browsing the web. Process filtering system 2732 can receive this information and utilize the one or more filters to render the user-requested content in a UI/UX on the user device 2711. In some implementations, the filters may be rule-based, Gen AI/ML based, or some combination thereof.

According to some embodiments, process filtering system 2732 may be configured to filter out AI generated content explicitly tagged via frameworks (e.g., Coalition for Content Provenance and Authenticity) or based on real-time analysis of the media (request content) returned. For example, there may be rules/preferences which cause process filtering system 2732 to “Filter out media that scores over 85% on an ‘AI generated score chart’”. This may be implemented by integrating with a content registry of AI generated content.

Platform 2730 may implement various Gen AI content filtering processes including, but not limited to, content failing to meet a score which is computed on content classification, content comparisons to external registries, content comparisons to knowledge bases (i.e., truthfulness against authoritative sources), presence of select material based on user settings and context (e.g., NSFW, racist/sexist, illegal content), safety and risk scoring (e.g., systems with a high cyber security threat score, potential phishing content), and content that is not appropriately “signed”. Similar to how website certs can confirm ownership through digital signature verification, the system may be able to filter content based on where all the parts of the content have been “signed” by the correct author. For example, filter out all parts of “XYZ” news site that has not been digitally signed by XYZ Inc. System or user defined processing of content can enable things such as: content replacement with description of content and why it is not being shown w/option to show anyway; FPO media placement notice with or without description but no explanation; alternative content that is similar in meaning/content but scores high enough and doesn't trip any “red line” settings (e.g. illegal or work specific policies); a “carousel” of related content (similar to a Pinterest page) of potential alternatives/related sources/content that the user can select from to help refine their ongoing media filter/replacement guidelines. This subsystem routine can then be used as a semi-supervised ML process to help w/ongoing refinement of content replacement/filters unique to the user.

In some implementations, curated content may comprise accessibility overlays such as, for example, text-to-speech conversion, a screen reader, alternative control/input methods, magnification and zoom, color contrast adjustment, captions and transcripts, sign language interpretation, keyboard navigation, voice control, simplified content layout, readability enhancements, visual cues and notifications, haptic feedback, and easy language and symbol support. This can improve the experience for users with disabilities when they access and engage with digital content.

A model management system 2734 is present and configured to obtain, train, and/or maintain one or more Gen AI or ML models which may be used by process filtering system 2732 to generate curated content on a user device 2711, according to an embodiment. For the use case directed to curating a user's experience with the Internet there are several types of Gen AI systems that could be used to curate and render content on a custom web page (or some other type of representation such as a mobile app render, an AR/VR environment, etc.). One or many possible examples can include a conditional image generation system which generates images based on conditional inputs such as, for example, generating different versions of a product image based on user preferences. As another example, while not strictly generative, recommender systems can dynamically curate content for a web page based on user preferences and behavior.

In some implementations, the Gen AI models may be configured to operate with Retrieval Augmented Generation (RAG) components. Adding a retrieval augmented generation (RAG) component to the Gen AI models can significantly benefit the experience curation platform in several ways. RAG allows the AI models to retrieve and incorporate relevant information from external knowledge sources, such as databases or documents, during the content generation process. This ensures that the generated content is more accurate, up-to-date, and relevant to the user's context and preferences. By leveraging a wide range of external knowledge sources, RAG can help the AI models generate more diverse and creative content. This can lead to a more engaging and interesting user experience, as the platform can offer a broader range of perspectives, ideas, and recommendations. RAG can help streamline the content generation process by allowing the AI models to quickly locate and extract relevant information from external sources, rather than relying solely on their internal knowledge representation. This can result in faster content generation and curation, enabling the platform to serve users more efficiently. RAG can be particularly beneficial when dealing with niche or highly specific topics that may not be well-represented in the AI models' training data. By retrieving information from specialized knowledge sources, the platform can provide more accurate and comprehensive content on these topics. With RAG, the AI models can incorporate information from external sources that may not have been part of their initial training data. This reduces the platform's reliance on extensive and constantly updated training datasets, making it more scalable and adaptable to new content domains. By retrieving information from user-specific knowledge sources, such as personal documents or preferences, RAG can enable the platform to generate highly personalized content tailored to each user's unique needs and interests.

According to the embodiment, a session management system 2733 may be configured to support a user's curated experience between and across multiple user devices 2711. Session management systems 2733 may manage a user session across multiple devices. In some implementations, this may comprise steps involving assigning a unique user identifier (ID) (e.g., username, email address, or generated ID, etc.) to identify the user consistently across devices and sessions; generating a session token (e.g., JSON web token or session ID) when the user logs in or starts a session (e.g., submits a request for content), which may be stored on the client-side (e.g., in cookies or local storage) and sent with each request to identify the session; keeping track of session state and store relevant information such as user ID, session token, device information/state, and session timing data (state and expiration); providing cross-device synchronization which may involve updating session state whenever it changes on one device and propagating those changes to the other devices; and implementing session expiration to ensure sessions are not kept open indefinitely. Furthermore, session management system 2733 may implement secure communication protocols (e.g., HTTPS) to protect session tokens from being intercepted. Additional security measures such as device verification or multi-factor authentication may be implemented, according to some embodiments. User's may be given control over their sessions such as the ability to log out from devices 2711 or revoke access to certain devices.

In some implementations, session management system 2733 can be configured to provide functionality for seamlessly transitioning user engagement and content across different devices, such as from a laptop to a virtual reality/augmented reality (VR/AR) device, or from a desktop computer to a television, and/or the like. When a user switches devices, the system generates an event that triggers a process. According to an aspect, the process may begin by obtaining the current state of user engagement and content on the first device. The nature and characteristics of the second device are determined in relation to the same content. If necessary, additional content is requested from content providers to generate an equivalent or enhanced workflow based on the capabilities of the new device (e.g., 3D capabilities of VisionPro, 8K display on a television, etc.). The additional content can be fed into a classification model to extract and classify relevant information. User preference data is retrieved. A prompt is engineered using the outputs from the classification tasks performed on both devices and the user preference data. The prompt and content elements are submitted to Gen AI models. The output of the Gen AI models is rendered on the user interface of the second device as curated content responsive to the content request.

Additionally, ongoing user engagement with a device like VisionPro can be reinterpreted and broadcast for other mediums and devices, such as televisions or monitors. That is, the content generated on the second device may be re-curated and rendered on a third, fourth, etc. device. For example, consider screen sharing for local audiences such as watching a VR player in a racing sim at home on a television screen. As another example, consider an eSports broadcast on a streaming platform (e.g., Twitch) wherein curation platform 2730 can reinterpret what is happening on the stream with additional, curated content and/or context on or across multiple devices.

A user switching devices is a simple example of a triggering event for such a cross-device content transitioning, such as moving from a laptop to a VR/AR device, or vice versa. However, there could be other potential triggering events within the context of the described experience curation platform including, but not limited to, user login and authentication on a new device; user initiating a new task or workflow on the current device; user pausing or saving their progress on one device; scheduled to time-based events (e.g., a daily content update); location-based events (e.g., user moving from home to office); user preferences or settings; system detecting a change in user behavior or engagement patterns; external triggers from third-party services or platforms (e.g., receiving a notification or message); device battery level reaching a certain threshold; network connectivity changes (e.g., switch from Wi-Fi to cellular data). These triggering events could prompt the system to reevaluate the user's context, preferences, and device capabilities to curate and render the most appropriate content for the user's current situation.

According to the embodiment, one or more databases may be present and configured to store a plurality of information obtained from various sources such as users 2710, user devices 2711, and service providers and content providers 2740a-n accessible through a communication network such as the Internet 2740. Some exemplary databases that may be implemented in some embodiments include, but are not limited to, relational databases, key-value stores, document databases, graph databases, vector databases, time-series databases, and column-family stores, to name a few.

A preference database 2736 is present and configured to store a user profile and a plurality of user preferences which may be explicitly defined/declared by the user and/or implicitly learned/derived from user behavior and interactions. Preference database 2736 may also store rules or policies or other legal considerations which may be applicable to a user and/or requested content based on preferences, location, age, or any other constraint. These rules/legal considerations may be set forth by a company (e.g., corporate policy on what type of content employees are allowed to access or share) or a government/regulatory entity (e.g., local, state, or national laws) or some other type or authority. For example, parents could create a filter for their children which curates content to remove NSFW or explicit material and which also formats the content so that it is at the appropriate reading level for the child.

According to the embodiment, a vector database 2737 is present and configured to store a plurality of embedded data (i.e., vectors) comprising at least one or more of content requests, un-curated content, extracted and classified content, curated content, device context, and user preferences. A vector database stores vectors, which are mathematical representations of data points in a multi-dimensional space. Each vector typically represents a feature or an entity, and the database is optimized for storing, querying, and manipulating these vectors efficiently. The information stored in vector database 2737 may be leveraged by platform 2730 for use in machine learning, data mining, content extraction and classification, and similarity search processes. Each vector may be associated with a unique identifier and can be of fixed or variable length.

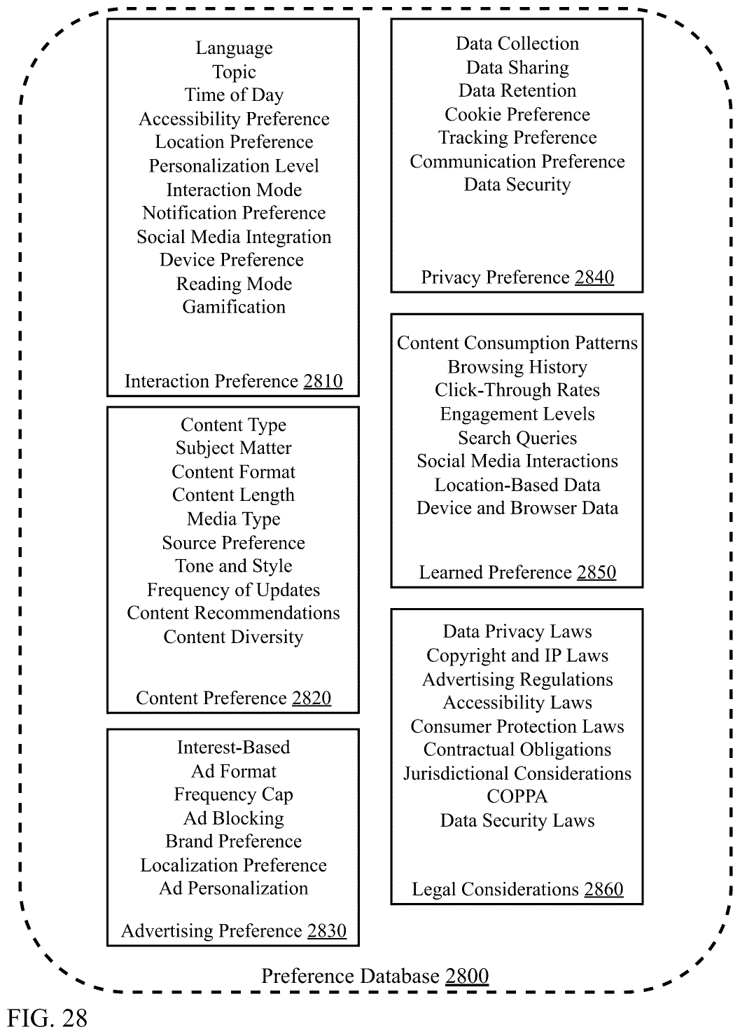

FIG. 28 is a block diagram illustrating an exemplary aspect of a dynamic experience curation platform, a preference database 2800. According to the aspect, preference database 2800 may be stored in local storage on a user device 2711, in a centralized data storage system (e.g., corporate server), in a cloud-based storage provided by platform 2730, or distributed between these or other storage systems. According to the aspect, preference database 2800 may be configured to store a plurality of user preference data 2810-2860. The user preference data may be received, retrieved, or otherwise obtained from a user 2710 and/or their user device(s) 2711. For example, during an initial interaction/registration with dynamic experience curation platform 2730 a user can submit preferences during creation of their user profile. In some aspects, the user may be able to submit preferences in the form of a questionnaire and/or survey which may be text-based (e.g., question and response) or interactive with a generated voice which asks the user questions and the user can speak their response or may be gamified so that the user can submit preferences in a manner which resembles a game (e.g., on a touch screen enabled device using a finger to drag a preference from a list of preferences across the screen and “drop” it into a preference category bucket). Some preferences may be learned, inferred, or otherwise derived by platform 2730 by analyzing at least user behavior and session state data.

According to the aspect, preference database 2800 may store a plurality of user interaction preferences 2810. The illustration provides some exemplary (non-limiting) interaction preferences. Users may prefer content in a specific language. This preference can be used to show content in the user's preferred language when available. Users may be interested in specific topics, such as technology, sports, or fashion. This preference can be used to show content related to the user's preferred topics. Users may have different preferences for content based on the time of day. For example, they may prefer news content in the morning and entertainment content in the evening. Users may have accessibility preferences, such as preferring high contrast or larger fonts. These preferences can be used to render content in a way that is more accessible to the user. Users may have preferences based on their location, such as local news or events. This preference can be used to show content relevant to the user's location. Users may have preferences for how personalized they want their content to be. Some users may prefer highly personalized content, while others may prefer less personalized content. Users may prefer different interaction modes, such as touch, voice, or keyboard input. This preference can be used to provide alternative interaction methods for users with different preferences or accessibility needs. Users may have preferences for receiving notifications, such as email alerts or push notifications. This preference can be used to determine how and when to notify the user about new content or updates. Users may have preferences for integrating social media content, such as displaying their social media feeds or sharing content on social media platforms. This preference can be used to customize a rendered web page's social media integration features. Users may prefer viewing content on specific devices, such as smartphones, tablets, smart wearables, AR/VR devices, or desktop computers. This preference can be used to optimize the layout and design of the rendered content for the user's preferred device. Users may have preferences for reading modes, such as light or dark mode, or preferences for font styles and sizes. This preference can be used to customize the rendered content's appearance to match the user's reading preferences. Users may have preferences for gamification elements, such as badges, rewards, or leaderboards. This preference can be used to incorporate gamification elements into the rendered content to enhance user experience and engagement.

According to the aspect, preference database 2800 may store a plurality of user content preferences 2820. The illustration provides some exemplary (non-limiting) content preferences. Users may prefer certain types of content, such as articles, videos, or images. This preference can be used to prioritize the display of the user's preferred content type. Users may have preferences for specific topics or subjects, such as technology, politics, sports, or entertainment. Content related to these topics can be prioritized for the user. Users may prefer certain content formats, such as articles, videos, podcasts, or infographics. The web page can prioritize displaying content in the user's preferred format. Users may prefer shorter or longer content based on their reading habits and time constraints. The platform 2730 can adjust the length of content displayed based on the user's preference. Users may prefer different types of media, such as images, gifs, or interactive elements. The rendered content can tailor the media displayed to match the user's preferences. Users may prefer content from specific sources or authors that they trust or enjoy. The rendered content can prioritize displaying content from these sources. Users may prefer content with a certain tone or style, such as formal, casual, humorous, or informative. The rendered content can adjust the tone and style of content displayed based on the user's preference. Users may prefer to see content that is updated frequently or prefer a more static content experience. The platform can adjust the frequency of content updates based on the user's preference. Users may prefer to receive personalized content recommendations based on their browsing history or interests. The platform can provide content recommendations tailored to the user's preferences. Users may prefer a diverse range of content or prefer to focus on a specific niche. The rendered content can adjust the diversity of content displayed based on the user's preference.

According to the aspect, preference database 2800 may store a plurality of user advertising preferences 2830. The illustration provides some exemplary (non-limiting) advertising preferences which may be used to construct one or more experience curation filters. Users may prefer to see ads that are relevant to their interests and hobbies. The filter can use browsing history or user input to tailor ads to the user's interests. Users may prefer certain ad formats, such as banner ads, native ads, or video ads. The filter can prioritize displaying ads in the user's preferred format. Users may prefer to limit the number of ads they see in a given time period. The filter can adjust the frequency of ads based on the user's preference. Users may prefer to block certain types of ads, such as pop-up ads or auto-play video ads. The filter can respect these preferences and refrain from displaying blocked ad types. Users may prefer ads from certain brands or companies that they trust or have a positive opinion of. The filter can prioritize displaying ads from these brands. Users may prefer to see ads that are relevant to their location, such as local deals or events. The filter can use geolocation data to tailor ads to the user's location. Users may have preferences for how personalized they want their ads to be. Some users may prefer highly personalized ads (e.g., generating images of the user wearing the times they are currently viewing), while others may prefer less personalized ads.

According to the aspect, preference database 2800 may store a plurality of user privacy preferences 2840. The illustration provides some exemplary (non-limiting) privacy preferences which may be used to construct one or more curation filters. Privacy preferences allow for users to control how their data is collected, used, and shared. Users may prefer to limit the collection of their personal data, such as browsing history, location data, or demographic information. The filter can respect these preferences and only collect necessary data for providing services. Users may prefer to limit the sharing of their personal data with third parties, such as advertisers or data brokers. The filter can respect these preferences and refrain from sharing user data without explicit consent. Users may prefer that their personal data is not retained for longer than necessary. The filter can respect these preferences and delete user data after a specified period or when it is no longer needed. Users may prefer to manage their cookie settings, such as accepting only necessary cookies or blocking all cookies. The filter can provide options for users to manage their cookie preferences. Users may prefer to opt out of tracking technologies, such as tracking pixels or browser fingerprinting. The filter can acknowledge these preferences and refrain from using these technologies. Users may prefer to limit the communication they receive from the web page, such as marketing emails or notifications. The filter can provide options for users to manage their communication preferences. Users may prefer that their personal data is stored and transmitted securely. The platform can use encryption and other security measures to protect user data.

According to the aspect, preference database 2800 may store a plurality of user learned preferences 2850. The illustration provides some exemplary (non-limiting) learned preferences which may be used to construct one or more curation filters. Learned or inferred preferences may be based on the analysis of user behavior, interactions/sessions, and historical data. By analyzing the types of content a user consumes regularly (e.g., articles, videos, podcasts), the platform can infer the user's preferences and recommend similar content. Analyzing the user's browsing history can reveal their interests and preferences for specific topics, which can be used to personalize content recommendations. By tracking the user's click-through rates on different types of content or ads, the platform can infer their preferences and prioritize similar content in the future. Analyzing the user's engagement levels with different types of content (e.g., time spent, interactions, cross device sessions, etc.) can help the platform infer their preferences and adjust content recommendations accordingly. Analyzing the user's search queries and/or content requests can provide insights into their interests and preferences, which can be used to customize search results and content recommendations. Analyzing the user's interactions on social media platforms (e.g., likes, shares, comments) can reveal their preferences for content and brands, which can be used to curate content. Analyzing the user's location data can provide insights into their preferences for local events, news, and services, which can be used to personalize content. Analyzing the user's device and browser data (e.g., type of device, browser history) can provide insights into their preferences for content formats and presentation styles. Analyzing the user's behavior over time (e.g., daily, weekly, seasonal patterns) can help infer their preferences for content consumption at different times, which can be used to schedule content delivery. Analyzing the user's feedback and ratings on content can provide direct insights into their preferences and help improve content curation.

According to the aspect, preference database 2800 may store a plurality of legal considerations 2860. The illustration provides some exemplary (non-limiting) legal considerations which may be used to construct one or more curation filters. Compliance with data privacy laws, such as the General Data Protection Regulation (GDPR) in Europe or the California Consumer Privacy Act (CCPA) in the United States, requires obtaining consent for data collection and processing, as well as providing users with the ability to access, correct, or delete their data. Curated content must comply with copyright and intellectual property laws. Proper attribution and permissions must be obtained for using third-party content, and the fair use doctrine must be considered. Advertisements must comply with relevant advertising regulations, such as the Federal Trade Commission (FTC) guidelines in the United States. This includes disclosing sponsored content and ensuring that advertisements are not deceptive or misleading. Web content must be accessible to individuals with disabilities, as required by laws such as the Americans with Disabilities Act (ADA) in the United States and the Web Content Accessibility Guidelines (WCAG). Curated content may make certain web content more accessible for individuals with disabilities. Curated content should not engage in deceptive or unfair practices, such as false advertising or fraudulent schemes, as prohibited by consumer protection laws. If the web page is subject to contractual agreements, such as terms of service or content licensing agreements, these obligations should be adhered to in the curation process. The legal requirements can vary depending on the jurisdiction in which the platform operates and where its users are located. Compliance with local laws and regulations may be considered during the curation process.

By incorporating these and other preferences in the content curation process, rendered content can provide a more personalized and relevant experience for the user wherein the rendered content is curated based on the preferences.

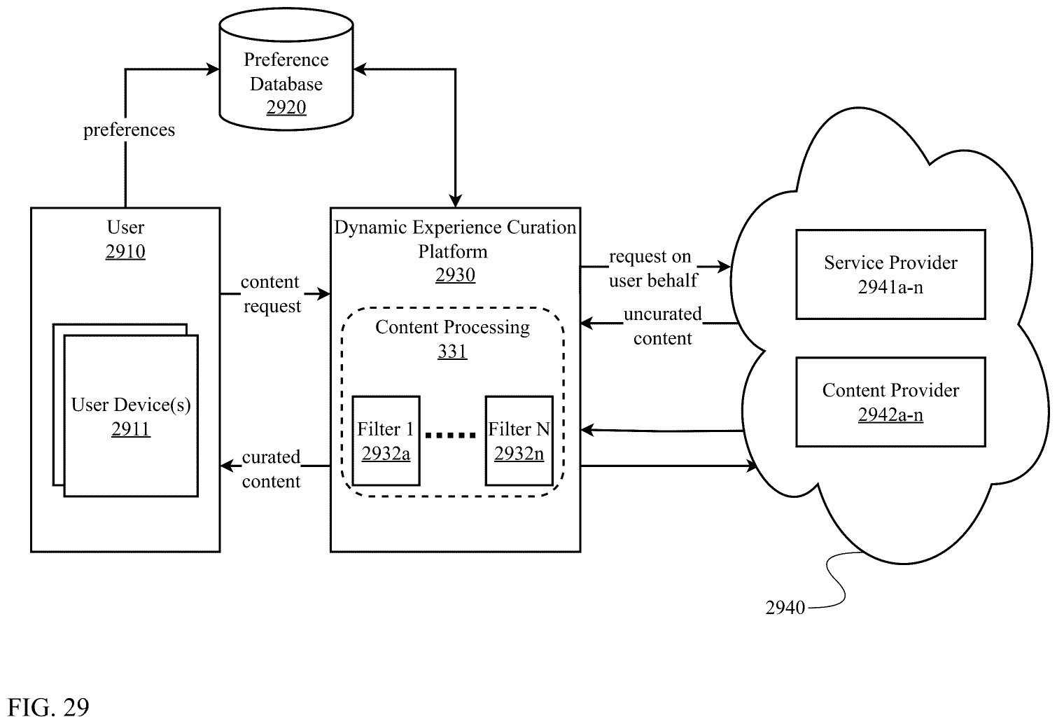

FIG. 29 is a block diagram illustrating an exemplary high-level architecture of a dynamic experience curation platform 2930 and the exchange of information among various components during dynamic experience curation, according to an aspect of an embodiment. A user 2910 can provide a plurality of user preferences which may be stored in a preference database 2920. According to the aspect, a user 2910 may access dynamic experience curation platform 2930 via a user device 2911 to submit a request for content from one or more service providers 2941a-n and/or content providers 2942a-n accessible via the Internet 2940. Platform 2930 may receive the content request and submit the request to the service provider/content provider on behalf of the user. In turn, platform 2930 receives the requested content from the service provider/content provider and processes the received, un-curated content. In some implementations, the processing 2931 of the received content may comprise extracting content and classifying the content. The processing may further comprise obtaining device context data from the user device 2911. The classified content, device context, and retrieved user preferences may be processed by one or more filters 2932a-n which can produce curated content which may be rendered on a UI/UX of the user device 2911.

According to the aspect, the filters 2932a-n can range from rule-based filters to Gen AI-based filters (e.g., based on AI/ML models). The filters may be thought of as specialized content generation tools which may be selected during the content generation phase based on the classification of the content (or segments of the content) identified during the extraction and classification process. This information may be used to run different models in generation (e.g., sequentially or in parallel) that might be responsive for various licensing, cost, specialization, efficiency, timeliness, etc. objectives.

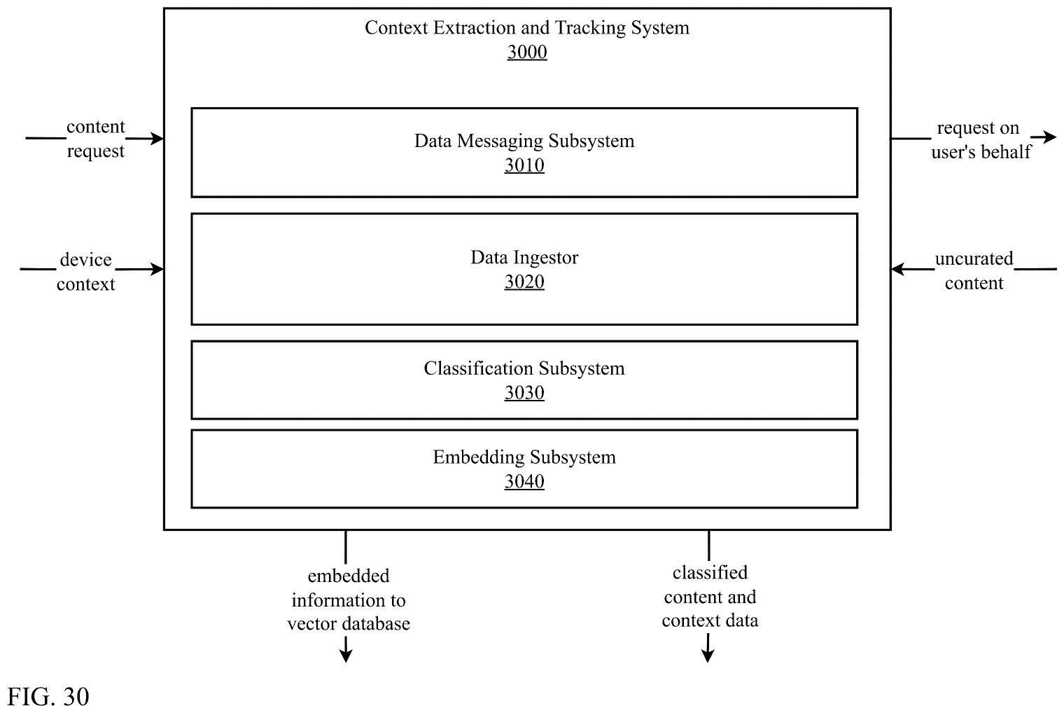

FIG. 30 is a block diagram illustrating an exemplary aspect of a dynamic experience curation platform, a context extraction and tracking system 3000. According to the aspect, context extraction and tracking system 3000 comprises a data messaging subsystem 3010 configured to receive a content request from a user, format the request into a suitable format, if applicable, and submit the content request on the user's behalf to a service provider/content provider and a data ingestor subsystem 3020 configured to receive the requested, un-curated content from the service provider/content provider. Data ingestor 3020 may also obtain device context associated with the user device the user is currently using to engage with dynamic experience curation platform 2730. Data ingestor 3020 may process the received data for storage or for processing by other system 3000 components. For example, un-curated content may be transformed into a format suitable for storage in a preference database.

Content requests directed to Internet content or services can take various forms, depending on the type of content and service being requested and the protocol being used. Data messaging subsystem 3010 can be configured to format content requests into the appropriate format/protocol for delivery to the appropriate content creator/service provider. For example, subsystem 3010 can format content requests into an HTTP request, an API request, a DNS request, an email request, and streaming request, to name a few.

According to the aspect, a classification subsystem 3030 is present and configured to process un-curated content to classify the content (or segments of the content). Classification subsystem 3030 may utilize defined categories or topics that are relevant to the user preferences and content request. For example, if a user is interested in sports, technology, and fashion, then these would be defined categories for the user. Web-scraping techniques may be used to extract content from the received content (e.g., web page). This can include text, images, and other relevant information. In some implementations, natural language processing (NLP) techniques may be used to analyze the extracted text. This could involve tasks such as keyword extraction, sentiment analysis, and named entity recognition. Classification subsystem 3030 may utilize machine and/or deep learning models to classify the content into the defined categories. This could involve model management system 2734 training a model on a labeled dataset of content that has been manually classified into the categories of interest. Next, the user preferences may be mapped to the categories. For example, if the user prefers sports content, the system can map the sports category to the user preference. Based on the classification results and the preference mapping, platform 2730 can curate the content to display on a personalized web page. This could involve prioritizing content from categories that match the user preferences and filtering out content from categories that are less relevant to the user. Context extraction and tracking system 3000 may send classified content and context data to filter processing system 2732 where the web page may be curated based on one or more preference filters.

According to the aspect, an embedding subsystem 3040 is present and configured to use one or more embedding models to vectorize various types of data obtained and analyzed by platform 2730. A user content request and device context data may be vectorized and stored in a vector database. Likewise, un-curated content and curated content may be vectorized by embedding subsystem 3040 and stored in vector database. Vectorizing data allows it to be easily processed by the various AI and deep learning models implemented by platform 2730. The embedded data may be used in various applications by platform 2730 including, but not limited to, similarity search, recommendation systems, natural language processing, and computer vision tasks. Embedding models are widely used in natural language processing (NLP), recommendation systems, and other machine learning applications to represent words, phrases, or items in a continuous vector space. Some exemplary embedding models include word embeddings (e.g., Word2Vec), sentence/document embeddings (e.g., Doc2Vec), item embeddings for recommendation systems (e.g., matrix factorization, neural collaborative filtering), graph embeddings (e.g., Node2Vec), and knowledge graph embeddings (e.g., TransE).

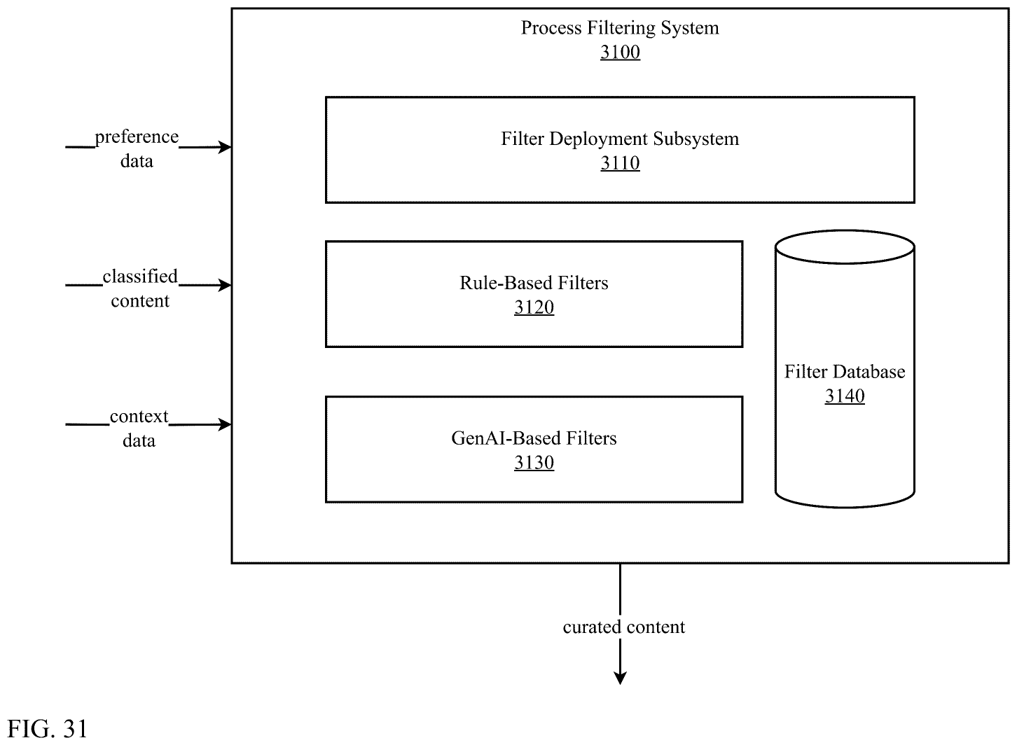

FIG. 31 is a block diagram illustrating an exemplary aspect of a dynamic experience curation platform, a process filtering system 3100. According to the aspect, process filtering system 3100 is configured to receive, retrieve, or otherwise obtain preference data, classified content, and context data and apply one or more filters based on the obtained data to declaratively generate curated content which may be rendered on the UI/UX of a user device 2711. According to the aspect, a filter deployment subsystem 3110 is present and configured to manage the selection and application of filters to the requested content to produce curated content based on the selected filters. Filter deployment subsystem 3110 may select specialized content generation tools (i.e., preference filters) during the content generation process based on the received classified content (or segments of content) identified during the extraction and classification processes. This information may be used to run different models in generation that might be more responsive to specific objectives (e.g., licensing, cost, specialization, efficiency, timeliness, etc.). These models may run in parallel or sequentially and their outputs or model results compared against each other. In such embodiments, filter deployment subsystem 3110 may select one or more model outputs to be used to curate the content.

According to various aspects, filters may be referred to as virtual cross-platform agents because they may be deployed across multiple user devices and provide a consistent user experience when engaging with content.

According to various aspects, filter deployment system 3110 may be further configured to manage the sharing and access to stored filters in a filter database 3140. A user may have multiple preference filters associated with or applicable to his or herself. For example, a user may have a personal filter, a work/corporate filter, a social filter, and a family filter (which may be applied to a child device to curate the child's experience with online media based on rules and preferences established by a parent/guardian) which may exist together simultaneously and inform the curation process. As noted before, when a user has one or more filters applicable to them, the filters may be applied to the user in a hierarchical method based on various constraints that may cause one filter to supersede another such as, for example, geographic constraints, device constraints, time constraints, legal constraints, and/or the like.

According to the aspect, the one or more filters that can be applied to the content based on the received data can include both rule-based filters 3120 and Gen AI-based filters 3130. Rule-based filters for curating content might involve setting specific criteria or rules to include or exclude content based on predefined conditions. Some exemplary rule-based filters can include, but are not limited to, keyword filters (e.g., include or exclude content based on the presence or absence of specific keywords or phrases), source filters (e.g., include or exclude content from specific sources or websites. For example, filter out content from unreliable sources or prioritize content from trusted sources.), date filters (e.g., include or exclude content based on the publication date. For example, could prioritize recent content or filter out outdated content.), topic filters (e.g., include or exclude content based on predefined topics or categories. For example, filter out content that is not relevant to user interests or prioritize content that matches specific topics.), length filters (e.g., include or exclude content based on the length of the content. For example, filter out long-form content if the user prefers shorter articles.), popularity filters (e.g., include or exclude content based on its popularity or engagement metrics. For example, prioritize content that has been shared or liked by a large number of users.), language filters (e.g., include or exclude content based on the language of the content. For example, filter out content that is not in user's preferred language.), and format filters (e.g., include or exclude content based on its format, such as text, images, videos, or interactive content. For example, filter out videos if user prefers to read articles.). These are just a few examples of rule-based filters 3120 that can be used to curate content based on predefined criteria. By setting up these filters, a user can customize the content that is displayed to match their preferences and interests.

In some implementations, filter deployment subsystem 3110 may be further configured to create a prompt to be submitted to a one or more Gen AI-based filters 3130, wherein the prompt is based on the received preference data, classified content, and device context data. The selected Gen AI-based filters 3130 may process the prompt and return as a response, curated content which can be rendered on the UI/UX of a user device 2711. There are several types of Gen AI systems that could be used to render curated content based on the prompt. Text-to-image generation systems can generate images based on textual descriptions. For example, a system could generate a visual representation of a product based on a written description. As another example, a web page displaying a story could be augmented with additional generated illustrations based on the text, which is currently being read, thereby enhancing the user experience by providing a more immersive environment for the story reader. Another exemplary Gen AI system which may be implemented is a style transfer algorithm that can be used to apply the style of one image to another. This could be used to dynamically style elements on a curated web page based on user preferences. Natural language generation systems can generate human-like text based on structured data. This could be used to dynamically generate personalized product descriptions or other textual content on a web page. As another example neuro-symbolic systems can be implemented which combine neural networks with symbolic reasoning to perform tasks that require both pattern recognition and logical reasoning. Neuro-symbolic systems could be used to dynamically generate content based on user input, preferences, and context. These are just a few examples of the types of Gen AI systems that could be used to render curated content.

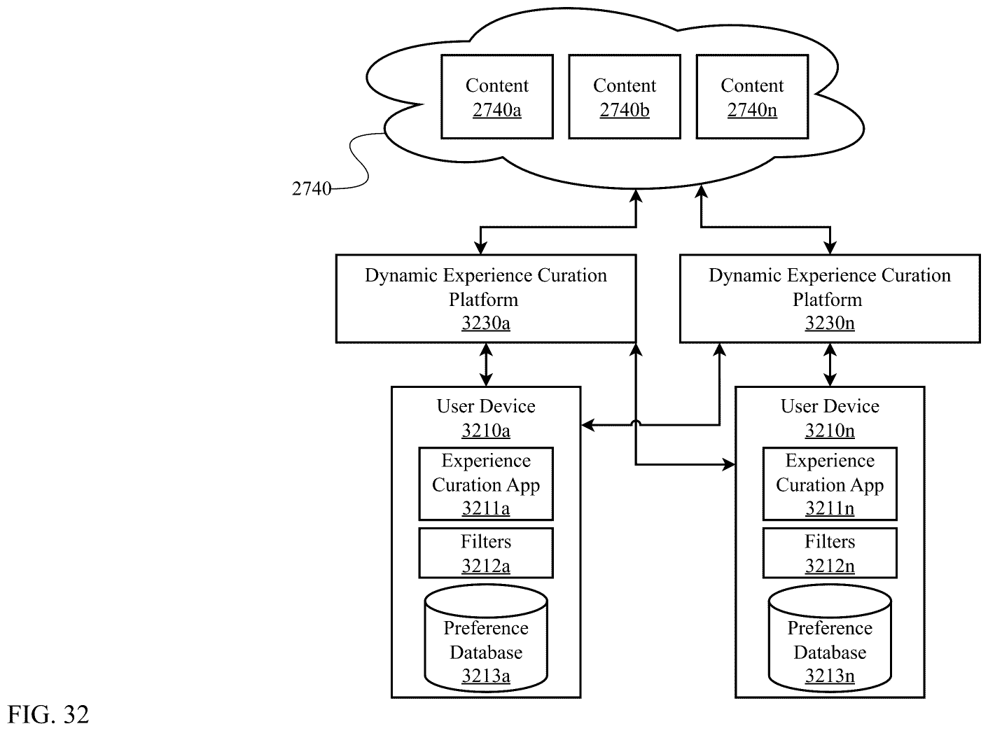

FIG. 32 is a block diagram illustrating an exemplary federated architecture of a dynamic experience curation platform, according to an aspect of an embodiment. Federation can be a powerful approach to improve or augment the curation platform system in several ways. By federating the platform, you can distribute the workload across multiple nodes or servers 3230a-n, improving scalability. This can be particularly useful when dealing with a large number of users or when the Gen AI systems require significant computational resources.

To leverage federation in the platform 3230, it may be designed to support distributed computation and communication between devices and the cloud. This may involve implementing protocols for data synchronization, model updates, and collaboration between federated nodes.

Federation can help improve privacy by allowing the AI models to operate on data (e.g., preference data 3213a-n) that remains on the user's device 3210a-n, reducing the need to send sensitive data to the cloud for processing. This can be achieved through techniques such as federated learning, where the AI models (i.e., filters 3212a-n) are trained across multiple devices without sharing raw data. Federation can enable more personalized content curation by allowing the AI models to learn from user interactions and preferences directly on the user's device. This can lead to more accurate and tailored content/recommendations over time. Additionally, by processing data and generating content closer to the user, federation can reduce latency and improve the overall user experience, especially in situations where real-time or low-latency interactions are required. Federation can enable the platform to operate offline or with limited connectivity by allowing the local AI models 3212a-n to continue generating content based on locally stored data and preferences 3213a-n.

As illustrated, a dynamic experience curation platform 3230 may be federated and deployed across a plurality of nodes 3230a-n which can provide distributed compute and storage capabilities. Each of the federated platforms 3230a-n may comprise all or some of the components described with respect to FIGS. 27-31 above. Due to the distributed nature of the federated architecture, it is possible that a task may be started on one node of the federation and completed on another node of the federation. The platforms 3230a-n may be connected to service providers/content providers 2740a-n accessible via the Internet 2740. In some embodiments, when a user of a user device 3210a submits a content request it may be processed by one or more instances of platform 3230a-n.

According to some aspects, a user device 3210a may comprise an experience curation application 3211a which may be a web application or a mobile device software application, one or more filters (e.g., Gen AI models), and a local instance of a preference database 3213a. User device 3210a may further comprise an operating system, one or more processors, a memory, a display, input device(s) (e.g., mouse, keyboard, touchscreen, etc.), embedded sensors (e.g., microphone, camera, fingerprint sensor, facial recognition system, gyroscope, Lidar, gait detection, dental record comparisons, implant/fixation device comparisons, tattoo comparisons, etc.), and other applications or microservices.

According to the embodiment, the user devices 3210a-n may be used in a federated arrangement to provide edge-based computing and learning. In such an arrangement, each user device 3210a may store a local instance of filters 3212a and a local repository of data including preference data to perform content curation on the user device. A user can submit a request for content via experience curation app 3211a which retrieves the requested content from the appropriate content provider 2740a-n and then extracts and classifies relevant content from the retrieved content. User and device specific information available only to that user device may be used as inputs to the one or more filters 3212a to generate curated content and display it on the user device 3210a. In this way, a user device 3210a may still be able to operate in conditions where an intermittent connection to a cloud-based platform 3230a-n is available. Preference data may be stored locally and periodically uploaded for storage in a cloud-based preference database.

In some implementations, each of a plurality (or subset of a plurality) of user devices 3210a may periodically send local AI model (e.g., preference filter) parameters to a cloud-based platform 3230a-n which may aggregate the received plurality of AI model parameters and update a global version of an AI model. The updated global model parameters may then be transmitted to one or more of the user devices 3210a-n where it may be operated locally as an updated local filter 3212a. In this way, the federated dynamic experience curation platform architecture can provide edge learning across multiple edge devices.

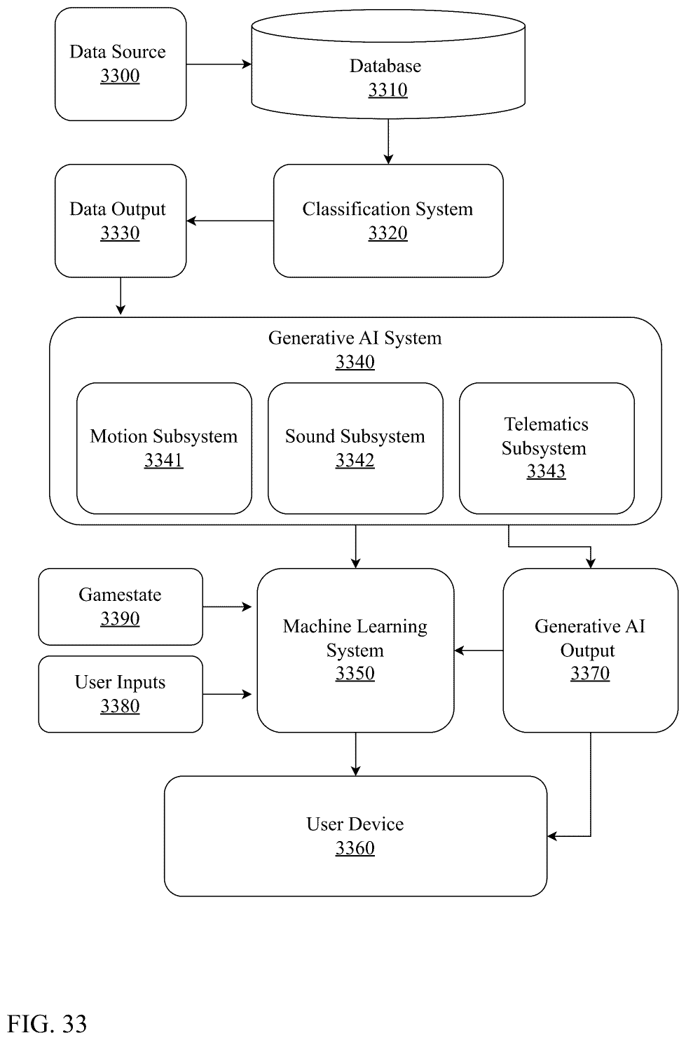

FIG. 33 is a block diagram illustrating an exemplary system architecture for AI-enabled telematics for electronic entertainment and simulation systems. In one embodiment, a system for AI-enabled telematics for electronic entertainment and simulation systems comprises a plurality of data sources 3300, a plurality of databases 3310, a data classification system 3320, a data output 3330, a Gen AI system 3340 comprising a plurality of Gen AI subsystems, a plurality of Gen AI outputs 3370, a machine learning system 3350, game state data 3390, user input data 3380, and a user device 3360.

The system may receive a plurality of data from a plurality of data sources 3300. Data sources may include but are not limited to cameras, microphones, speedometers, accelerometers, or global positioning systems (GPS). Data sources will vary depending on the desired video game or simulation environment. For example, a game or simulation about flying airplanes may include additional data sources for altitude and lift. All data collected by the system may be stored in a plurality of databases 3310 which may include but are not limited to cloud based storage systems. Data is classed by a classification system 3320 where datasets are formed based on where data was collected from. For example, all data pertaining to speed collected from an accelerometer may be classed together. Likewise, any data pertaining to altitude will be in its own class. Classed data is then output from the classification system 3320 as data output 3330. Data output 3330 may be passed through a Gen AI system 3340 which comprises a plurality of Gen AI subsystems. In one embodiment, the Gen AI system 3340 may further comprise a motion subsystem 3341, a sound subsystem 3342, and a telematics subsystem 3343. The Gen AI system may further comprise a plurality of additional subsystems for any and all classed data outputs 3330. Which subsystems are needed will vary depending on the video game or simulation environment being created.

The Gen AI system 3340 will take in classed data outputs 3330 and pass each data set to a corresponding Gen AI subsystem. Each subsystem will generate a Gen AI output 3370 corresponding to each classed data output 3330 passed through the Gen AI system 3340. For example, if sound data was passed through a sound subsystem 3342, the Gen AI output 3370 may consist of newly generated sound data pertaining to a desired video game or simulation environment. In one embodiment, the classed data output 3330 may include sound data from a Formula One (F1) race. The sound data may include sound from inside a vehicle, from surrounding vehicles, and from the nearby crowd. The Gen AI system 3340 may receive the sound data and relay the data to a specific sound subsystem 3342. The sound subsystem 3342 may then process the data and generate new sound data based on a desired output. For example, the sound subsystem 3342 may process the input sound data and generate a sound profile for a specific vehicle at an F1 race. The profile may include what it sounds like from inside the vehicle and the crowd outside. This sound profile may then be either further processed by a machine learning system 3350 or broadcast directly to a user device 3360.

The machine learning system 3350 may take inputs from a plurality of sources including but not limited to the Gen AI system 3340, a Gen AI subsystem, a game or simulation state through game state data 3390, and directly from a user through user inputs 3380. Game state data 3390 may include but is not limited to map data, telemetry, vehicle conditions, player decisions, acceleration, velocity, vectors, physics engine data, xyzzy positions, and pitch and yaw positional data. User input data 3380 includes but is not limited to historical input data for a particular user, present input data, or user preferred settings. The machine learning system 3340 may compile game state data 3390 and user input data 3380 to better constrain the range of future game states including but not limited to possible motion, vibration, smells, and sounds that a user may be subjected to. The machine learning system 3340 is able to control the natural momentum of the game by predicting and generating an optimal future game state.

In one embodiment, the machine learning system 3350 may process a plurality of data about a professional in a particular field. For example, the machine learning system 3350 may process a plurality of data for Boston Red Sox former pitcher Pedro Martinez. The machine learning system may create a professional profile using a plurality of algorithms where the professional profile is a recreation of how that professional would perform. In the context of Pedro Martinez, the machine learning system 3350 may create a professional profile which captures traits such as but not limited to Martinez's stance, his form, his power, his accuracy, and other data points to recreate an experience for a user where they are pitted against a virtual professional such as Pedro Martinez. The Gen AI system 3340 may separately collect data about a particular professional. In the context of Pedro Martinez, the Gen AI system 3340 may collect and process data such as but not limited to appearance, form, figure, power, accuracy, skills, and other activity related statistics. The Gen AI system may then create an environment which replicates an environment where a particular professional may operate. For example, in the context of Pedro Martinez, the Gen AI system 3340 may create a realistic environment which replicates Fenway Park where Martinez played many of his games. A user may then be placed in the created realistic environment where they may interact with it using a user device. The machine learning system 3350 may incorporate the professional profile into the realistic environment where the user can interact with a recreation of a professional in an environment where they would have performed.

Additionally, the machine learning system 3350 may collect and process user input data based on how they interact in the generated realistic environment. The machine learning system 3350 may process the user input data into a user profile. The user profile may then be compared against a plurality of other user profiles or a plurality of professional profiles where the machine learning system 3350 may determine how close a user is to a particular professional. This allows the system to rank users amongst themselves and display to users how they compare to professionals on a particular task. Additionally, this allows talent agencies to easily view users who perform well in a particular environment and who closely compare to professionals in that environment. Similarly, this embodiment may lead to fun activities where users compete in challenges based on populated professional profiles and generated environments. For example, one challenge may be to hit a pitch from former Boston Red Sox pitcher Pedro Martinez. This allows organizations to grow fan bases, create promotional challenges, or generate challenges where users pay money to pit their skills against professionals or groups of other users.

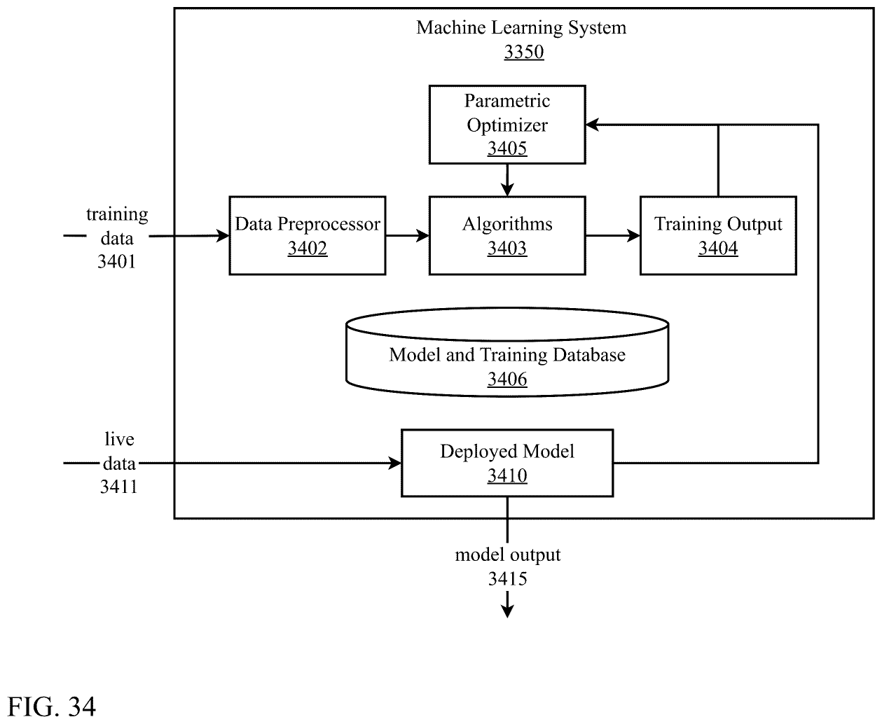

FIG. 34 is a block diagram illustrating an exemplary architecture for a subsystem of the system for AI-enabled telematics for electronic entertainment and simulation systems, a Machine Learning system 3350. According to the embodiment, machine learning engine may comprise a model training stage comprising a data preprocessor 3402, one or more machine and/or deep learning algorithms 3403, training output 3404, and a parametric optimizer 3405, and a model deployment stage comprising a deployed and fully trained model 3410 configured to perform tasks described herein such as transcription, summarization, agent coaching, and agent guidance.

At the model training stage, a plurality of training data 3401 may be received at machine learning engine 3400. In some embodiments, the plurality of training data may be obtained from one or more databases 3310 and/or directly from various sources such as but not limited to a video game or simulation game state 3390 or user inputs 3380. Data preprocessor 3402 may receive the input data (e.g., video game or simulation game state data) and perform various data preprocessing tasks on the input data to format the data for further processing. For example, data preprocessing can include, but is not limited to, tasks related to data cleansing, data deduplication, data normalization, data transformation, handling missing values, feature extraction and selection, mismatch handling, and/or the like. Data preprocessor 3402 may also be configured to create training dataset, a validation dataset, and a test set from the plurality of input data 3401. For example, a training dataset may comprise 80% of the preprocessed input data, the validation set 10%, and the test dataset may comprise the remaining 10% of the data. The preprocessed training dataset may be fed as input into one or more machine and/or deep learning algorithms 3403 to train a predictive model for object monitoring and detection.

Machine learning engine 3350 may be fine-tuned to ensure each model performed in accordance with a desired outcome. Fine-tuning involves adjusting the model's parameters to make it perform better on specific tasks or data. In this case, the goal is to improve the model's performance on video game or simulation data. The fine-tuned models are expected to provide improved accuracy and quality when processing video game or simulation data, which can be crucial for applications like predicting and generating future game states. The refined models can be optimized for real-time processing, meaning they can quickly analyze and understand game states and user inputs as they happen. Additionally, by using the smaller, fine-tuned models instead of a larger model for routine tasks, the machine learning system 3350 reduces computational costs associated with AI processing.

During model training, training output 3404 is produced and used to measure the accuracy and usefulness of the predictive outputs. During this process a parametric optimizer 3405 may be used to perform algorithmic tuning between model training iterations. Model parameters and hyperparameters can include, but are not limited to, bias, train-test split ratio, learning rate in optimization algorithms (e.g., gradient descent), choice of optimization algorithm (e.g., gradient descent, stochastic gradient descent, of Adam optimizer, etc.), choice of activation function in a neural network layer (e.g., Sigmoid, ReLu, Tan h, etc.), the choice of cost or loss function the model will use, number of hidden layers in a neural network, number of activation units in each layer, the drop-out rate in a neural network, number of iterations (epochs) in a training the model, number of clusters in a clustering task, kernel or filter size in convolutional layers, pooling size, batch size, the coefficients (or weights) of linear or logistic regression models, cluster centroids, and/or the like. Parameters and hyperparameters may be tuned and then applied to the next round of model training. In this way, the training stage provides a machine learning training loop.

In some implementations, various accuracy metrics may be used by machine learning engine 3350 to evaluate a model's performance. Metrics may include, but are not limited to latency between a user input and a generated game state, quality of generated game states, and the realism of generated game states.

The test dataset can be used to test the accuracy of the model outputs. If the training model is making predictions that satisfy a certain criterion then it can be moved to the model deployment stage as a fully trained and deployed model 3410 in a production environment making predictions based on live input data 3411 (e.g., video game or simulation game state data). Further, model predictions made by a deployed model can be used as feedback and applied to model training in the training stage, wherein the model is continuously learning over time using both training data and live data and predictions.

A model and training database 3406 is present and configured to store training/test datasets and developed models. Database 3406 may also store previous versions of models. Database 3406 may be a part of database(s) 3310.

According to some embodiments, the one or more machine and/or deep learning models may comprise any suitable algorithm known to those with skill in the art including, but not limited to: LLMs, generative transformers, transformers, supervised learning algorithms such as: regression (e.g., linear, polynomial, logistic, etc.), decision tree, random forest, k-nearest neighbor, support vector machines, Naïve-Bayes algorithm; unsupervised learning algorithms such as clustering algorithms, hidden Markov models, singular value decomposition, and/or the like. Alternatively, or additionally, algorithms 3403 may comprise a deep learning algorithm such as neural networks (e.g., recurrent, convolutional, long short-term memory networks, etc.).

In some implementations, ML engine 3350 automatically generates standardized model scorecards for each model produced to provide rapid insights into the model and training data, maintain model provenance, and track performance over time. These model scorecards provide insights into model framework(s) used, training data, training data specifications such as chip size, stride, data splits, baseline hyperparameters, and other factors. Model scorecards may be stored in database(s) 3310.

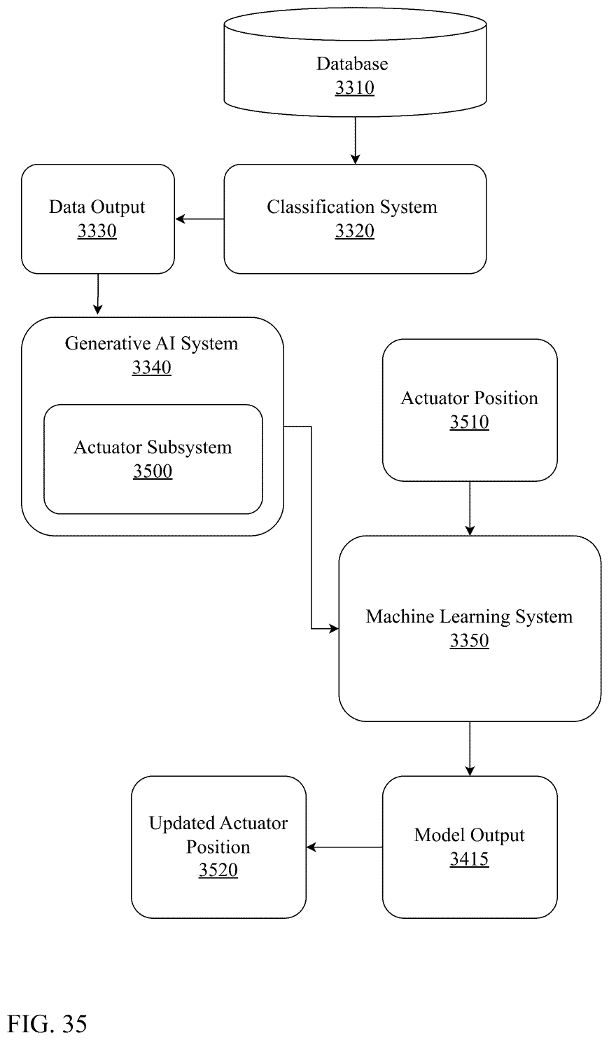

FIG. 35 is a diagram showing an embodiment of one aspect of the system and method for AI-enabled telematics for electronic entertainment and simulation systems, specifically, using a machine learning system to update actuator position. Many gaming and simulation systems utilize a plurality of actuators to translate virtual movement into real movement for a user. In one embodiment, the Gen AI system 3340 may have an actuator subsystem 3500 which receives a plurality of telematics data pertaining to a particular environment. For example, if the environment being replicated is a F1 race, a vehicle in the race will only be able to move along a constrained track. Walls or barriers may prevent a driver from veering too far off course. Additionally, vehicles have predetermined turn radii which limit the range of motion for any given vehicle. Data about the course and each vehicle may be processed by an actuator subsystem 3500 to generate an actuator profile which determines the given possible range of motion for an object within a particular environment. The actuator profile may then be passed through a machine learning system 3350 which may also receive data based on the current position of each actuator. The machine learning system may synthesize the actuator profile and the current position of each actuator and generate a model output 3415 which controls subsequent updated actuator positions 3520. Additionally, the machine a learning system 3350 may generate a resting actuator position which is a default position for the actuators to return to when not being engaged. Movement back to the resting actuator position may be gradual and over time so the user's experience is not interrupted by unexpected motion. Slow and gradual motion allows the user to continue making movements in a particular direction even when an actuator's range of motion has been fully exhausted.

In another embodiment, the machine learning system 3350 may process past and present data and make predictions about where a user may move in the future. Past and present data may include but is not limited to, map data, telemetry, vehicle condition, player decisions, acceleration, velocity, vectors, physics engines, xyzzy positions, and other positional information. The machine learning system 3350 processes past and present game data to generate a predicted actuation profile. This predicted actuation profile may vary depending on the environment being generated. For example, a person at rest and about to the take a step. A probability exists that the person might move straight ahead, left or right, or backwards. Based on the probabilities of each motion the machine learning system 3350 may predict the most likely subsequent motion. The context can be changed to apply to NASCAR racing where a driver generally moves forward and to the left. By breaking down motion into a series of probabilistic events, the machine learning engine 150 can reduce how drastic it feels to return to the actuator's resting position.

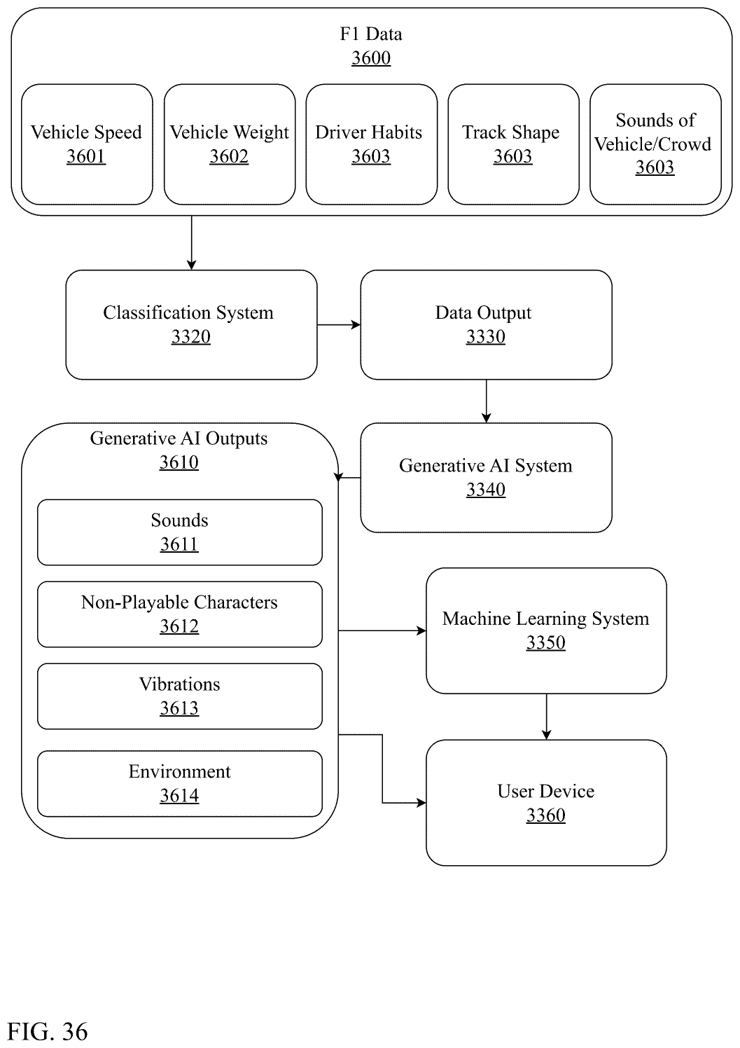

FIG. 36 is a diagram showing an embodiment of one aspect of the system and method for AI-enabled telematics for electronic entertainment and simulation systems, specifically, generating racing environments from telematics data. In one embodiment, the classification system 3320 may receive racing data 3600 from a plurality of data sources. Racing data 3600 may include, but is not limited to vehicle speed 3601, vehicle weight 3602, driver habits 3603, track shape 3604, and sounds of the vehicle or crowd 3605. The classification system 3320 may send a data output 3330 to a Gen AI system 3340. The Gen AI system 3340 may output a plurality of Gen AI outputs 3610 pertaining to the corresponding data outputs 3330. Some examples of Gen AI outputs 3610 may include but are not limited to sounds 3611, non-playable characters 3612, vibrations 3613, and a plurality of environments 3614. The Gen AI outputs 3610 may then be passed through a machine learning system 3350 which will process the Gen AI outputs 3610 to predict and generate new environments based on the data. Additionally, Gen AI outputs 3610 may be sent directly to a user device 3360.

In one embodiment, the Gen AI system 3340 may receive GPS data as an input where the system may generate tracks and courses which resemble tracks and courses in real life. For example, using GPS data, cameras, drone footage, and other image based data sources the Gen AI system 3340 may recreate a realistic virtual rendering of the Monaco F1 racetrack. In another embodiment, the Gen AI system 3340 may turn any starting point and ending point into a track by generating a traversable terrain between two points. For example, a user may want to drive a virtual racecar along a track which connects the German Autobahn with the peak of Mount Everest. The Gen AI system 3340 may process image and GPS data between those two points and render a virtual track which is comparable to traversing those two points in reality.

In another embodiment, the Gen AI system 3340 may process data about professionals in a particular area. For example, the Gen AI system 3340 may process data about popular F1 drivers such as but not limited to, driving habits, skill level, and vehicle information. The machine learning system 3350 may access Gen AI system outputs 3610 to create professional profiles using data outputs pertaining to professionals at a given task. For example, the machine learning system 3350 may create a professional profile for Charles LeClerc, a professional F1 driver. The machine learning system 3350 may then populate a virtual Charles LeClerc based on his professional profile into a generated vehicle where the virtual Charles Leclerc drives the vehicle similarly to how he would drive in real life. This function may be translated into a variety of features. One feature is where a user wants to ride with a professional racer. The user may experience a race from inside of a vehicle while a virtual professional driver operates the vehicle. Additionally, a user may elect to take control of the vehicle at any point in the game or simulation. The Gen AI system 3340 and the machine learning system 3350 may continually generate a continuous track or simulation based on where the virtual professional driver left off. This allows users to jump in at various points of a race or simulation depending on user preference.

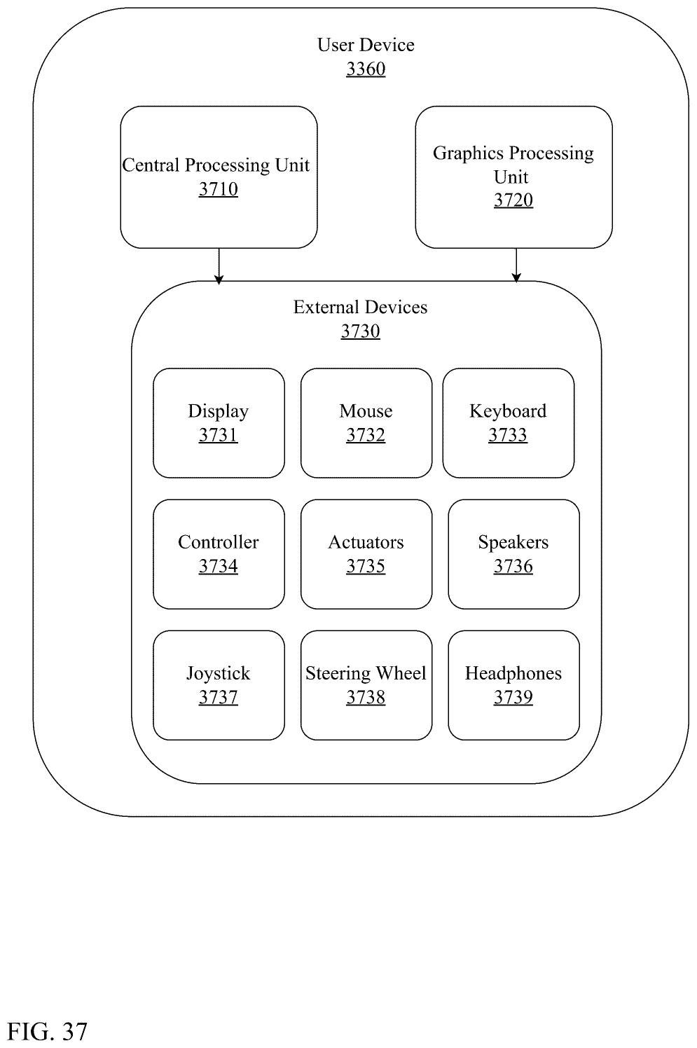

FIG. 37 is a block diagram illustrating an exemplary architecture for a component of a system for AI-enabled telematics for electronic entertainment and simulation systems, specifically, a user device. In general, the user device 3360 serves as an intermediary between the user and the virtual environment. Generated environments may be displayed to a user device 3360 where the user may then interact with the environment. In one embodiment, a user device 3360 may include electronic devices with a central processing unit 3710 (CPU) and a graphics processing unit 3720 (GPU). A large variety of external devices 3730 may be operably paired to either the CPU 3710 or the GPU 3720 to allow a user to interact or experience a virtual environment in a variety of ways. Some external devices 3730 may include, but are not limited to, a display 3731, a mouse 3732, a keyboard 3733, a controller 3734, a plurality of actuators 3735 which may or may not be positioned on a platform, a plurality of speakers 3736, a joystick controller 3737, a steering wheel 3738, or headphones 3739. The external devices 3730 may vary depending on the kind of device being used by a user. For example, if the user is engaging with a virtual environment with an Xbox, the external devices may only consist of a display 3731 and a controller 3734. The quantity and quality of external devices may vary depending on the particular video game or simulation environment. For example, a racing simulation may include a display 3731, a steering wheel 3738, brakes, a gas pedal, and a clutch, while a flight simulator may include a display 3731 and a joystick 3737.

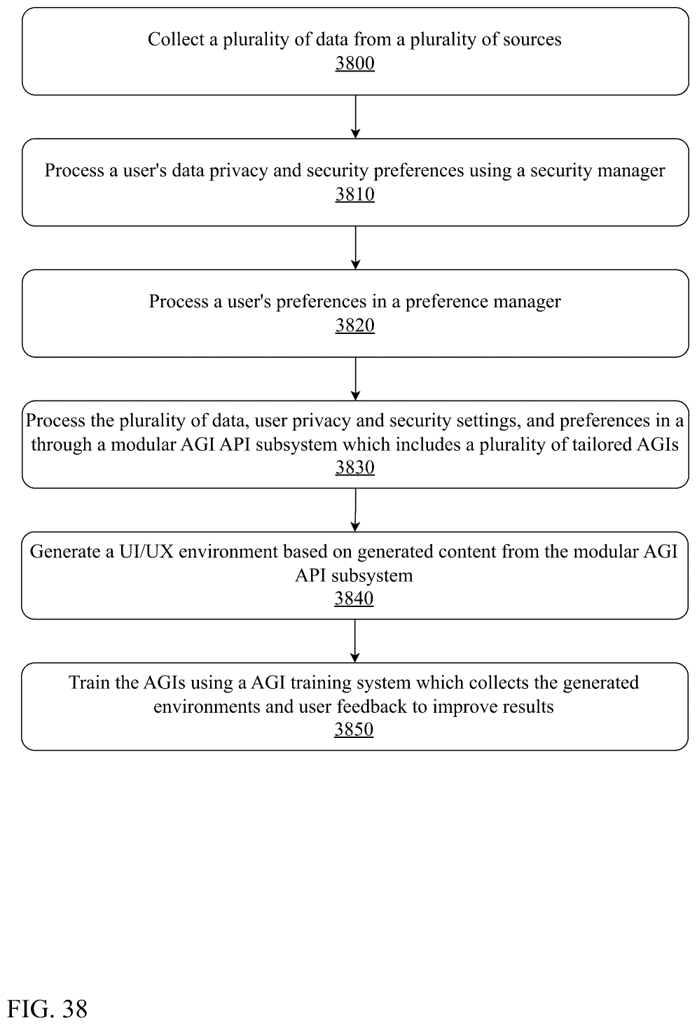

FIG. 38 is a flow diagram illustrating an exemplary method for generating a UI/UX environment using a user experience curation system. In a first step 3800, collect a plurality of data from a plurality of sources. This data may include user demographics, preferences, behavior patterns, interaction history, and contextual information. The data sources can be diverse, such as user input, sensors, databases, APIs, or external services. The collected data serves as the foundation for understanding the user and their needs, enabling the AI system to generate personalized experiences.

In a step 3810, process a user's data privacy and security preferences using a security manager. To ensure the protection of user data and comply with relevant regulations, the method employs a security manager. This component processes the user's data privacy and security preferences, which may include settings related to data sharing, anonymization, encryption, and access control. The security manager ensures that the collected data is handled securely and in accordance with the user's specified preferences throughout the entire process. In a step 3820, process a user's preferences in a preference manager. The method utilizes a preference manager to process and handle the user's individual preferences. These preferences may encompass various aspects of the user experience, such as content categories, visual styles, accessibility requirements, and interaction modes. The preference manager allows users to express their desires and customize their experience according to their specific needs and likings.

In a step 3830, process the plurality of data, user privacy and security settings, and preferences through a modular AI API subsystem which includes a plurality of tailored AGIs. The modular AI API subsystem consists of multiple specialized AI modules. Each AI module is tailored to handle specific aspects of the user experience, such as natural language processing, visual content generation, recommendation engines, and interaction design. The collected data, along with the user's privacy settings and preferences, are processed through this subsystem. The AI modules collaborate and leverage their specialized capabilities to generate personalized content, recommendations, and UI/UX elements that align with the user's needs and preferences.

In a step 3840, generate a UI/UX environment based on generated content from the modular AI API subsystem. Using the outputs generated by the modular AI API subsystem, the method creates a comprehensive UI/UX environment. This environment seamlessly integrates the personalized content, recommendations, and UI/UX elements produced by the AI modules. The resulting UI/UX environment is tailored to the user's preferences, context, and privacy settings, providing an engaging and adaptive user experience.

In a step 3850, train the AGIs using an AI training system which collects the generated environments and user feedback to improve results. To continuously improve the performance and effectiveness of the AI system, the method incorporates an AI training system. This system collects the generated UI/UX environments along with user feedback, which can include explicit ratings, comments, and implicit behavioral data. By analyzing this feedback and the corresponding generated environments, the training system can identify patterns, learn from user preferences, and fine-tune the AI modules. Through iterative training and optimization, the AI system becomes more adept at generating personalized and satisfying user experiences over time.

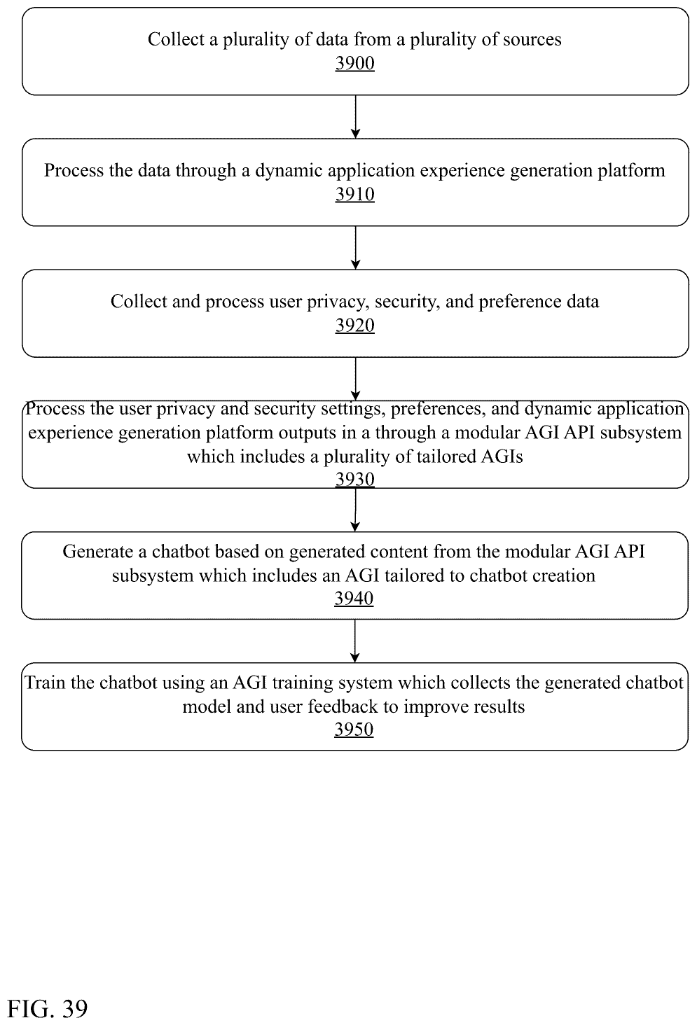

FIG. 39 is a flow diagram illustrating an exemplary method for generating a chatbot using a user experience curation system. In a step 3900, collect a plurality of data from a plurality of sources. This data may include user demographics, preferences, interaction history, and domain-specific knowledge relevant to the chatbot's purpose. The data sources can vary, such as user input, databases, APIs, or external services. The collected data forms the basis for understanding the user and their requirements, enabling the AI system to generate a tailored chatbot experience.

In a step 3910, process the data through a dynamic application experience generation platform. This platform is designed to analyze and interpret the data, extracting meaningful insights and patterns. It may employ various techniques, such as data mining, machine learning, and natural language processing, to understand the user's needs, preferences, and context. The platform's output serves as a foundation for generating a personalized chatbot experience.

In a step 3920, collect and process user privacy, security, and preference data. This step involves collecting user-specific settings related to data privacy, such as data sharing permissions and encryption preferences. Additionally, user preferences regarding the chatbot's behavior, tone, and interaction style are collected. This information ensures that the chatbot adheres to the user's privacy requirements and aligns with their preferred communication style.

In a step 3930, process the user privacy and security settings, preferences, and dynamic application experience generation platform outputs through a modular AI API subsystem which includes a plurality of tailored AGIs. This subsystem comprises multiple specialized AI modules, each designed to handle specific aspects of the chatbot's functionality. These AI modules may include natural language understanding, dialogue management, response generation, and personality modeling. The AI modules work together, leveraging the processed data and user preferences, to generate a personalized and context-aware chatbot experience.

In a step 3940, generate a chatbot based on generated content from the modular AI API subsystem which includes an AI tailored to chatbot creation. Utilizing the outputs generated by the modular AI API subsystem, particularly the AI module tailored to chatbot creation, the method generates a personalized chatbot. This chatbot incorporates the user's preferences, privacy settings, and the insights derived from the processed data. The generated chatbot is designed to engage in natural and context-aware conversations, providing relevant information, assistance, and support to the user. The chatbot's behavior, language, and interaction style are adapted to align with the user's specific needs and preferences.

In a step 3950, train the chatbot using an AI training system which collects the generated chatbot model and user feedback to improve results. To continuously enhance the chatbot's performance and effectiveness, the method employs an AI training system. This system collects the generated chatbot model along with user feedback, which can include explicit ratings, user interactions, and conversation logs. By analyzing this feedback and the corresponding chatbot model, the training system can identify areas for improvement, refine the AI modules, and optimize the chatbot's responses. Through iterative training and fine-tuning, the chatbot becomes more proficient in understanding user intent, providing accurate and helpful responses, and delivering a personalized and engaging conversational experience.

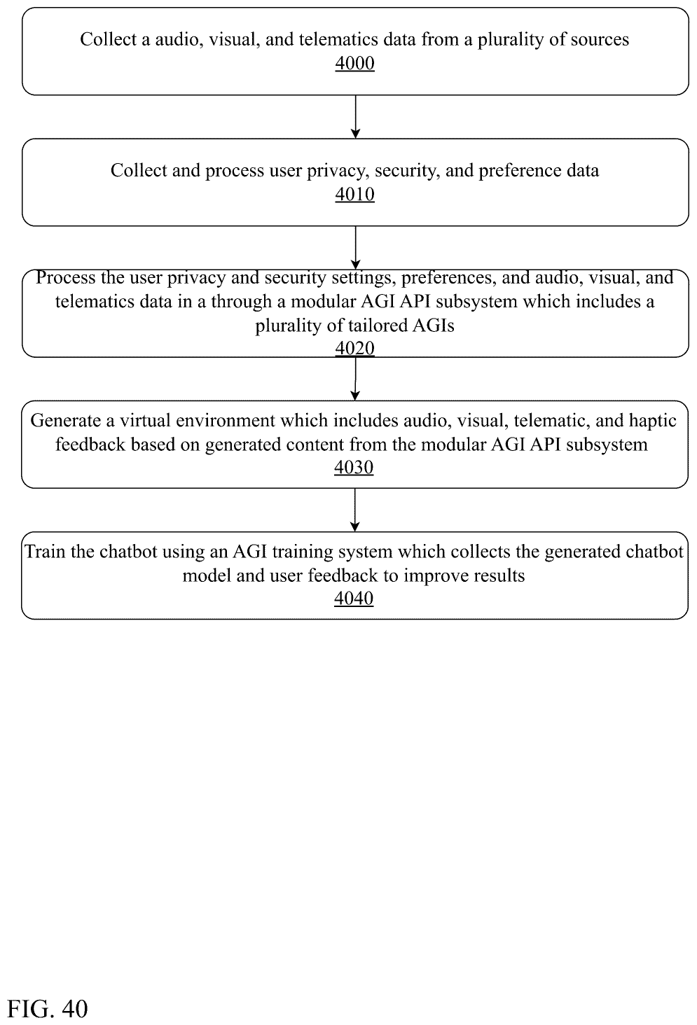

FIG. 40 is a flow diagram illustrating an exemplary method for generating audio, visual, telematics, and haptic experiences using a user experience curation system. In a step 4000, collect audio, visual, and telematics data from a plurality of sources. Audio data may include ambient sounds, speech, and music, while visual data may encompass images, videos, and 3D models. Telematics data refers to information derived from sensors and systems, such as location, motion, and environmental data. These diverse data sources provide rich input for generating a comprehensive and realistic virtual environment.

In a step 4010, collect and process user privacy, security, and preference data. Alongside collecting audio, visual, and telematics data, the method also gathers and processes user privacy, security, and preference data. This step involves obtaining user-specific settings related to data privacy, such as data sharing permissions, encryption requirements, and access controls. Additionally, user preferences regarding the virtual environment's content, interaction modes, and personalization options are collected. This information ensures that the generated virtual environment aligns with the user's privacy expectations and individual preferences.

In a step 4020, process the user privacy and security settings, preferences, and audio, visual, and telematics data through a modular AI API subsystem which includes a plurality of tailored AGIs. The collected user privacy and security settings, preferences, and the audio, visual, and telematics data are then processed through a modular AI API subsystem. This subsystem consists of multiple specialized AI modules, each designed to handle specific aspects of the virtual environment generation. These AI modules may include audio processing, visual rendering, telematics analysis, and haptic feedback generation. The AI modules collaborate, leveraging the processed data and user preferences, to create a personalized and immersive virtual environment.

In a step 4030, generate a virtual environment which includes audio, visual, telematic, and haptic feedback based on generated content from the modular AI API subsystem. Utilizing the outputs generated by the modular AI API subsystem, the method generates a comprehensive virtual environment. This environment seamlessly integrates audio, visual, telematic, and haptic feedback elements, creating a rich and immersive user experience. The audio components may include ambient sounds, spatial audio, and interactive sound effects. The visual elements may comprise realistic 3D graphics, animations, and dynamic lighting. Telematic data is used to create a responsive and interactive environment that reacts to user actions and real-world conditions. Haptic feedback, such as vibrations and tactile sensations, enhances the sense of immersion and interactivity.

In a step 4040, train the chatbot using an AI training system which collects the generated chatbot model and user feedback to improve results. To continuously refine and improve the virtual environment, the method employs an AI training system. This system collects the generated virtual environment model along with user feedback, which can include explicit ratings, user interactions, and behavioral data. By analyzing this feedback and the corresponding virtual environment model, the training system can identify areas for enhancement, optimize the AI modules, and fine-tune the audio, visual, telematic, and haptic elements. Through iterative training and adaptation, the virtual environment becomes more engaging, realistic, and responsive to user preferences and actions.

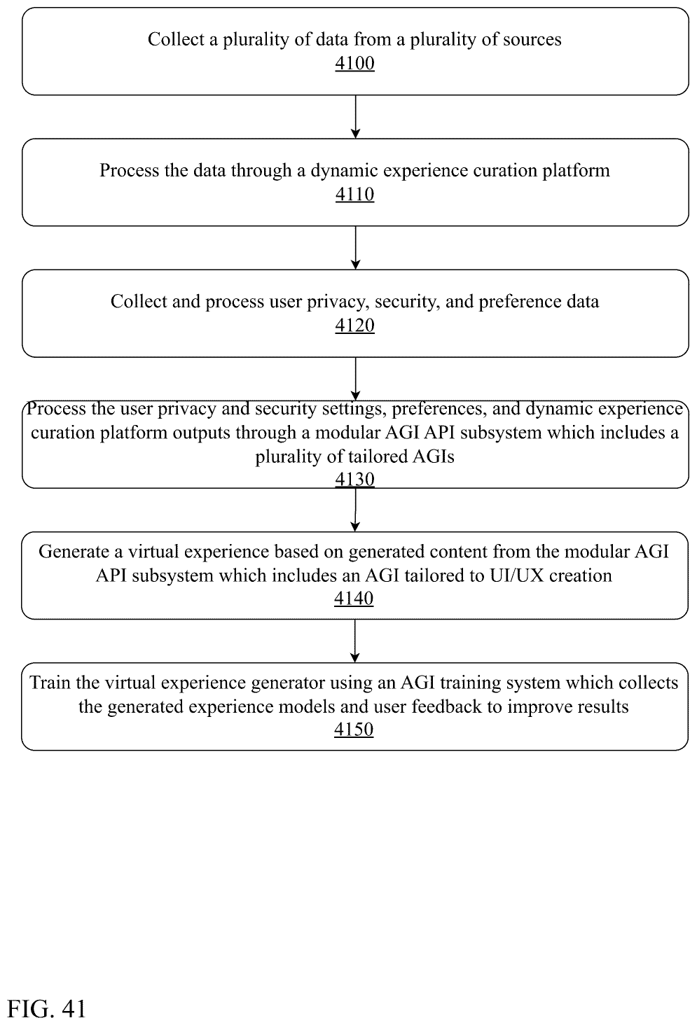

FIG. 41 is a flow diagram illustrating an exemplary method for generating a UI/UX environment using a dynamic experience curation platform with an integrated user experience curation platform. In a step 4100, collect a plurality of data from a plurality of sources. This data may include user demographics, preferences, interaction history, and contextual information relevant to the virtual experience. The data sources can be varied, such as user input, sensors, databases, APIs, or external services. The collected data serves as the foundation for understanding the user and their requirements, enabling the AI system to generate a tailored virtual experience.

In a step 4110, process the data through a dynamic experience curation platform. This platform is designed to analyze and curate the data, identifying relevant patterns, user preferences, and contextual insights. It may employ advanced techniques such as data analytics, machine learning, and recommendation algorithms to create a personalized and context-aware experience framework. The platform's output provides a structured and optimized set of data that informs the subsequent steps in the virtual experience generation process.

In a step 4120, collect and process user privacy, security, and preference data. This step involves collecting user-specific settings related to data privacy, such as data sharing permissions, encryption preferences, and access controls. Additionally, user preferences regarding the virtual experience's content, interaction modes, and customization options are collected. This information ensures that the generated virtual experience respects the user's privacy choices and aligns with their individual preferences.

In a step 4130, process the user privacy and security settings, preferences, and dynamic experience curation platform outputs through a modular AI API subsystem which includes a plurality of tailored AGIs. The user privacy and security settings, preferences, and the outputs from the dynamic experience curation platform are then processed through a modular AI API subsystem. This subsystem comprises multiple specialized AI modules, each designed to handle specific aspects of the virtual experience generation. These AI modules may include content generation, interaction design, visual rendering, and personalization. The AI modules work together, leveraging the processed data and user preferences, to generate a highly personalized and engaging virtual experience.

In a step 4140, generate a virtual experience based on generated content from the modular AI API subsystem which includes an AI tailored to UI/UX creation. Utilizing the outputs generated by the modular AI API subsystem, particularly the AI module tailored to UI/UX creation, the method generates a personalized virtual experience. This virtual experience incorporates the user's preferences, privacy settings, and the insights derived from the curated data. The UI/UX-focused AI module ensures that the virtual experience features intuitive navigation, visually appealing designs, and seamless interactions. The generated virtual experience is designed to captivate the user, providing a rich and immersive environment that adapts to their specific needs and preferences.

In a step 4150, train the virtual experience generator using an AI training system which collects the generated experience models and user feedback to improve results. To continuously enhance the quality and effectiveness of the virtual experience, the method employs an AI training system. This system collects the generated virtual experience models along with user feedback, which can include explicit ratings, user interactions, and engagement metrics. By analyzing this feedback and the corresponding virtual experience models, the training system can identify areas for improvement, refine the AI modules, and optimize the overall user experience. Through iterative training and fine-tuning, the virtual experience generator becomes more adept at creating compelling, personalized, and user-centric virtual experiences.

It should be appreciated that the described systems and methods may be directed to the generation of experience moments, sequences of moments, and/or the progression of sequences in addition to, or alternative to, the generation of various environments.

### Exemplary Computing Environment

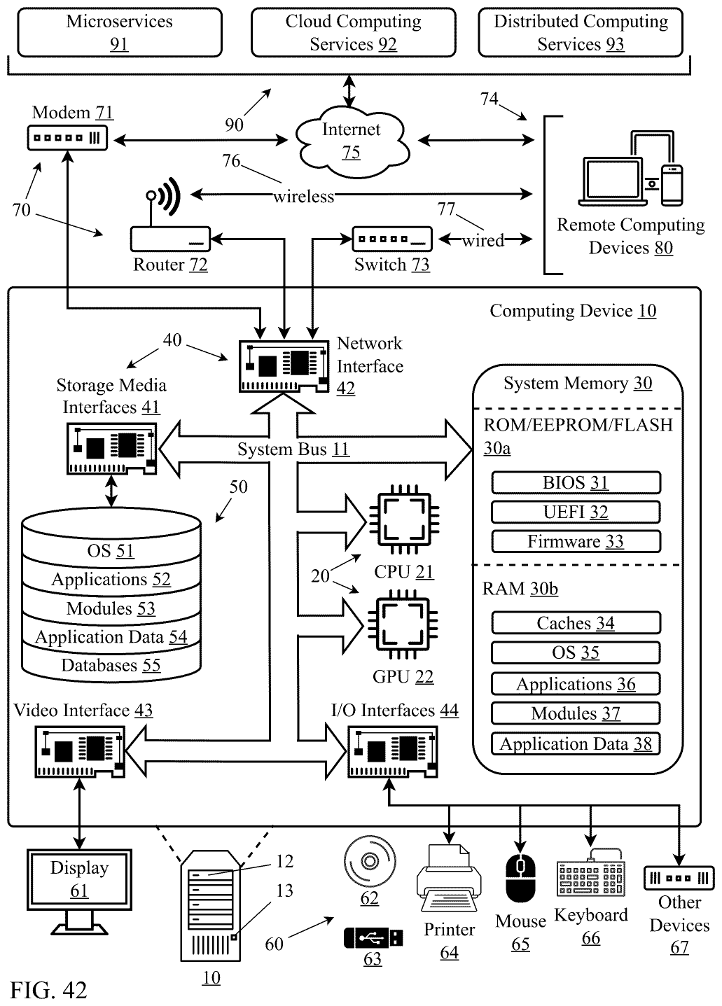

FIG. 42 illustrates an exemplary computing environment on which an embodiment described herein may be implemented, in full or in part. This exemplary computing environment describes computer-related components and processes supporting enabling disclosure of computer-implemented embodiments. Inclusion in this exemplary computing environment of well-known processes and computer components, if any, is not a suggestion or admission that any embodiment is no more than an aggregation of such processes or components. Rather, implementation of an embodiment using processes and components described in this exemplary computing environment will involve programming or configuration of such processes and components resulting in a machine specially programmed or configured for such implementation. The exemplary computing environment described herein is only one example of such an environment and other configurations of the components and processes are possible, including other relationships between and among components, and/or absence of some processes or components described. Further, the exemplary computing environment described herein is not intended to suggest any limitation as to the scope of use or functionality of any embodiment implemented, in whole or in part, on components or processes described herein.

The exemplary computing environment described herein comprises a computing device 10 (further comprising a system bus 11, one or more processors 20, a system memory 30, one or more interfaces 40, one or more non-volatile data storage devices 50), external peripherals and accessories 60, external communication devices 70, remote computing devices 80, and cloud-based services 90.

System bus 11 couples the various system components, coordinating operation of and data transmission between those various system components. System bus 11 represents one or more of any type or combination of types of wired or wireless bus structures including, but not limited to, memory busses or memory controllers, point-to-point connections, switching fabrics, peripheral busses, accelerated graphics ports, and local busses using any of a variety of bus architectures. By way of example, such architectures include, but are not limited to, Industry Standard Architecture (ISA) busses, Micro Channel Architecture (MCA) busses, Enhanced ISA (EISA) busses, Video Electronics Standards Association (VESA) local busses, a Peripheral Component Interconnects (PCI) busses also known as a Mezzanine busses, or any selection of, or combination of, such busses. Depending on the specific physical implementation, one or more of the processors 20, system memory 30 and other components of the computing device 10 can be physically co-located or integrated into a single physical component, such as on a single chip. In such a case, some or all of system bus 11 can be electrical pathways within a single chip structure.

Computing device may further comprise externally-accessible data input and storage devices 12 such as compact disc read-only memory (CD-ROM) drives, digital versatile discs (DVD), or other optical disc storage for reading and/or writing optical discs 62; magnetic cassettes, magnetic tape, magnetic disk storage, or other magnetic storage devices; or any other medium which can be used to store the desired content and which can be accessed by the computing device 10. Computing device may further comprise externally-accessible data ports or connections 12 such as serial ports, parallel ports, universal serial bus (USB) ports, and infrared ports and/or transmitter/receivers. Computing device may further comprise hardware for wireless communication with external devices such as IEEE 1394 (“Firewire”) interfaces, IEEE 802.11 wireless interfaces, BLUETOOTH® wireless interfaces, and so forth. Such ports and interfaces may be used to connect any number of external peripherals and accessories 60 such as visual displays, monitors, and touch-sensitive screens 61, USB solid state memory data storage drives (commonly known as “flash drives” or “thumb drives”) 63, printers 64, pointers and manipulators such as mice 65, keyboards 66, and other devices 67 such as joysticks and gaming pads, touchpads, additional displays and monitors, and external hard drives (whether solid state or disc-based), microphones, speakers, cameras, and optical scanners.

Processors 20 are logic circuitry capable of receiving programming instructions and processing (or executing) those instructions to perform computer operations such as retrieving data, storing data, and performing mathematical calculations. Processors 20 are not limited by the materials from which they are formed or the processing mechanisms employed therein, but are typically comprised of semiconductor materials into which many transistors are formed together into logic gates on a chip (i.e., an integrated circuit or IC). The term processor includes any device capable of receiving and processing instructions including, but not limited to, processors operating on the basis of quantum computing, optical computing, mechanical computing (e.g., using nanotechnology entities to transfer data), and so forth. Depending on configuration, computing device 10 may comprise more than one processor. For example, computing device 10 may comprise one or more central processing units (CPUs) 21, each of which itself has multiple processors or multiple processing cores, each capable of independently or semi-independently processing programming instructions. Further, computing device 10 may comprise one or more specialized processors such as a graphics processing unit (GPU) 22 configured to accelerate processing of computer graphics and images via a large array of specialized processing cores arranged in parallel. The term processor may further include: neural processing units (NPUs) or neural computing units optimized for machine learning and artificial intelligence workloads using specialized architectures and data paths; tensor processing units (TPUs) designed to efficiently perform matrix multiplication and convolution operations used heavily in neural networks and deep learning applications; application-specific integrated circuits (ASICs) implementing custom logic for domain-specific tasks; application-specific instruction set processors (ASIPs) with instruction sets tailored for particular applications; field-programmable gate arrays (FPGAs) providing reconfigurable logic fabric that can be customized for specific processing tasks; processors operating on emerging computing paradigms such as quantum computing, optical computing, mechanical computing (e.g., using nanotechnology entities to transfer data), and so forth. Depending on configuration, computing device 10 may comprise one or more of any of the above types of processors in order to efficiently handle a variety of general purpose and specialized computing tasks. The specific processor configuration may be selected based on performance, power, cost, or other design constraints relevant to the intended application of computing device 10.

System memory 30 is processor-accessible data storage in the form of volatile and/or nonvolatile memory. System memory 30 may be either or both of two types: non-volatile memory and volatile memory. Non-volatile memory 30a is not erased when power to the memory is removed, and includes memory types such as read only memory (ROM), electronically-erasable programmable memory (EEPROM), and rewritable solid state memory (commonly known as “flash memory”). Non-volatile memory 30a is typically used for long-term storage of a basic input/output system (BIOS) 31, containing the basic instructions, typically loaded during computer startup, for transfer of information between components within computing device, or a unified extensible firmware interface (UEFI), which is a modern replacement for BIOS that supports larger hard drives, faster boot times, more security features, and provides native support for graphics and mouse cursors. Non-volatile memory 30a may also be used to store firmware comprising a complete operating system 35 and applications 36 for operating computer-controlled devices. The firmware approach is often used for purpose-specific computer-controlled devices such as appliances and Internet-of-Things (IoT) devices where processing power and data storage space is limited. Volatile memory 30b is erased when power to the memory is removed and is typically used for short-term storage of data for processing. Volatile memory 30b includes memory types such as random-access memory (RAM), and is normally the primary operating memory into which the operating system 35, applications 36, program modules 37, and application data 38 are loaded for execution by processors 20. Volatile memory 30b is generally faster than non-volatile memory 30a due to its electrical characteristics and is directly accessible to processors 20 for processing of instructions and data storage and retrieval. Volatile memory 30b may comprise one or more smaller cache memories which operate at a higher clock speed and are typically placed on the same IC as the processors to improve performance.

Interfaces 40 may include, but are not limited to, storage media interfaces 41, network interfaces 42, display interfaces 43, and input/output interfaces 44. Storage media interface 41 provides the necessary hardware interface for loading data from non-volatile data storage devices 50 into system memory 30 and storage data from system memory 30 to non-volatile data storage device 50. Network interface 42 provides the necessary hardware interface for computing device 10 to communicate with remote computing devices 80 and cloud-based services 90 via one or more external communication devices 70. Display interface 43 allows for connection of displays 61, monitors, touchscreens, and other visual input/output devices. Display interface 43 may include a graphics card for processing graphics-intensive calculations and for handling demanding display requirements. Typically, a graphics card includes a graphics processing unit (GPU) and video RAM (VRAM) to accelerate display of graphics. One or more input/output (I/O) interfaces 44 provide the necessary support for communications between computing device 10 and any external peripherals and accessories 60. For wireless communications, the necessary radio-frequency hardware and firmware may be connected to I/O interface 44 or may be integrated into I/O interface 44.

Non-volatile data storage devices 50 are typically used for long-term storage of data. Data on non-volatile data storage devices 50 is not erased when power to the non-volatile data storage devices 50 is removed. Non-volatile data storage devices 50 may be implemented using any technology for non-volatile storage of content including, but not limited to, CD-ROM drives, digital versatile discs (DVD), or other optical disc storage; magnetic cassettes, magnetic tape, magnetic disc storage, or other magnetic storage devices; solid state memory technologies such as EEPROM or flash memory; or other memory technology or any other medium which can be used to store data without requiring power to retain the data after it is written. Non-volatile data storage devices 50 may be non-removable from computing device 10 as in the case of internal hard drives, removable from computing device 10 as in the case of external USB hard drives, or a combination thereof, but computing device will typically comprise one or more internal, non-removable hard drives using cither magnetic disc or solid state memory technology. Non-volatile data storage devices 50 may store any type of data including, but not limited to, an operating system 51 for providing low-level and mid-level functionality of computing device 10, applications 52 for providing high-level functionality of computing device 10, program modules 53 such as containerized programs or applications, or other modular content or modular programming, application data 54, and databases 55 such as relational databases, non-relational databases, object oriented databases, BOSQL databases, and graph databases.

Applications (also known as computer software or software applications) are sets of programming instructions designed to perform specific tasks or provide specific functionality on a computer or other computing devices. Applications are typically written in high-level programming languages such as C++, Java, and Python, which are then either interpreted at runtime or compiled into low-level, binary, processor-executable instructions operable on processors 20. Applications may be containerized so that they can be run on any computer hardware running any known operating system. Containerization of computer software is a method of packaging and deploying applications along with their operating system dependencies into self-contained, isolated units known as containers. Containers provide a lightweight and consistent runtime environment that allows applications to run reliably across different computing environments, such as development, testing, and production systems.

The memories and non-volatile data storage devices described herein do not include communication media. Communication media are means of transmission of information such as modulated electromagnetic waves or modulated data signals configured to transmit, not store, information. By way of example, and not limitation, communication media includes wired communications such as sound signals transmitted to a speaker via a speaker wire, and wireless communications such as acoustic waves, radio frequency (RF) transmissions, infrared emissions, and other wireless media.

External communication devices 70 are devices that facilitate communications between computing device and either remote computing devices 80, or cloud-based services 90, or both. External communication devices 70 include, but are not limited to, data modems 71 which facilitate data transmission between computing device and the Internet 75 via a common carrier such as a telephone company or internet service provider (ISP), routers 72 which facilitate data transmission between computing device and other devices, and switches 73 which provide direct data communications between devices on a network. Here, modem 71 is shown connecting computing device 10 to both remote computing devices 80 and cloud-based services 90 via the Internet 75. While modem 71, router 72, and switch 73 are shown here as being connected to network interface 42, many different network configurations using external communication devices 70 are possible. Using external communication devices 70, networks may be configured as local area networks (LANs) for a single location, building, or campus, wide area networks (WANs) comprising data networks that extend over a larger geographical area, and virtual private networks (VPNs) which can be of any size but connect computers via encrypted communications over public networks such as the Internet 75. As just one exemplary network configuration, network interface 42 may be connected to switch 73 which is connected to router 72 which is connected to modem 71 which provides access for computing device 10 to the Internet 75. Further, any combination of wired 77 or wireless 76 communications between and among computing device 10, external communication devices 70, remote computing devices 80, and cloud-based services 90 may be used. Remote computing devices 80, for example, may communicate with computing device through a variety of communication channels 74 such as through switch 73 via a wired 77 connection, through router 72 via a wireless connection 76, or through modem 71 via the Internet 75. Furthermore, while not shown here, other hardware that is specifically designed for servers may be employed. For example, secure socket layer (SSL) acceleration cards can be used to offload SSL encryption computations, and transmission control protocol/internet protocol (TCP/IP) offload hardware and/or packet classifiers on network interfaces 42 may be installed and used at server devices.

In a networked environment, certain components of computing device 10 may be fully or partially implemented on remote computing devices 80 or cloud-based services 90. Data stored in non-volatile data storage device 50 may be received from, shared with, duplicated on, or offloaded to a non-volatile data storage device on one or more remote computing devices 80 or in a cloud computing service 92. Processing by processors 20 may be received from, shared with, duplicated on, or offloaded to processors of one or more remote computing devices 80 or in a distributed computing service 93. By way of example, data may reside on a cloud computing service 92, but may be usable or otherwise accessible for use by computing device 10. Also, certain processing subtasks may be sent to a microservice 91 for processing with the result being transmitted to computing device 10 for incorporation into a larger processing task. Also, while components and processes of the exemplary computing environment are illustrated herein as discrete units (e.g., OS 51 being stored on non-volatile data storage device 51 and loaded into system memory 35 for use) such processes and components may reside or be processed at various times in different components of computing device 10, remote computing devices 80, and/or cloud-based services 90.

In an implementation, the disclosed systems and methods may utilize, at least in part, containerization techniques to execute one or more processes and/or steps disclosed herein. Containerization is a lightweight and efficient virtualization technique that allows you to package and run applications and their dependencies in isolated environments called containers. One of the most popular containerization platforms is Docker, which is widely used in software development and deployment. Containerization, particularly with open-source technologies like Docker and container orchestration systems like Kubernetes, is a common approach for deploying and managing applications. Containers are created from images, which are lightweight, standalone, and executable packages that include application code, libraries, dependencies, and runtime. Images are often built from a Dockerfile or similar, which contains instructions for assembling the image. Dockerfiles are configuration files that specify how to build a Docker image. Systems like Kubernetes also support containerd or CRI-O. They include commands for installing dependencies, copying files, setting environment variables, and defining runtime configurations. Docker images are stored in repositories, which can be public or private. Docker Hub is an exemplary public registry, and organizations often set up private registries for security and version control using tools such as Hub, JFrog Artifactory and Bintray, Github Packages or Container registries. Containers can communicate with each other and the external world through networking. Docker provides a bridge network by default, but can be used with custom networks. Containers within the same network can communicate using container names or IP addresses.

Remote computing devices 80 are any computing devices not part of computing device 10. Remote computing devices 80 include, but are not limited to, personal computers, server computers, thin clients, thick clients, personal digital assistants (PDAs), mobile telephones, watches, tablet computers, laptop computers, multiprocessor systems, microprocessor based systems, set-top boxes, programmable consumer electronics, video game machines, game consoles, portable or handheld gaming units, network terminals, desktop personal computers (PCs), minicomputers, main frame computers, network nodes, virtual reality or augmented reality devices and wearables, and distributed or multi-processing computing environments. While remote computing devices 80 are shown for clarity as being separate from cloud-based services 90, cloud-based services 90 are implemented on collections of networked remote computing devices 80.

Cloud-based services 90 are Internet-accessible services implemented on collections of networked remote computing devices 80. Cloud-based services are typically accessed via application programming interfaces (APIs) which are software interfaces which provide access to computing services within the cloud-based service via API calls, which are pre-defined protocols for requesting a computing service and receiving the results of that computing service. While cloud-based services may comprise any type of computer processing or storage, three common categories of cloud-based services 90 are microservices 91, cloud computing services 92, and distributed computing services 93.

Microservices 91 are collections of small, loosely coupled, and independently deployable computing services. Each microservice represents a specific computing functionality and runs as a separate process or container. Microservices promote the decomposition of complex applications into smaller, manageable services that can be developed, deployed, and scaled independently. These services communicate with each other through well-defined application programming interfaces (APIs), typically using lightweight protocols like HTTP, gRPC, or message queues such as Kafka. Microservices 91 can be combined to perform more complex processing tasks.

Cloud computing services 92 are delivery of computing resources and services over the Internet 75 from a remote location. Cloud computing services 92 provide additional computer hardware and storage on as-needed or subscription basis. Cloud computing services 92 can provide large amounts of scalable data storage, access to sophisticated software and powerful server-based processing, or entire computing infrastructures and platforms. For example, cloud computing services can provide virtualized computing resources such as virtual machines, storage, and networks, platforms for developing, running, and managing applications without the complexity of infrastructure management, and complete software applications over the Internet on a subscription basis.

Distributed computing services 93 provide large-scale processing using multiple interconnected computers or nodes to solve computational problems or perform tasks collectively. In distributed computing, the processing and storage capabilities of multiple machines are leveraged to work together as a unified system. Distributed computing services are designed to address problems that cannot be efficiently solved by a single computer or that require large-scale computational power. These services enable parallel processing, fault tolerance, and scalability by distributing tasks across multiple nodes.

Although described above as a physical device, computing device 10 can be a virtual computing device, in which case the functionality of the physical components herein described, such as processors 20, system memory 30, network interfaces 40, and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where computing device 10 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executing within the construct of another virtual computing device. Thus, computing device 10 may be either a physical computing device or a virtualized computing device within which computer-executable instructions can be executed in a manner consistent with their execution by a physical computing device. Similarly, terms referring to physical components of the computing device, as utilized herein, mean either those physical components or virtualizations thereof performing the same or equivalent functions.

The skilled person will be aware of a range of possible modifications of the various aspects described above. Accordingly, the present invention is defined by the claims and their equivalents.

What is claimed is:

1. A system for user experience curation, comprising:
a computing device comprising at least a memory and a processor;
a plurality of programming instructions that, when operating on the processor, cause the computing device to:
collect a plurality of data types from a plurality of sources or systems wherein data may include but is not limited to audio, visual, telematics, haptic, smells, environmental conditions, user security settings, user privacy settings, user disabilities and sensory ranges, user health and faculties, other user devices, and user preference settings;
train a modular artificial intelligence which includes a plurality of artificial general intelligence subsystems using the plurality of data where each intelligence subsystem is trained on a different data type;
generate a user interface or user experience which incorporates elements associated with audio, visual, smell or fragrance, pressure, temperature, humidity, direct brain stimulus via neural interface, other environmental elements to include molecular composition of air or water or solutions in vicinity of user, telematics and motion elements, taste, haptic, and user inputs using the modular artificial intelligence system wherein the plurality user security, privacy, and preference settings allow the interface or experience to be tailored to a particular user; and
collect a plurality of user feedback data which may input into an artificial intelligence training live or training system to better tailor an interface, experience moment or sequence of moments or progression of sequences, or environment to a particular user.

2. The system of claim 1, wherein the modular artificial general intelligence system is integrated into a dynamic application experience generation platform which generates a chatbot that may be incorporated into a generated user interface or experience.

3. The system of claim 1, wherein the modular artificial general intelligence system uses the telematics, haptics, audio, and visual data to generate virtual environments and interfaces for video games and simulations.

4. The system of claim 3, wherein the generated virtual environments and interfaces for video games and simulations may be updated based on how the user interacts with the environment and allows a user to receive sensory feedback based on their interactions.

5. The system of claim 1, wherein the artificial intelligence experience is integrated into a dynamic experience curation platform which allows the artificial intelligence system to generate a plurality of virtual experiences.

6. The system of claim 1, wherein the user provides real-time feedback to dynamically alter the generated experience moment, sequence of moments, progression of sequences, or environment.

7. A method for user experience curation, comprising the steps of:
collecting a plurality of data types from a plurality of sources or systems wherein data may include but is not limited to audio, visual, telematics, haptic, smells, environmental conditions, user security settings, user privacy settings, user disabilities and sensory ranges, user health and faculties, other user devices, and user preference settings;
training a modular artificial intelligence which includes a plurality of artificial general intelligence subsystems using the plurality of data where each intelligence subsystem is trained on a different data type;
generating a user interface or user experience which incorporates elements associated with audio, visual, smell or fragrance, pressure, temperature, humidity, direct brain stimulus via neural interface, other environmental elements to include molecular composition of air or water or solutions in vicinity of user, telematics and motion elements, taste, haptic, and user inputs using the modular artificial intelligence system wherein the plurality user security, privacy, and preference settings allow the interface or experience to be tailored to a particular user; and
collecting a plurality of user feedback data which may input into an artificial intelligence training live or training system to better tailor an interface, experience moment or sequence of moments or progression of sequences, or environment to a particular user.

8. The method of claim 7, wherein the modular artificial intelligence system is integrated into a dynamic application experience generation platform which generates a chatbot that may be incorporated into a generated user interface or experience.

9. The method of claim 7, wherein the modular artificial intelligence system uses the telematics, haptics, audio, and visual data to generate virtual environments and interfaces for video games and simulations.

10. The method of claim 9, wherein the generated virtual environments and interfaces for video games and simulations may be updated based on how the user interacts with the environment and allows a user to receive sensory feedback based on their interactions.

11. The method of claim 7, wherein the artificial intelligence experience is integrated into a dynamic experience curation platform which allows the artificial intelligence system to generate a plurality of virtual experiences.

12. The method of claim 7, wherein the user provides real-time feedback to dynamically alter the generated experience moment, sequence of moments, progression of sequences, or environment.

13. Non-transitory, computer-readable storage media having computer-executable instructions embodied thereon that, when executed by one or more processors of a computing system employing an asset registry platform for user experience curation, cause the computing system to:
collect a plurality of data types from a plurality of sources or systems wherein data may include but is not limited to audio, visual, telematics, haptic, smells, environmental conditions, user security settings, user privacy settings, user disabilities and sensory ranges, user health and faculties, other user devices, and user preference settings;
train a modular artificial intelligence which includes a plurality of artificial general intelligence subsystems using the plurality of data where each intelligence subsystem is trained on a different data type;
generate a user interface or user experience which incorporates elements associated with audio, visual, smell or fragrance, pressure, temperature, humidity, direct brain stimulus via neural interface, other environmental elements to include molecular composition of air or water or solutions in vicinity of user, telematics and motion elements, taste, haptic, and user inputs using the modular artificial intelligence system wherein the plurality user security, privacy, and preference settings allow the interface or experience to be tailored to a particular user; and
collect a plurality of user feedback data which may input into an artificial intelligence training live or training system to better tailor an interface, experience moment or sequence of moments or progression of sequences, or environment to a particular user.

14. The media of claim 13, wherein the modular artificial intelligence system is integrated into a dynamic application experience generation platform which generates a chatbot that may be incorporated into a generated user interface or experience.

15. The media of claim 13, wherein the modular artificial intelligence system uses the telematics, haptics, audio, and visual data to generate virtual environments and interfaces for video games and simulations.

16. The media of claim 15, wherein the generated virtual environments and interfaces for video games and simulations may be updated based on how the user interacts with the environment and allows a user to receive sensory feedback based on their interactions.

17. The media of claim 13, wherein the artificial intelligence experience is integrated into a dynamic experience curation platform which allows the artificial intelligence system to generate a plurality of virtual experiences.

18. The media of claim 13, wherein the user provides real-time feedback to dynamically alter the generated experience moment, sequence of moments, progression of sequences, or environment.

19. A system for user experience curation, comprising one or more computers with executable instructions that, when executed, cause the system to:
collect a plurality of data types from a plurality of sources or systems wherein data may include but is not limited to audio, visual, telematics, haptic, smells, environmental conditions, user security settings, user privacy settings, user disabilities and sensory ranges, user health and faculties, other user devices, and user preference settings;
train a modular artificial intelligence which includes a plurality of artificial general intelligence subsystems using the plurality of data where each intelligence subsystem is trained on a different data type;
generate a user interface or user experience which incorporates elements associated with audio, visual, smell or fragrance, pressure, temperature, humidity, direct brain stimulus via neural interface, other environmental elements to include molecular composition of air or water or solutions in vicinity of user, telematics and motion elements, taste, haptic, and user inputs using the modular artificial intelligence system wherein the plurality user security, privacy, and preference settings allow the interface or experience to be tailored to a particular user; and
collect a plurality of user feedback data which may input into an artificial intelligence training live or training system to better tailor an interface, experience moment or sequence of moments or progression of sequences, or environment to a particular user.

20. The system of claim 19, wherein the modular artificial intelligence system is integrated into a dynamic application experience generation platform which generates a chatbot that may be incorporated into a generated user interface or experience.

21. The system of claim 19, wherein the modular artificial intelligence system uses the telematics, haptics, audio, and visual data to generate virtual environments and interfaces for video games and simulations.

22. The system of claim 21, wherein the generated virtual environments and interfaces for video games and simulations may be updated based on how the user interacts with the environment and allows a user to receive sensory feedback based on their interactions.

23. The system of claim 19, wherein the artificial intelligence experience is integrated into a dynamic experience curation platform which allows the artificial intelligence system to generate a plurality of virtual experiences.

24. The system of claim 19, wherein the user provides real-time feedback to dynamically alter the generated experience moment, sequence of moments, progression of sequences, or environment.
